(19) United States
(12) Patent Application Publication
(10) Pub. No.: US 2025/0362876 A1
(43) Pub. Date: Nov. 27, 2025

(54) Semiconductor Device And Electronic Device

(71) Applicant: Semiconductor Energy Laboratory Co., Ltd., Kanagawa-ken (JP)

(72) Inventors: Yoshiyuki KUROKAWA, Sagamihara, Kanagawa (JP); Yuki OKAMOTO, Ebina, Kanagawa (JP); Satoru OHSHITA, Hadano, Kanagawa (JP)

(73) Assignee: Semiconductor Energy Laboratory Co., Ltd., Kanagawa-ken (JP)

(21) Appl. No.: 18/873,625

(22) PCT Filed: Jun. 2, 2023
(86) PCT No.: PCT/IB2023/055671

§ 371 Date: Dec. 10, 2024

(30) Foreign Application Priority Data
Jun. 17, 2022 (JP) 2022-097858

(51) Int. Cl. G06F 7/57

(52) U.S. Cl. CPC G06F 7/57

(57) ABSTRACT

A semiconductor device with a small circuit scale and reduced power consumption is provided. The semiconductor device includes a first arithmetic portion that performs a digital arithmetic operation and a second arithmetic portion that performs an analog arithmetic operation. In an arithmetic operation of a convolutional neural network, the first arithmetic portion executes an arithmetic operation of a convolution layer, and the second arithmetic portion executes an arithmetic operation of a fully connected layer. The convolution layer often uses the same filter value repeatedly; thus, the first arithmetic portion is configured to execute a plurality of product-sum operations at the same time with single input of the same filter value and with input of a plurality of pieces of data to be subjected to convolution processing. Since the fully connected layer needs weight coefficients as many as the product of the number of pieces of input data and the number of pieces of output data, the second arithmetic portion has a structure in which arithmetic cells arranged in a matrix retain the weight coefficients and the input data is transmitted in the row directions, whereby the output data is output in the column directions.

### TECHNICAL FIELD

One embodiment of the present invention relates to a semiconductor device and an electronic device.

Note that one embodiment of the present invention is not limited to the above technical field. The technical field of the invention disclosed in this specification and the like relates to an object, a driving method, or a manufacturing method. Alternatively, one embodiment of the present invention relates to a process, a machine, manufacture, or a composition of matter. Therefore, specific examples of the technical field of one embodiment of the present invention disclosed in this specification include a semiconductor device, a display apparatus, a liquid crystal display apparatus, a light-emitting apparatus, a power storage device, an image capturing device, a storage device, a signal processing device, a sensor, a processor, an electronic device, a system, a driving method thereof, a manufacturing method thereof, and a testing method thereof.

### BACKGROUND ART

Integrated circuits that imitate the mechanism of the human brain are currently under active development. The integrated circuits incorporate the brain mechanism as electronic circuits and include circuits corresponding to “neurons” and “synapses” of the human brain. Such integrated circuits may therefore be referred to as “neuromorphic”, “brain-morphic”, or “brain-inspired” circuits, for example. The integrated circuits have a non-von Neumann architecture and are expected to be able to perform parallel processing with extremely low power consumption as compared with a von Neumann architecture, which consumes higher power with increasing processing speed.

An information processing model that imitates a biological neural network including “neurons” and “synapses” is referred to as an artificial neural network (ANN). For example, Non-Patent Document 1 and Non-Patent Document 2 each disclose an arithmetic device including an artificial neural network constructed using an SRAM (Static Random Access Memory).

An attempt has been made to use an arithmetic device in which an artificial neural network is constructed, for example, for correction of images to be displayed by a display apparatus. For example, in a display apparatus disclosed in Patent Document 1, an arithmetic circuit in which an artificial neural network is constructed is used to adjust the luminance, tone, and the like of displayed images in accordance with the preference of the person who watches the images.

### REFERENCES

### Patent Document

[Patent Document 1] Japanese Published Patent Application No. 2018-36639

### Non-Patent Documents

[Non-Patent Document 1]M. Kang et al., “IEEE Journal Of Solid-State Circuits”, 2018, Volume 53, No. 2, p. 642-655.
[Non-Patent Document 2]J. Zhang et al., “IEEE Journal Of Solid-State Circuits”, 2017, Volume 52, No. 4, p. 915-924.

### SUMMARY OF THE INVENTION

### Problems to be Solved by the Invention

Examples of a means for performing feature extraction and image recognition on an image include a method using a convolutional neural network, which is a kind of artificial neural network. A convolutional neural network includes, for example, a convolution layer, a pooling layer, and a fully connected layer; when data of an image is input to a multilayer structure combining these layers, feature extraction and image recognition can be performed on the image.

The convolution layer performs low-level feature extraction. Specifically, the convolution layer performs a product-sum operation of image data in a region selected from the input image and a filter (sometimes referred to as kernel). In the convolution layer, the product-sum operations are sequentially performed with the region being shifted by a stride; thus, the data obtained in the convolution layer is, for example, two-dimensional array (matrix) data or three-dimensional array data.

In the convolution layer, a smaller stride and a larger number of filters cause the product-sum operations to involve a more massive number of times of multiplications. A massive number of times of multiplications lead to a higher frequency of updating a filter value (a value included in a filter) to be input to an arithmetic circuit, so that updating necessitates higher power. A massive number of times of multiplications may be dealt with using a large number of arithmetic circuits; however, in that case, the circuit area increases.

The fully connected layer performs high-level feature extraction. Specifically, in the fully connected layer, for one output channel, a product-sum operation of data of all input channels and corresponding weight coefficients is performed, and the value of an activation function is calculated using the result as an input value. Since the number of output channels is two or more, the number of weight coefficients in the fully connected layer is (the number of input channels)×(the number of output channels).

That is, a larger number of input channels and a larger number of output channels cause a more massive number of weight coefficients (cause the product-sum operation to involve a more massive number of times of multiplications). Thus, the arithmetic operation of the fully connected layer necessitates a large number of memory circuits for retaining the weight coefficients, increasing the circuit area.

An object of one embodiment of the present invention is to provide a semiconductor device with reduced power consumption. Another object of one embodiment of the present invention is to provide a semiconductor device with a small circuit area. Another object of one embodiment of the present invention is to provide a semiconductor device capable of performing arithmetic operations successively. Another object of one embodiment of the present invention is to provide a novel semiconductor device. Another object of one embodiment of the present invention is to provide an electronic device that includes the above semiconductor device.

Note that the objects of one embodiment of the present invention are not limited to the above objects. The above objects do not preclude the existence of other objects. Note that the other objects are objects that are not described in this section and are described below. The objects that are not described in this section are derived from the description of the specification, the drawings, and the like and can be extracted as appropriate from the description by those skilled in the art. Note that one embodiment of the present invention is to achieve at least one of the above objects and the other objects and does not necessarily achieve all of the above objects and the other objects.

### Means for Solving the Problems

(1)

One embodiment of the present invention is a semiconductor device including a first arithmetic portion, a second arithmetic portion, and a storage portion. The first arithmetic portion includes a first wiring and an arithmetic circuit, the second arithmetic portion includes a second wiring, a first circuit, a second circuit, a third circuit, and a plurality of arithmetic cells, and the storage portion includes a first memory circuit portion, a second memory circuit portion, and a third memory circuit portion.

A first input terminal of the arithmetic circuit is electrically connected to the first wiring, and a second input terminal of the arithmetic circuit is electrically connected to the second memory circuit portion. The second wiring is electrically connected to the first circuit, the third circuit, and the plurality of arithmetic cells.

The first wiring has a function of a wiring sequentially transmitting a plurality of pieces of first digital data. The second memory circuit portion has a function of reading a plurality of pieces of second digital data and sequentially transmitting the plurality of pieces of second digital data to the second input terminal of the arithmetic circuit. The arithmetic circuit has a function of performing a first product-sum operation of the plurality of pieces of first digital data and the plurality of pieces of second digital data and a function of transmitting, to the first memory circuit portion, third digital data that is a result of the first product-sum operation.

The first memory circuit portion has a function of retaining a plurality of pieces of the third digital data, and the third memory circuit portion has a function of reading a plurality of pieces of fourth digital data and sequentially transmitting the plurality of pieces of fourth digital data to the first circuit. The first circuit has a function of sequentially generating first currents corresponding to the fourth digital data and making the first currents flow to the plurality of arithmetic cells. The arithmetic cell has a function of retaining a first potential corresponding to the first current. The first memory circuit portion has a function of reading the plurality of pieces of third digital data and transmitting the plurality of pieces of third digital data to the second circuit. The second circuit has a function of generating a plurality of second currents corresponding to the plurality of pieces of third digital data and making the second currents flow to the plurality of arithmetic cells. The arithmetic cell has a function of changing the first potential in accordance with an amount of the second current, generating a third current in an amount corresponding to a product of the fourth digital data and the third digital data, and making the third current flow to the second wiring. The third circuit has a function of obtaining, from the second wiring, a sum of amounts of a plurality of the third currents generated in the plurality of arithmetic cells, performing an arithmetic operation of a function system using the sum of the third currents as an input value, and generating first data that is a result of the arithmetic operation of the function system.

(2)

In another embodiment of the present invention, a plurality of the first wirings and a plurality of the arithmetic circuits may be provided in (1) above. Specifically, it is preferable that the first input terminals of the plurality of arithmetic circuits be electrically connected to the plurality of first wirings to have one-to-one correspondence. It is preferable that the second input terminals of the plurality of arithmetic circuits be electrically connected to each other. It is preferable that output terminals of the plurality of arithmetic circuits be electrically connected to the first memory circuit portion.

(3)

In another embodiment of the present invention, the first arithmetic portion may include a processing circuit in (2) above. Specifically, it is preferable that the first memory circuit portion have a function of transmitting the third digital data to the processing circuit. It is preferable that the processing circuit have a function of performing pooling processing on the third digital data and a function of transmitting, to the first memory circuit portion, the third digital data on which the pooling processing is performed.

(4)

In another embodiment of the present invention, the first arithmetic portion may include a switching circuit in (3) above. Specifically, it is preferable that the switching circuit include a plurality of first input terminals, a plurality of second input terminals, and a plurality of output terminals. It is preferable that the plurality of second input terminals of the switching circuit be electrically connected to the first memory circuit portion and the plurality of output terminals of the switching circuit be electrically connected to the plurality of first wirings to have one-to-one correspondence. It is preferable that the switching circuit have a function of establishing a conduction state between one of the plurality of first input terminals of the switching circuit and the plurality of second input terminals of the switching circuit and the plurality of output terminals of the switching circuit and establishing a non-conduction state between the other of the plurality of first input terminals of the switching circuit and the plurality of second input terminals of the switching circuit and the plurality of output terminals of the switching circuit. It is preferable that the first memory circuit portion have a function of reading the plurality of pieces of third digital data and transmitting the plurality of pieces of third digital data to the first input terminal of the arithmetic circuit through the switching circuit, and the arithmetic circuit have a function of performing a second product-sum operation of the plurality of pieces of third digital data retained in the first memory circuit portion and the plurality of pieces of second digital data retained in the second memory circuit portion and a function of transmitting a result of the second product-sum operation as digital data to the first memory circuit portion.

(5)

In another embodiment of the present invention, the third circuit may include an analog-digital converter circuit in (4) above. Specifically, it is preferable that the analog-digital converter circuit have a function of converting the first data into fifth digital data and the third circuit have a function of transmitting the fifth digital data to the first memory circuit portion.

(6)

In another embodiment of the present invention, a first layer, a second layer positioned above the first layer, and a third layer positioned above the second layer may be provided in any one of (1) to (5) above. Specifically, it is preferable that the first layer include an arithmetic portion, the first circuit, the second circuit, and the third circuit, the second layer include the first memory circuit portion, the second memory circuit portion, and the third memory circuit portion, and the third layer include a plurality of arithmetic portions.

(7)

In another embodiment of the present invention, it is preferable that the first layer include a transistor in which a channel formation region includes silicon and each of the second layer and the third layer include a transistor in which a channel formation region includes an oxide semiconductor in (6) above.

Specifically, it is preferable that the oxide semiconductor include one or more selected from indium, zinc, and an element M. Note that the element M is one or more selected from gallium, aluminum, silicon, boron, yttrium, tin, copper, vanadium, beryllium, titanium, iron, nickel, germanium, zirconium, molybdenum, lanthanum, cerium, neodymium, hafnium, tantalum, tungsten, cobalt, magnesium, and antimony.

(8)

Another embodiment of the present invention is an electronic device that includes the semiconductor device of (7) above and a housing.

### Effect of the Invention

According to one embodiment of the present invention, a semiconductor device with reduced power consumption can be provided. According to another embodiment of the present invention, a semiconductor device with a small circuit area can be provided. According to another embodiment of the present invention, a semiconductor device capable of performing arithmetic operations successively can be provided. According to another embodiment of the present invention, a novel semiconductor device can be provided. According to another embodiment of the present invention, an electronic device that includes the above semiconductor device can be provided.

Note that the effects of one embodiment of the present invention are not limited to the effects described above. The effects described above do not preclude the existence of other effects. The other effects are the ones that are not described in this section and will be described below. The effects that are not described in this section can be derived from the description of the specification, the drawings, and the like and can be extracted as appropriate from the description by those skilled in the art. One embodiment of the present invention has at least one of the above effects and the other effects. Accordingly, one embodiment of the present invention does not have the above effects in some cases.

### BRIEF DESCRIPTION OF THE DRAWINGS

FIG. 1 is a block diagram illustrating a structure example of a semiconductor device.

FIG. 2A and FIG. 2B are block diagrams each illustrating a structure example of a circuit included in a semiconductor device.

FIG. 3A and FIG. 3B are block diagrams each illustrating a structure example of a circuit included in a semiconductor device.

FIG. 4A is a block diagram illustrating a structure example of a circuit included in a semiconductor device, and FIG. 4B and FIG. 4C are circuit diagrams each illustrating a structure example of a storage cell.

FIG. 5A to FIG. 5C are circuit diagrams each illustrating a structure example of a circuit included in a semiconductor device.

FIG. 6 is a circuit diagram showing a structure example of a circuit included in a semiconductor device.

FIG. 7A to FIG. 7C are circuit diagrams each illustrating a structure example of a circuit included in a semiconductor device.

FIG. 8A to FIG. 8D are circuit diagrams each illustrating a structure example of a circuit included in a semiconductor device.

FIG. 9A to FIG. 9C are block diagrams each illustrating a structure example of a circuit included in a semiconductor device.

FIG. 10 is a diagram showing an example of a convolutional neural network.

FIG. 11 is a diagram illustrating an example of convolution processing.

FIG. 12 is a diagram illustrating an example of convolution processing.

FIG. 13 is a timing chart showing an operation example of convolution processing in a semiconductor device.

FIG. 14A and FIG. 14B are diagrams each illustrating an example of pooling processing.

FIG. 15A and FIG. 15B are block diagrams each illustrating a structure example of a circuit included in a semiconductor device.

FIG. 16 is a schematic perspective view showing a structure example of a semiconductor device.

FIG. 17 is a block diagram showing a structure example of a semiconductor device.

FIG. 18 is a block diagram showing a structure example of a semiconductor device.

FIG. 19 is a schematic cross-sectional view showing a structure example of a semiconductor device.

FIG. 20 is a schematic cross-sectional view showing a structure example of a semiconductor device.

FIG. 21 is a schematic perspective view showing a structure example of a semiconductor device.

FIG. 22A and FIG. 22B are diagrams showing examples of electronic components.

FIG. 23A and FIG. 23B are diagrams showing examples of electronic devices, and FIG. 23C to FIG. 23E are diagrams showing an example of a large computer.

FIG. 24 is a diagram showing an example of space equipment.

FIG. 25 is a diagram showing an example of a storage system applicable to a data center.

FIG. 26 is a top view photograph of an actually fabricated semiconductor device.

FIG. 27 is a top view photograph of an actually fabricated semiconductor device.

### MODE FOR CARRYING OUT THE INVENTION

In this specification and the like, a semiconductor device refers to a device that utilizes semiconductor characteristics, and means a circuit including a semiconductor element (e.g., a transistor, a diode, and a photodiode), or a device including the circuit. The semiconductor device also means all devices that can function by utilizing semiconductor characteristics. For example, an integrated circuit, a chip including an integrated circuit, and an electronic component including a chip in a package are each an example of the semiconductor device. Moreover, a storage device, a display apparatus, a light-emitting apparatus, a lighting device, an electronic device, and the like themselves are semiconductor devices in some cases and include semiconductor devices in other cases.

In the case where there is description “X and Y are connected” in this specification and the like, the case where X and Y are electrically connected, the case where X and Y are functionally connected, and the case where X and Y are directly connected are regarded as being disclosed in this specification and the like. Accordingly, without being limited to a predetermined connection relation, for example, a connection relation shown in drawings or texts, a connection relation other than one shown in drawings or texts is regarded as being disclosed in the drawings or the texts. Each of X and Y denotes an object (e.g., a device, an element, a circuit, a wiring, an electrode, a terminal, a conductive film, or a layer).

For example, in the case where X and Y are electrically connected, one or more elements that allow electrical connection between X and Y (e.g., a switch, a transistor, a capacitor, an inductor, a resistor, a diode, a display device, a light-emitting device, and a load) can be connected between X and Y. Note that a switch has a function of being controlled to be turned on or off. That is, the switch has a function of being in a conduction state (on state) or a non-conduction state (off state) to control whether a current flows or not.

For example, in the case where X and Y are functionally connected, one or more circuits that allow functional connection between X and Y (e.g., a logic circuit (e.g., an inverter, a NAND circuit, or a NOR circuit); a signal converter circuit (e.g., a digital-analog converter circuit, an analog-digital converter circuit, or a gamma correction circuit); a potential level converter circuit (e.g., a power supply circuit such as a step-up circuit or a step-down circuit, or a level shifter circuit for changing the potential level of a signal); a voltage source; a current source; a switching circuit; an amplifier circuit (e.g., a circuit that can increase signal amplitude, the amount of a current, or the like, an operational amplifier, a differential amplifier circuit, a source follower circuit, or a buffer circuit); a signal generation circuit; a storage circuit; or a control circuit) can be connected between X and Y. For instance, even if another circuit is provided between X and Y, X and Y are regarded as being functionally connected when a signal output from X is transmitted to Y.

Note that an explicit description “X and Y are electrically connected” includes the case where X and Y are electrically connected (i.e., the case where X and Y are connected with another element or another circuit provided therebetween) and the case where X and Y are directly connected (i.e., the case where X and Y are connected without another element or another circuit provided therebetween).

This specification describes a circuit structure in which a plurality of elements are electrically connected to a wiring (a wiring for supplying a fixed potential or a wiring for transmitting a signal). For example, in the case where X is directly connected to a wiring and Y is directly connected to the wiring, this specification may describe that X and Y are directly electrically connected to each other.

It can be expressed as, for example, “X, Y, a source (sometimes called one of a first terminal and a second terminal) of a transistor, and a drain (sometimes called the other of the first terminal and the second terminal) of the transistor are electrically connected to each other, and X, the source of the transistor, the drain of the transistor, and Y are electrically connected to each other in this order”. Alternatively, it can be expressed as “a source of a transistor is electrically connected to X; a drain of the transistor is electrically connected to Y; and X, the source of the transistor, the drain of the transistor, and Y are electrically connected to each other in this order”. Alternatively, it can be expressed as “X is electrically connected to Y through a source and a drain of a transistor, and X, the source of the transistor, the drain of the transistor, and Y are provided in this connection order”. When the connection order in a circuit structure is defined by an expression similar to the above examples, a source and a drain of a transistor can be distinguished from each other to specify the technical scope. Note that these expressions are examples and the expression is not limited to these expressions. Here, each of X and Y denotes an object (e.g., a device, an element, a circuit, a wiring, an electrode, a terminal, a conductive film, or a layer).

Even when independent components are electrically connected to each other in a circuit diagram, one component has functions of a plurality of components in some cases. For example, when part of a wiring also functions as an electrode, one conductive film has both functions of a wiring and an electrode. Thus, electrical connection in this specification includes, in its category, such a case where one conductive film has functions of a plurality of components.

In this specification and the like, a “resistor” can be, for example, a circuit element having a resistance value higher than 0Ω or a wiring having a resistance value higher than 0Ω. Therefore, in this specification and the like, a “resistor” includes a wiring having a resistance value, a transistor in which a current flows between a source and a drain, a diode, and a coil. Thus, the term “resistor” can sometimes be replaced with the terms “resistance”, “load”, or “region having a resistance value”. Conversely, the terms “resistance”, “load”, or “region having a resistance value” can sometimes be replaced with the term “resistor”. The resistance value can be, for example, preferably higher than or equal to 1 mΩ and lower than or equal to 10Ω, further preferably higher than or equal to 5 mΩ and lower than or equal to 5Ω, still further preferably higher than or equal to 10 mΩ and lower than or equal to 1Ω. For another example, the resistance value may be higher than or equal to 1Ω and lower than or equal to 1×10⁹Ω.

In this specification and the like, a “capacitor” can be, for example, a circuit element having an electrostatic capacitance value higher than 0 F, a region of a wiring having an electrostatic capacitance value higher than 0 F, parasitic capacitance, or gate capacitance of a transistor. The term “capacitor”, “parasitic capacitance”, or “gate capacitance” can be replaced with the term “capacitance” in some cases. Conversely, the term “capacitance” can be replaced with the term “capacitor”, “parasitic capacitance”, or “gate capacitance” in some cases. In addition, a “capacitor” (including a “capacitor” with three or more terminals) includes an insulator and a pair of conductors between which the insulator is interposed. Thus, the term “pair of conductors” of “capacitor” can be replaced with “pair of electrodes”, “pair of conductive regions”, “pair of regions”, or “pair of terminals”. In addition, the terms “one of a pair of terminals” and “the other of the pair of terminals” are referred to as a first terminal and a second terminal, respectively, in some cases. Note that the electrostatic capacitance value can be higher than or equal to 0.05 fF and lower than or equal to 10 pF, for example. For another example, the electrostatic capacitance value may be higher than or equal to 1 pF and lower than or equal to 10 pF.

In this specification and the like, a transistor includes three terminals called a gate, a source, and a drain. The gate is a control terminal for controlling the conduction state of the transistor. Two terminals functioning as the source and the drain are input/output terminals of the transistor. One of the two input/output terminals serves as the source and the other serves as the drain on the basis of the conductivity type (n-channel type or p-channel type) of the transistor and the levels of potentials applied to the three terminals of the transistor. Thus, the terms “source” and “drain” can sometimes be replaced with each other in this specification and the like. In this specification and the like, expressions “one of a source and a drain” (sometimes called a first electrode or a first terminal) and “the other of the source and the drain” (sometimes called a second electrode or a second terminal) are used in description of the connection relation of a transistor. Depending on the transistor structure, a transistor may include a back gate in addition to the above three terminals. In that case, in this specification and the like, one of the gate and the back gate of the transistor may be referred to as a first gate and the other of the gate and the back gate of the transistor may be referred to as a second gate. Moreover, the terms “gate” and “back gate” can be replaced with each other in one transistor in some cases. In the case where a transistor includes three or more gates, the gates may be referred to as a first gate, a second gate, a third gate, and the like in this specification and the like.

In this specification and the like, for example, a transistor with a multi-gate structure having two or more gate electrodes can be used as the transistor. With the multi-gate structure, channel formation regions are connected in series; accordingly, a plurality of transistors are connected in series. Thus, with the multi-gate structure, the amount of an off-state current can be reduced, and the breakdown voltage of the transistor can be increased (the reliability can be improved). Alternatively, with the multi-gate structure, a drain-source current does not change very much even if a drain-source voltage changes at the time of an operation in a saturation region, so that a flat slope of voltage-current characteristics can be obtained. By utilizing the flat slope of the voltage-current characteristics, an ideal current source circuit or an active load having an extremely high resistance value can be obtained. Accordingly, a differential circuit, a current mirror circuit, and the like having excellent properties can be obtained.

The case where a single circuit element is illustrated in a circuit diagram may indicate a case where the circuit element includes a plurality of circuit elements. For example, the case where a single resistor is illustrated in a circuit diagram may indicate a case where two or more resistors are electrically connected to each other in series. For another example, the case where a single capacitor is illustrated in a circuit diagram may indicate a case where two or more capacitors are electrically connected to each other in parallel. For another example, the case where a single transistor is illustrated in a circuit diagram may indicate a case where two or more transistors are electrically connected to each other in series and their gates are electrically connected to each other. Similarly, for another example, the case where a single switch is illustrated in a circuit diagram may indicate a case where the switch includes two or more transistors which are electrically connected to each other in series or in parallel and whose gates are electrically connected to each other.

In this specification and the like, a node can be referred to as a terminal, a wiring, an electrode, a conductive layer, a conductor, an impurity region, or the like depending on the circuit structure and the device structure. Furthermore, a terminal, a wiring, or the like can be referred to as a node.

In this specification and the like, a “voltage” and a “potential” can be replaced with each other as appropriate. A “voltage” refers to a potential difference from a reference potential, and when the reference potential is a ground potential, for example, a “voltage” can be replaced with a “potential”. Note that the ground potential does not necessarily mean 0 V. Moreover, potentials are relative values, and a potential supplied to a wiring, a potential applied to a circuit or the like, and a potential output from a circuit or the like, for example, change with a change of the reference potential.

In this specification and the like, the terms “high-level potential” and “low-level potential” do not mean a particular potential. For example, in the case where two wirings are both described as “functioning as a wiring for supplying a high-level potential”, the levels of the high-level potentials supplied to the wirings are not necessarily equal to each other. Similarly, in the case where two wirings are both described as “functioning as a wiring for supplying a low-level potential”, the levels of the low-level potentials supplied to the wirings are not necessarily equal to each other.

A “current” means a charge transfer phenomenon (electrical conduction); for example, the description “electrical conduction of positively charged particles occurs” can be rephrased as “electrical conduction of negatively charged particles occurs in the opposite direction”. Therefore, unless otherwise specified, a “current” in this specification and the like refers to a charge transfer phenomenon (electrical conduction) accompanying carrier movement. Examples of a carrier here include an electron, a hole, an anion, a cation, and a complex ion, and the type of carrier differs between current flow systems (e.g., a semiconductor, a metal, an electrolyte solution, and a vacuum). The “direction of a current” in a wiring or the like refers to the direction in which a carrier with positive charge moves, and the amount of the current is expressed as a positive value. In other words, the direction in which a carrier with negative charge moves is opposite to the direction of a current, and the amount of the current is expressed as a negative value. Thus, in the case where the polarity of a current (or the direction of a current) is not specified in this specification and the like, the description “a current flows from element A to element B” can be rephrased as “a current flows from element B to element A”. The description “a current is input to element A” can be rephrased as “a current is output from element A”.

Ordinal numbers such as “first”, “second”, and “third” in this specification and the like are used to avoid confusion among components. Thus, the ordinal numbers do not limit the number of components. In addition, the ordinal numbers do not limit the order of components. In this specification and the like, for example, a “first” component in one embodiment can be referred to as a “second” component in other embodiments or the scope of claims. For another example, a “first” component in one embodiment in this specification and the like can be omitted in other embodiments or the scope of claims.

In this specification and the like, the terms for describing positioning, such as “over” and “under”, are sometimes used for convenience to describe the positional relation between components with reference to drawings. The positional relation between components is changed as appropriate in accordance with the direction in which the components are described. Thus, the positional relation is not limited to the terms described in the specification and the like, and can be described with another term as appropriate depending on the situation. For example, the expression “an insulator positioned over (on) the top surface of a conductor” can be replaced with the expression “an insulator positioned under (on) a bottom surface of a conductor” when the direction of a drawing showing these components is rotated by 180°.

Furthermore, the terms “over” and “under” do not necessarily mean that a component is placed directly over or directly under and in direct contact with another component. For example, the expression “electrode B over insulating layer A” does not necessarily mean that the electrode B is formed over and in direct contact with the insulating layer A, and does not exclude the case where another component is provided between the insulating layer A and the electrode B. Similarly, for example, the expression “electrode B above insulating layer A” does not necessarily mean that the electrode B is formed over and in direct contact with the insulating layer A, and does not exclude the case where another component is provided between the insulating layer A and the electrode B. Similarly, for example, the expression “electrode B under insulating layer A” does not necessarily mean that the electrode B is formed under and in direct contact with the insulating layer A, and does not exclude the case where another component is provided between the insulating layer A and the electrode B.

In this specification and the like, components arranged in a matrix and their positional relation are sometimes described using terms such as “row” and “column”. The positional relation between components is changed as appropriate in accordance with the direction in which the components are described. Thus, the positional relation is not limited to the terms described in the specification and the like, and can be described with another term as appropriate depending on the situation. For example, the term “row direction” can be replaced with the term “column direction” when the direction of the diagram is rotated by 90°.

In this specification and the like, the terms “film” and “layer” can be interchanged with each other depending on the situation. For example, the term “conductive layer” can be replaced with the term “conductive film” in some cases. For another example, the term “insulating film” can be replaced with the term “insulating layer” in some cases. Alternatively, the terms “film” and “layer” are not used and can be interchanged with another term depending on the case or the situation. For example, the term “conductive layer” or “conductive film” can be replaced with the term “conductor” in some cases. For another example, the term “insulating layer” or “insulating film” can be replaced with the term “insulator” in some cases.

In this specification and the like, the terms “electrode”, “wiring”, and “terminal” do not limit the functions of such components. For example, an “electrode” is used as part of a “wiring” in some cases, and vice versa. Furthermore, the term “electrode” or “wiring” also includes, for example, the case where a plurality of “electrodes”, “wirings”, or the like are formed in an integrated manner. For example, a “terminal” is used as part of a “wiring” or an “electrode” in some cases, and vice versa. Furthermore, the term “terminal” also includes, for example, the case where one or more selected from “electrodes”, “wirings”, and “terminals” are formed in an integrated manner. Therefore, for example, an “electrode” can be part of a “wiring” or a “terminal”, and a “terminal” can be part of a “wiring” or an “electrode”. Moreover, the term “electrode”, “wiring”, or “terminal” is sometimes replaced with the term “region” depending on the case.

In this specification and the like, the terms “wiring”, “signal line”, and “power supply line” can be interchanged with each other depending on the case or the situation. For example, the term “wiring” can be replaced with the term “signal line” in some cases. For another example, the term “wiring” can be replaced with the term “power supply line” or the like in some cases. Conversely, the term “signal line” or “power supply line” can be replaced with the term “wiring” in some cases. The term “power supply line” can be replaced with the term “signal line” in some cases. Conversely, the term “signal line” can be replaced with the term “power supply line” in some cases. The term “potential” that is applied to a wiring can be replaced with the term “signal” depending on the case or the situation. Conversely, the term “signal” can be replaced with the term “potential” in some cases.

In this specification and the like, a timing chart is used in some cases to describe an operation method of a semiconductor device. In this specification and the like, the timing chart shows an ideal operation example and a period, a level of a signal (e.g., a potential or a current), and a timing described in the timing chart are not limited unless otherwise specified. In the timing chart described in this specification and the like, the level of a signal (e.g., a potential or a current) input to a wiring (including a node) and a timing can be changed depending on the circumstances. For example, even when two periods are shown to have an equal length, the two periods have different lengths in some cases. Furthermore, for example, even when one of two periods is shown long and the other is shown short, the two periods have the equal length in some cases, and the one period has a short length and the other has a long length in other cases.

In this specification and the like, a flowchart is used in some cases to describe an operation method of a semiconductor device. In this specification and the like, processing shown in the flowchart is classified on the operation basis and illustrated as independent steps. However, in actual processing, it is difficult to separate processing shown in the flowchart on the operation basis, and there is a case where a plurality of steps are associated with one step or a case where one step is associated with a plurality of steps. Thus, the processing illustrated in the flowchart is not limited to each step described in the specification, and the steps can be interchanged as appropriate according to circumstances. Specifically, the order of steps can be changed, a step can be added or omitted according to circumstances.

In this specification and the like, a metal oxide is an oxide of a metal in a broad sense. Metal oxides are classified into an oxide insulator, an oxide conductor (including a transparent oxide conductor), an oxide semiconductor (also simply referred to as an OS), and the like. For example, in the case where a metal oxide is included in a channel formation region of a transistor, the metal oxide is referred to as an oxide semiconductor in some cases. That is, when a metal oxide can form a channel formation region of a transistor that has at least one of an amplifying function, a rectifying function, and a switching function, the metal oxide can be referred to as a metal oxide semiconductor. In the case where an OS transistor is mentioned, the OS transistor can also be referred to as a transistor including a metal oxide or an oxide semiconductor.

In this specification and the like, a metal oxide containing nitrogen is also collectively referred to as a metal oxide in some cases. A metal oxide containing nitrogen may be called a metal oxynitride.

In this specification and the like, an impurity in a semiconductor refers to, for example, an element other than a main component of a semiconductor layer. For example, an element with a concentration lower than 0.1 atomic % is an impurity. When an impurity is contained, for example, one or more selected from an increase in the density of defect states in a semiconductor, a decrease in carrier mobility, and a decrease in crystallinity may occur. In the case where the semiconductor is an oxide semiconductor, examples of an impurity that changes the characteristics of the semiconductor include Group 1 elements, Group 2 elements, Group 13 elements, Group 14 elements, Group 15 elements, and transition metals other than the main components; specific examples are hydrogen (contained also in water), lithium, sodium, silicon, boron, phosphorus, carbon, and nitrogen.

In this specification and the like, a switch has a function of being in a conduction state (on state) or a non-conduction state (off state) to control whether a current flows or not. Alternatively, a switch has a function of selecting and changing a current path. Thus, a switch may have two or more terminals through which a current flows, in addition to a control terminal. For example, an electrical switch or a mechanical switch can be used. That is, a switch can be any element capable of controlling a current, and is not limited to a particular element.

Examples of an electrical switch include a transistor (e.g., a bipolar transistor and a MOS transistor), a diode (e.g., a PN diode, a PIN diode, a Schottky diode, a MIM (Metal Insulator Metal) diode, a MIS (Metal Insulator Semiconductor) diode, and a diode-connected transistor (a transistor in which a conduction state is established between its gate and drain)), and a logic circuit in which such elements are combined. Note that in the case of using a transistor as a switch, a “conduction state” of the transistor refers to, for example, a state where a source electrode and a drain electrode of the transistor can be regarded as being electrically short-circuited or a state where a current can be made to flow between the source electrode and the drain electrode. Furthermore, a “non-conduction state” of the transistor refers to a state where the source electrode and the drain electrode of the transistor can be regarded as being electrically disconnected. Note that in the case where a transistor operates just as a switch, there is no particular limitation on the polarity (conductivity type) of the transistor.

An example of a mechanical switch is a switch formed using a MEMS (micro electro mechanical systems) technology. Such a switch includes an electrode that can be moved mechanically, and operates by controlling conduction and non-conduction with movement of the electrode.

In this specification, “parallel” indicates a state where two straight lines are placed at an angle greater than or equal to −10° and less than or equal to 10°. Thus, the case where the angle is greater than or equal to −5° and less than or equal to 5° is also included. In addition, “approximately parallel” or “substantially parallel” indicates a state where two straight lines are placed at an angle greater than or equal to −30° and less than or equal to 30°. Moreover, “perpendicular” indicates a state where two straight lines are placed at an angle greater than or equal to 800 and less than or equal to 100°. Thus, the case where the angle is greater than or equal to 85° and less than or equal to 950 is also included. Furthermore, “approximately perpendicular” or “substantially perpendicular” indicates a state where two straight lines are placed at an angle greater than or equal to 600 and less than or equal to 120°.

In this specification and the like, the structure described in each embodiment can be combined with the structures described in the other embodiments as appropriate to constitute one embodiment of the present invention. In addition, in the case where a plurality of structure examples are described in one embodiment, the structure examples can be combined as appropriate.

Note that a content (or part of the content) described in one embodiment can be applied to, combined with, or replaced with at least one of another content (or part of the content) described in the embodiment and a content (or part of the content) described in one or more different embodiments.

Note that in each embodiment, a content described in the embodiment is a content described using a variety of diagrams or a content described with text disclosed in the specification.

Note that by combining a diagram (or part thereof) described in one embodiment with at least one of another part of the diagram, a different diagram (or part thereof) described in the embodiment, and a diagram (or part thereof) described in one or more different embodiments, much more diagrams can be formed.

Embodiments described in this specification are described with reference to the drawings. Note that the embodiments can be implemented in many different modes, and it will be readily appreciated by those skilled in the art that modes and details can be changed in various ways without departing from the spirit and scope thereof. Therefore, the present invention should not be interpreted as being limited to the description in the embodiments. Note that in the structures of the invention in the embodiments, the same portions or portions having similar functions are denoted by the same reference numerals in different drawings, and repeated description thereof is omitted in some cases. In perspective views and the like, illustration of some components may be omitted for clarity of the drawings.

In this specification and the like, when a plurality of components are denoted with the same reference numerals, and in particular need to be distinguished from each other, an identification sign such as “_1”, “[n]”, or “[m,n]” is sometimes added to the reference numerals. Components denoted with identification signs such as “1”, “[n]”, and “[m,n]” in the drawings and the like are sometimes denoted without such identification signs in this specification and the like when the components do not need to be distinguished from each other.

In the drawings in this specification, the size, the layer thickness, or the region is exaggerated for clarity in some cases. Therefore, they are not limited to the illustrated scale. The drawings are schematic views showing ideal examples, and embodiments of the present invention are not limited to shapes, values, or the like shown in the drawings. For example, variations in a signal, a voltage, or a current due to noise, variations in a signal, a voltage, or a current due to difference in timing, or the like can be included.

### Embodiment 1

In this embodiment, a semiconductor device of one embodiment of the present invention will be described.

### Structure Example of Semiconductor Device

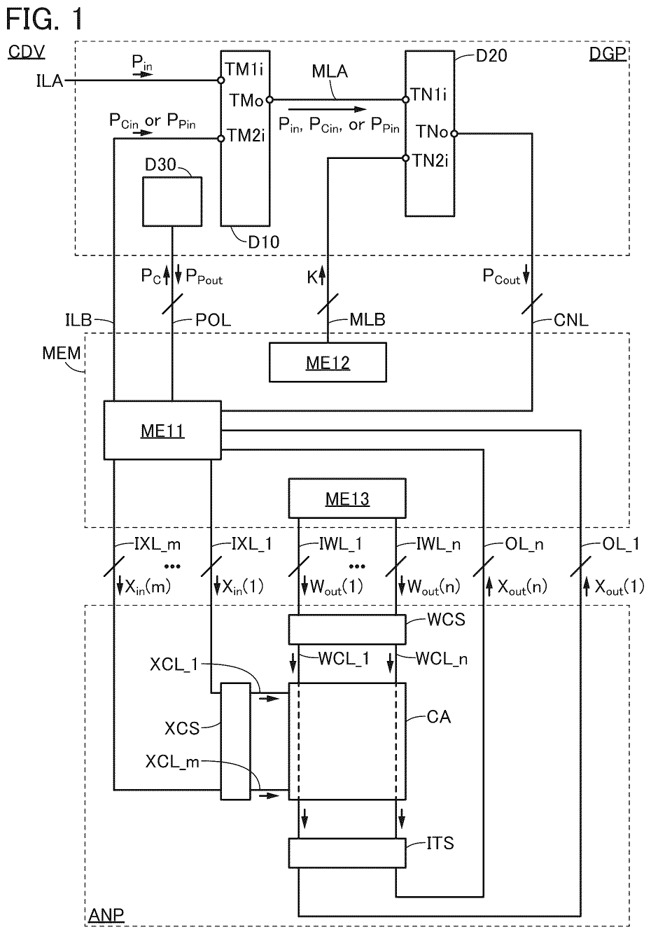

FIG. 1 illustrates a structure example of a semiconductor device CDV of one embodiment of the present invention.

The semiconductor device CDV has a function of an accelerator that executes a program (e.g., kernel program). The program is called from a host program stored in a storage device outside the semiconductor device CDV, for example. The semiconductor device CDV can perform parallel processing of a matrix operation in graphics processing, parallel processing of a product-sum operation of a neural network, or parallel processing of floating-point arithmetic in chemical technology calculation, for example.

Specifically, the semiconductor device CDV can perform an arithmetic operation of a model of a convolutional neural network. The convolutional neural network includes, for example, a convolution layer, a pooling layer, and a fully connected layer; when an image is input to a multilayer structure combining these layers, feature extraction and recognition of the image can be performed.

The semiconductor device CDV includes an arithmetic portion DGP, an arithmetic portion ANP, and a storage portion MEM, for example.

The arithmetic portion DGP is a digital arithmetic circuit that performs an arithmetic operation upon input of input data, which is digital data, and outputs the result of the arithmetic operation as digital data. Specifically, the arithmetic portion DGP has a function of performing a product-sum operation in a convolution layer of the convolutional neural network and outputting the result of the product-sum operation as digital data, for example.

The arithmetic portion ANP is an analog arithmetic circuit that performs an arithmetic operation upon input of input data, which is digital data, and outputs analog data as the result of the arithmetic operation. Specifically, the arithmetic portion ANP has a function of performing a product-sum operation in a fully connected layer of the convolutional neural network and outputting the result of the product-sum operation as analog data, for example.

The storage portion MEM has a function of a storage circuit that stores input data for the arithmetic operation performed in the arithmetic portion DGP or the arithmetic portion ANP, for example. The storage portion MEM also has a function of a storage circuit that stores output data, which is the result of the arithmetic operation performed in the arithmetic portion DGP or the arithmetic portion ANP, for example. Note that in this embodiment, the storage portion MEM is described as a storage circuit that retains digital data. In the case where the arithmetic operation result output from the arithmetic portion ANP is stored in the storage portion MEM, the analog data as the output data from the arithmetic portion ANP is converted into digital data by a digital-analog converter circuit or the like and the digital data is stored in the storage portion MEM.

The arithmetic portion DGP includes a switching circuit D10, an arithmetic circuit D20, and a processing circuit D30, for example.

The storage portion MEM includes a memory circuit portion ME11 to a memory circuit portion ME13, for example.

The arithmetic portion ANP includes a cell array CA, a circuit WCS, a circuit XCS, and a circuit ITS, for example.

An input terminal TM1i of the switching circuit D10 is electrically connected to a wiring ILA, an input terminal TM2i of the switching circuit D10 is electrically connected to a wiring ILB, and an output terminal TMo of the switching circuit D10 is electrically connected to a wiring MLA.

An input terminal TN1i of the arithmetic circuit D20 is electrically connected to the wiring MLA, an input terminal TN2i of the arithmetic circuit D20 is electrically connected to a wiring MLB, and an output terminal TNo of the arithmetic circuit D20 is electrically connected to a wiring CNL.

The processing circuit D30 is electrically connected to a wiring POL.

The memory circuit portion ME11 is electrically connected to the wiring ILB. The memory circuit portion ME11 is electrically connected to the wiring CNL. The memory circuit portion ME11 is electrically connected to the wiring POL. The memory circuit portion ME11 is electrically connected to a wiring IXL_1 to a wiring IXL_m (m is an integer greater than or equal to 1). The memory circuit portion ME12 is electrically connected to the wiring MLB. The memory circuit portion ME13 is electrically connected to a wiring IWL_1 to a wiring IWL_n (n is an integer greater than or equal to 1).

The wiring IWL_1 to the wiring IWL_n are electrically connected to a plurality of input terminals of the circuit WCS. A wiring WCL_1 to a wiring WCL_n are electrically connected to a plurality of output terminals of the circuit WCS.

The wiring IXL_1 to the wiring IXL_m are electrically connected to a plurality of input terminals of the circuit XCS. A wiring XCL_1 to a wiring XCL_m are electrically connected to a plurality of output terminals of the circuit XCS.

In FIG. 1, the wiring WCL_1 to the wiring WCL_n extend in the column direction of the cell array CA. The wiring XCL_1 to the wiring XCL_m extend in the row direction of the cell array CA.

Note that the cell array CA includes a plurality of arithmetic cells, and the arithmetic cells are arranged in a matrix in the cell array CA, for example. As will be described later in detail, an arithmetic cell in the i-th row and the j-th column of the cell array CA (i is an integer greater than or equal to 1 and less than or equal to m, and j is an integer greater than or equal to 1 and less than or equal to n) is electrically connected to the wiring WCL_j and the wiring XCL_i.

The wiring WCL_1 to the wiring WCL_n are electrically connected to a plurality of input terminals of the circuit ITS. A wiring OL_1 to a wiring OL_n are electrically connected to a plurality of output terminals of the circuit ITS.

The wiring ILA functions as a wiring for inputting, to the input terminal TM1i of the switching circuit D10, input data from the outside of the semiconductor device CDV, for example. Note that the input data here can be an image, for example. In FIG. 1, an image Pᵢₙ is shown as the input data.

The wiring ILB functions as a wiring for inputting, to the input terminal TM2i of the switching circuit D10, input data read from the memory circuit portion ME11, for example. Note that the input data here can be, for example, data that has been subjected to convolution processing or data that has been subjected to pooling processing. In FIG. 1, the input data is denoted as “P_{Cin} or P_{Pin}”; P_{Cin} denotes data that has been subjected to convolution processing, and P_{Pin} denotes data that has been subjected to pooling processing.

The wiring MLA functions as a wiring for inputting, to the input terminal TN1i of the arithmetic circuit D20, digital data output from the output terminal TMo of the switching circuit D10, for example. Note that in FIG. 1, the digital data is denoted as “Pᵢₙ, P_{Cin}, or P_{Pin}”.

The wiring MLB functions as a wiring for inputting, to the input terminal TN2i of the arithmetic circuit D20, digital data read from the memory circuit portion ME12, for example. Note that the digital data here can be a filter value for an arithmetic operation of convolution processing performed in the arithmetic circuit D20, for example. In FIG. 1, the filter value is denoted as K.

The wiring CNL functions as a wiring for inputting, to the memory circuit portion ME13, digital data output from the output terminal TNo of the arithmetic circuit D20, for example. Note that the digital data here can be data that is the result of the convolution processing performed in the arithmetic circuit D20, for example. In FIG. 1, the data is denoted as P_{Cout}.

The wiring POL functions as a wiring for inputting, to the processing circuit D30, digital data read from the memory circuit portion ME11, for example. Note that the digital data here can be data to be subjected to pooling processing in the processing circuit D30, for example. In FIG. 1, the data is denoted as P_{C}.

The wiring POL may also function as a wiring for transmitting digital data that has been processed in the processing circuit D30 to the memory circuit portion ME11, for example. Note that the digital data here can be the data that has been subjected to pooling processing in the processing circuit D30, for example. In FIG. 1, the data is denoted as P_{Pout}.

The wiring IWL_1 functions as a wiring for inputting, to the circuit WCS, input data read from the memory circuit portion ME13, for example. Similarly, the wiring IWL_n functions as a wiring for inputting, to the circuit WCS, the input data read from the memory circuit portion ME13, for example. Note that the input data here can be, for example, one of a multiplier and a multiplicand for calculating the product for a product-sum operation in the fully connected layer in the cell array CA. Specifically, the one of the multiplier and the multiplicand here is a weight coefficient. In FIG. 1, the input data is denoted as Wₒᵤₜ(1) and Wₒᵤₜ(n).

The wiring IXL_1 functions as a wiring for inputting, to the circuit XCS, input data read from the memory circuit portion ME11, for example. Similarly, the wiring IXL_m functions as a wiring for inputting, to the circuit XCS, the input data read from the memory circuit portion ME11, for example. Note that the input data here can be, for example, the other of the multiplier and the multiplicand for calculating the product for a product-sum operation in the fully connected layer in the cell array CA. Specifically, the other of the multiplier and the multiplicand here is a value of a signal input to a neuron in the fully connected layer. In FIG. 1, the input data is denoted as Xᵢₙ(1) and Xᵢₙ(m).

The wiring OL_1 functions as a wiring for inputting, to the memory circuit portion ME11, digital data output from the output terminal in the first column of the circuit ITS, for example. Similarly, the wiring OL_n functions as a wiring for inputting, to the memory circuit portion ME11, digital data output from the output terminal in the n-th column of the circuit ITS, for example. Note that the digital data here refers to a value of a signal output from the neuron in the fully connected layer, for example. In FIG. 1, the digital data is denoted as Xₒᵤₜ(1) and Xₒᵤₜ(n).

### [Switching Circuit D10]

The switching circuit D10 has a function of selecting one of the input terminal TM1i and the input terminal TM2i and outputting, to the output terminal TMo, the data input to the selected terminal, for example. In other words, the switching circuit D10 has a function of establishing a conduction state between the output terminal TMo and one of the input terminal TM1i and the input terminal TM2i and establishing a non-conduction state between the output terminal TMo and the other of the input terminal TM1i and the input terminal TM2i.

Although the switching circuit D10 shown in FIG. 1 includes one input terminal TM1i and one input terminal TM2i, the switching circuit D10 may include a plurality of the input terminals TM1i and a plurality of the input terminals TM2i. Similarly, although the switching circuit D10 shown in FIG. 1 includes one output terminal TMo, the switching circuit D10 may include a plurality of the output terminals TMo.

### [Arithmetic Circuit D20]

The arithmetic circuit D20 has a function of calculating the product of the digital data input to the input terminal TN1i and the digital data input to the input terminal TN1i, for example. The arithmetic circuit D20 has a function of adding a plurality of products obtained by arithmetic operations and outputting digital data corresponding to the value (the result of the product-sum operation) to the output terminal TNo.

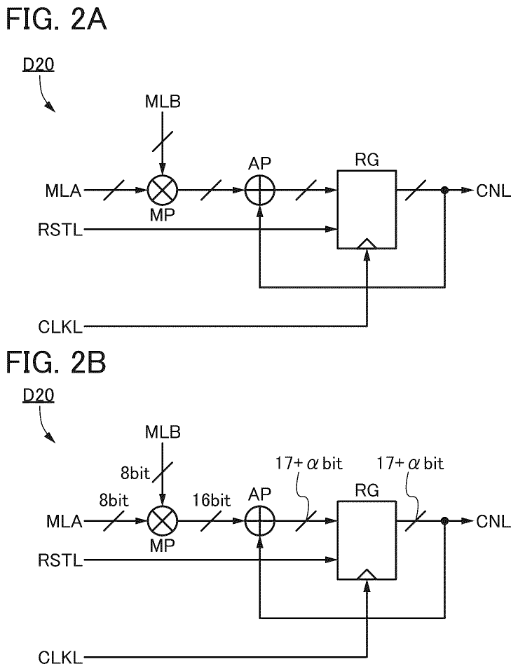

FIG. 2A illustrates an example of the arithmetic circuit D20. The arithmetic circuit D20 illustrated in FIG. 2A includes a multiplier circuit MP, an adder circuit AP, and a register RG.

In the arithmetic circuit D20, the multiplier circuit MP calculates the product of the digital data (e.g., the image Pin, the data P_{Cin}, or the data P_{Pin}) input from the wiring MLA and the digital data (e.g., the filter value K) input from the wiring MLB. The result of the arithmetic operation in the multiplier circuit MP is input to the adder circuit AP, and the output result of the adder circuit AP is retained in the register RG. When the multiplier circuit MP calculates another product after the retention of the output result of the adder circuit AP in the register RG, the adder circuit AP adds the value of the product to the value retained in the register RG, and the result is input to the register RG. This operation is repeated, so that a product-sum operation is performed. The result of the product-sum operation is output to the wiring CNL as digital data. Note that the register RG is controlled by a clock signal input to a wiring CLKL and a reset signal input to a wiring RSTL.

For example, in the case where the arithmetic circuit D20 in FIG. 2A is configured to perform a product-sum operation using 8-bit input data, the digital data processed in the arithmetic circuit D20 in FIG. 2A can be as shown in FIG. 2B. Specifically, when 8-bit digital data from the wiring MLA and 8-bit digital data from the wiring MLB are input to the multiplier circuit MP, the multiplier circuit MP outputs 16-bit digital data as a multiplication result. When 16-bit digital data from the multiplier circuit MP and 17+α-bit digital data output from the register RG are input to the adder circuit AP, the adder circuit AP outputs 17+α-bit digital data as an addition result. Note that a represents the carry generated when the adder circuit AP performs addition.

In the semiconductor device CDV in FIG. 1, the arithmetic circuit D20, which is configured to perform a product-sum operation using data transmitted to the wiring MLA and the wiring MLB, sometimes uses the same filter value (which is rephrased as a weight coefficient, a multiplier, or a multiplicand in some cases) repeatedly in performing convolution processing, for example.

Thus, a structure in which a plurality of the arithmetic circuits D20 illustrated in FIG. 2A are provided and a plurality of product-sum operations are executed at the same time using the same filter values is described below.

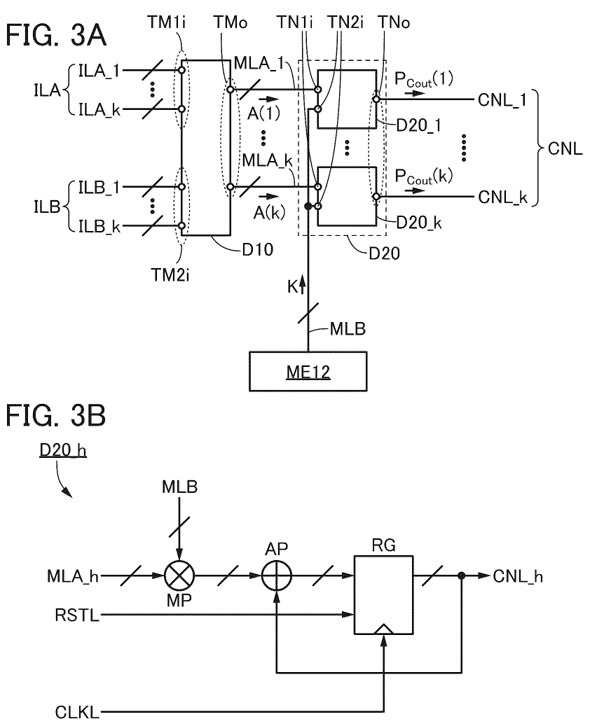

FIG. 3A is a structure example illustrating examples of the switching circuit D10 and the arithmetic circuit D20 that are illustrated in FIG. 1. Note that FIG. 3A also illustrates the memory circuit portion ME12.

In FIG. 3A, the arithmetic circuit D20 includes an arithmetic circuit D20_1 to an arithmetic circuit D20_k, for example.

As each of the arithmetic circuit D20_1 to the arithmetic circuit D20_k, the circuit illustrated in FIG. 2A can be used, for example. Specifically, the arithmetic circuit D20_h (h is an integer greater than or equal to 1 and less than or equal to k) illustrated in FIG. 3B can be used as each of the arithmetic circuit D20_1 to the arithmetic circuit D20_k. For the arithmetic circuit D20_h, the description of the arithmetic circuit D20 in FIG. 2A and FIG. 2B can be referred to.

The wiring ILA includes a wiring ILA_1 to a wiring ILA_k, for example. The wiring ILB includes a wiring ILB_1 to a wiring ILB_k, for example. The wiring MLA includes a wiring MLA_1 to a wiring MLA_k, for example. The wiring CNL includes a wiring CNL_1 to a wiring CNL_k, for example.

A plurality of the output terminals TMo of the switching circuit D10 are electrically connected to the wiring MLA_1 to the wiring MLA_k to have one-to-one correspondence.

The input terminal TN1i of the arithmetic circuit D20_1 is electrically connected to the wiring MLA_1, the input terminal TN2i of the arithmetic circuit D20_1 is electrically connected to the wiring MLB, and the output terminal TNo of the arithmetic circuit D20_1 is electrically connected to the wiring CNL_1. The input terminal TN1i of the arithmetic circuit D20_k is electrically connected to the wiring MLA_k, the input terminal TN2i of the arithmetic circuit D20_k is electrically connected to the wiring MLB, and the output terminal TNo of the arithmetic circuit D20_k is electrically connected to the wiring CNL_k.

In other words, the input terminals TN1i of the arithmetic circuit D20_1 to the arithmetic circuit D20_k are electrically connected to a plurality of the output terminals TNo of the switching circuit D10 to have one-to-one correspondence.

A plurality of pieces of digital data included in a region (Aᵢₙ(x) described later) in the image Pᵢₙ are collectively transmitted to the wiring ILA_1 to the wiring ILA_k. Specifically, for example, a plurality of pieces of digital data included in a region in the image Pin, which are to be subjected to convolution processing performed in the arithmetic circuit D20_1 to the arithmetic circuit D20_k, are transmitted to the wiring ILA_1 to the wiring ILA_k.

A plurality of pieces of digital data included in a region in the data P_{Cin} or a plurality of pieces of digital data included in a region in the data P_{Pin} are transmitted to the wiring ILB_1 to the wiring ILB_k. Specifically, for example, a plurality of pieces of digital data included in a region in the data P_{Cin} or a plurality of pieces of digital data included in a region of the data P_{Pin}, which are to be subjected to convolution processing performed in the arithmetic circuit D20_1 to the arithmetic circuit D20_k, are transmitted to the wiring ILB_1 to the wiring ILB_k.

Here, the switching circuit D10 has a function of selecting one of the input terminal TM1i electrically connected to the wiring ILA_1 and the input terminal TM2i electrically connected to the wiring ILB_1 and outputting, to the output terminal TMo electrically connected to the wiring MLA_1, the data input to the selected terminal, for example. Similarly, the switching circuit D10 has a function of selecting one of the input terminal TM1i electrically connected to the wiring ILA_k and the input terminal TM2i electrically connected to the wiring ILB_k and outputting, to the output terminal TMo electrically connected to the wiring MLA_k, the data input to the selected terminal, for example.

The wiring MLA_1 functions as a wiring for inputting, to the input terminal TN1i of the arithmetic circuit D20_1, digital data output from the first output terminal TMo of the switching circuit D10, for example. Similarly, the wiring MLA_k functions as a wiring for inputting, to the input terminal TN1i of the arithmetic circuit D20_k, digital data output from the k-th output terminal TMo of the switching circuit D10, for example. Note that in FIG. 3A, the digital data is denoted as A(1) and A(k). Furthermore, A(1) and A(k) can each be the above digital data included in a region in the image Pin, the above digital data included in a region in the data P_{Cin}, or the above digital data included in a region in the data P_{Pin}.

The wiring CNL_1 functions as a wiring for inputting, to the memory circuit portion ME13, digital data output from the output terminal TNo of the arithmetic circuit D20_1, for example. Similarly, the wiring CNL_k functions as a wiring for inputting, to the memory circuit portion ME13, digital data output from the output terminal TNo of the arithmetic circuit D20_k, for example. Note that the digital data here can be data that is the result of the convolution processing performed in the arithmetic circuit D20, for example. In FIG. 3A, the data is denoted as P_{Cout}(1) and P_{Cout}(k). Note that P_{Cout} described above can be a collection of P_{Cout}(1) and P_{Cout}(k).

When the structures of the switching circuit D10 and the arithmetic circuit D20 illustrated in FIG. 3A are applied to the semiconductor device CDV in FIG. 1, the same filter values can be input to the arithmetic circuit D20_1 to the arithmetic circuit D20_k, and the arithmetic circuit D20_1 to the arithmetic circuit D20_k can perform product-sum operations at the same time. Note that the order of inputting data in the switching circuit D10 and the arithmetic circuit D20 illustrated in FIG. 3A will be described later.

### [Processing Circuit D30]

The processing circuit D30 has a function of performing pooling processing on the data P_{C} read from the memory circuit portion ME11, for example. The processing circuit D30 also has a function of transmitting, to the memory circuit portion ME11, the data P_{Pout} output by the pooling processing. Note that the processing circuit D30 may also have a function of performing arithmetic processing of a function system (e.g., an activation function) and normalization arithmetic processing (normalization) other than a function of performing pooling processing.

### [Memory Circuit Portion ME11 to Memory Circuit Portion ME13]

The memory circuit portion ME11 functions as a storage device for retaining the input data (e.g., the data P_{Cin} or P_{Pin}) to be input to the arithmetic circuit D20 and the output data (e.g., the data P_{Cout}) output from the arithmetic circuit D20 in the semiconductor device CDV. The memory circuit portion ME12 functions as a storage device for retaining the input data (e.g., the filter value K) to be input to the arithmetic circuit D20. The memory circuit portion ME13 functions as a storage device for retaining Wₒᵤₜ(1) to Wₒᵤₜ(n) (e.g., weight coefficient) as the input data to be input to the circuit WCS.

Specifically, the memory circuit portion ME12 reads the filter value K and transmits the filter value K to the arithmetic circuit D20, for example; thus, the memory circuit portion ME12 is preferably placed near the arithmetic circuit D20. For example, the memory circuit portion ME12 is preferably stacked above or below the arithmetic circuit D20.

The memory circuit portion ME13 reads a weight coefficient and transmits the weight coefficient to the circuit WCS, for example; thus, the memory circuit portion ME13 is preferably placed near the circuit WCS. For example, the memory circuit portion ME13 is preferably stacked above or below the circuit WCS.

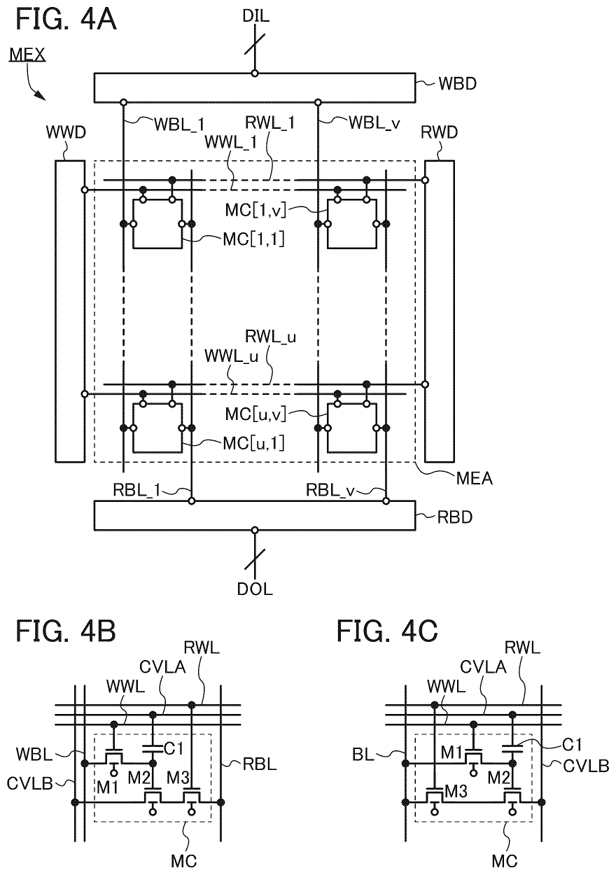

A memory circuit MEX in FIG. 4A is a circuit structure example applicable to each of the memory circuit portion ME11 to the memory circuit portion ME13 included in the semiconductor device CDV.

FIG. 4A illustrates a cell array MEA and a storage cell MC[1,1], a storage cell MC[u,1], a storage cell MC[1,v], and a storage cell MC[u,v], which are arranged in a matrix of u rows and v columns (u is an integer greater than or equal to 1 and v is an integer greater than or equal to 1) in the cell array MEA. FIG. 4A illustrates a wiring WWL_1 to a wiring WWL_u, a wiring RWL_1 to a wiring RWL_u, a wiring WBL_1 to a wiring WBL_v, and a wiring RBL_1 to a wiring RBL_v. FIG. 4A also illustrates a circuit WWD, a circuit RBD, a circuit WBD, and the circuit RBD. FIG. 4A also illustrates a wiring DIL electrically connected to the circuit WBD and a wiring DOL electrically connected to the circuit RBD.

The storage cell MC[1,1] placed in the first row and the first column is electrically connected to the wiring WWL_1, the wiring RWL_1, the wiring WBL_1, and the wiring RBL_1. The storage cell MC[u,1] placed in the u-th row and the first column is electrically connected to the wiring WWL_u, the wiring RWL_u, the wiring WBL_1, and the wiring RBL_1. The storage cell MC[1,v] placed in the first row and the v-th column is electrically connected to the wiring WWL_1, the wiring RWL_1, the wiring WBL_v, and the wiring RBL_v. The storage cell MC[u,v] placed in the u-th row and the v-th column is electrically connected to the wiring WWL_u, the wiring RWL_u, the wiring WBL_v, and the wiring RBL_v.

The circuit WWD is electrically connected to the wiring WWL_1 to the wiring WWL_u. A circuit RWD is electrically connected to the wiring RWL_1 to the wiring RWL_u. The circuit WBD is electrically connected to the wiring WBL_1 to the wiring WBL_v. The circuit RBD is electrically connected to the wiring RBL_1 to the wiring RBL_v.

The circuit WWD functions as a write word line driver circuit, for example. The circuit RWD functions as a read word line driver circuit, for example. The circuit WBD functions as a write bit line driver circuit, for example. The circuit RBD functions as a read bit line driver circuit, for example.

The circuit WBD has a function of receiving input data transmitted to the wiring DIL and transmitting the input data to one selected from the wiring WBL_1 to the wiring WBL_v. The circuit WBD has a function of selecting one of the wiring RBL_1 to the wiring RBL_v and transmitting, to the wiring DOL, the data read from the storage cell MC and flowing through the selected wiring.

For example, in the case where the memory circuit MEX illustrated in FIG. 4A is applied to the memory circuit portion ME11 in FIG. 1, the wiring ILB is electrically connected to the wiring DOL in FIG. 4A. In the case where the memory circuit MEX illustrated in FIG. 4A is applied to the memory circuit portion ME12 in FIG. 1, the wiring MLB is electrically connected to the wiring DOL in FIG. 4A. In the case where the memory circuit MEX illustrated in FIG. 4A is applied to the memory circuit portion ME11 in FIG. 1, the wiring CNL is electrically connected to the wiring DIL in FIG. 4A.

For example, in the case where the memory circuit MEX illustrated in FIG. 4A is applied to the memory circuit portion ME13 in FIG. 1, any one of the wiring IWL_1 to the wiring IWL_n is electrically connected to the wiring DOL in FIG. 4A. In the case where the memory circuit MEX illustrated in FIG. 4A is applied to the memory circuit portion ME11 in FIG. 1, any one of the wiring IXL_1 to the wiring IXL_m is electrically connected to the wiring DOL in FIG. 4A. In the case where the memory circuit MEX illustrated in FIG. 4A is applied to the memory circuit portion ME11 in FIG. 1, the wiring OL_1 to the wiring OL_n are electrically connected to the wiring DIL in FIG. 4A.

Next, a storage cell that can be applied to the storage cell MC[1,1] to the storage cell MC[u,v] is described.

FIG. 4B is a diagram illustrating a circuit structure example applicable to each of the storage cell MC[1,1] to the storage cell MC[u,v] of the memory circuit MEX. In FIG. 4B, the storage cell MC includes a transistor M1, a transistor M2, a transistor M3, and a capacitor C1. The storage cell MC illustrated in FIG. 4B has a structure of a gain cell including three transistors. In particular, when the transistor M1 and the transistor M3 are OS transistors, the storage cell MC is sometimes referred to as a NOSRAM (registered trademark) (Nonvolatile Oxide Semiconductor Random Access Memory).

The transistor M1 and the transistor M3 are preferably OS transistors, for example. Specific examples of a metal oxide included in a channel formation region of the OS transistor include indium oxide, gallium oxide, and zinc oxide. The metal oxide preferably includes one or more selected from indium, an element M, and zinc. The element M is one or more selected from gallium, aluminum, silicon, boron, yttrium, tin, copper, vanadium, beryllium, titanium, iron, nickel, germanium, zirconium, molybdenum, lanthanum, cerium, neodymium, hafnium, tantalum, tungsten, cobalt, magnesium, and antimony. Specifically, the element M is preferably one or more selected from aluminum, gallium, yttrium, and tin. Note that a metal oxide containing indium, the element M, and zinc is referred to as an In-M-Zn oxide in some cases.

It is particularly preferable that an oxide containing indium (In), gallium (Ga), and zinc (Zn) (also referred to as IGZO) be used as the metal oxide used for a semiconductor layer. Alternatively, it is preferable to use an oxide containing indium, tin, and zinc (also referred to as ITZO (registered trademark)). Alternatively, it is preferable to use an oxide containing indium (In), gallium (Ga), tin (Sn), and zinc (Zn). Alternatively, it is preferable to use an oxide containing indium (In), aluminum (Al), and zinc (Zn) (also referred to as IAZO). Alternatively, it is preferable to use an oxide containing indium (In), aluminum (Al), gallium (Ga), and zinc (Zn) (also referred to as IAGZO).

The metal oxide included in the channel formation region of the OS transistor preferably has a stacked-layer structure of a plurality of oxide layers with different chemical compositions. For example, an oxide layer having a two-layer structure of a first layer and a second layer positioned directly over the first layer is considered. The atomic ratio of the element M to the metal element that is a main component in the metal oxide used for the first layer is preferably higher than the atomic ratio of the element M to the metal element that is a main component in the metal oxide used for the second layer. Moreover, the atomic ratio of the element M to In in the metal oxide used for the first layer is preferably higher than the atomic ratio of the element M to In in the metal oxide used for the second layer. With this structure, impurities and oxygen can be inhibited from diffusing into the second layer from the components formed below the first layer.

The atomic ratio of In to the element M in the metal oxide used for the second layer is preferably higher than the atomic ratio of In to the element M in the metal oxide used for the first layer. With this structure, the OS transistor can have a high on-state current and high frequency characteristics.

Specifically, as the metal oxide used for the first layer, a metal oxide with a composition of In:M:Zn=1:3:2 [atomic ratio] or in the neighborhood thereof, a composition of In:M:Zn=1:3:4 [atomic ratio] or in the neighborhood thereof, or a composition of In:M:Zn=1:1:0.5 [atomic ratio] or in the neighborhood thereof can be used, for example. As the metal oxide used for the second layer, a metal oxide with a composition of In:M:Zn=1:1:1 [atomic ratio] or in the neighborhood thereof, a composition of In:M:Zn=1:1:1.2 [atomic ratio] or in the neighborhood thereof, a composition of In:M:Zn=1:1:2 [atomic ratio] or in the neighborhood thereof, or a composition of In:M:Zn=4:2:3 [atomic ratio] or in the neighborhood thereof can be used. Note that a composition in the neighborhood includes the range of ±30% of an intended atomic ratio.

One or more selected from the transistor M1 to the transistor M3 can be, other than an OS transistor, a transistor including silicon in its channel formation region (hereinafter, referred to as a Si transistor). As the silicon, amorphous silicon (referred to as hydrogenated amorphous silicon in some cases), microcrystalline silicon, polycrystalline silicon, single crystal silicon, or the like can be used, for example.

Examples of a transistor that can be used as one or more selected from the transistor M1 to the transistor M3 other than an OS transistor and a Si transistor include a transistor including germanium or the like in its channel formation region, a transistor including a compound semiconductor, such as zinc selenide, cadmium sulfide, gallium arsenide, indium phosphide, gallium nitride, or silicon germanium, in its channel formation region, a transistor including a carbon nanotube in its channel formation region, and a transistor including an organic semiconductor in its channel formation region.

The use of an OS transistor as one or more selected from the transistor M1 to the transistor M3 can reduce the leakage current of the selected transistor, so that power consumption of the arithmetic circuit can be reduced. Specifically, the amount of a leakage current from a retention node (e.g., a first terminal of the transistor M1, a first terminal of the capacitor C1, and a gate of the transistor M2) to the wiring WBL can be extremely small when the transistor M1 is in a non-conduction state; thus, the frequency of refresh operations for the potential of the retention node can be reduced. By reducing the frequency of refresh operations, power consumption of the arithmetic circuit can be reduced.

The circuit WWD, the circuit RWD, the circuit WBD, and the circuit RBD each preferably include a CMOS circuit. The CMOS circuit preferably includes a Si transistor. For example, in the case of fabricating a p-channel transistor, a Si transistor is preferably used rather than an OS transistor in terms of reliability. Thus, it is preferable that the circuit WWD, the circuit RWD, the circuit WBD, and the circuit RBD be formed over a semiconductor substrate including silicon as a material and the storage cell MC be formed above the circuit WWD, the circuit RWD, the circuit WBD, and the circuit RBD.

When semiconductor devices are highly integrated into a chip, heat may be generated in the chip by driving of the circuit. This heat generation increases the temperature of a transistor to change the characteristics of the transistor; thus, the field-effect mobility thereof might change or the operation frequency thereof might decrease, for example. Since an OS transistor has higher heat resistance than a Si transistor, a change in field-effect mobility and a decrease in operation frequency due to a temperature change do not easily occur. Even when having a high temperature, an OS transistor is likely to keep a property of the drain current increasing exponentially with respect to the gate-source voltage. With the use of an OS transistor, an arithmetic operation, processing, or the like can thus be easily performed even in a high-temperature environment. Therefore, in the case where driver circuits such as the circuit WWD, the circuit RWD, the circuit WBD, and the circuit RBD are fabricated over a semiconductor substrate including silicon as a material and a semiconductor device highly resistant to heat due to the driver circuits is formed, an OS transistor is preferably used as the transistor included in the circuit provided above the driver circuits.

In FIG. 4B, back gates are illustrated for the transistor M1 to the transistor M3. Although the connection structure of the back gates is not illustrated, points to which the back gates are electrically connected can be determined at the design stage. For example, in a transistor including a back gate, a gate and the back gate may be electrically connected to each other to increase the on-state current of the transistor. In other words, a gate and the back gate of the transistor M1 may be electrically connected to each other, for example. Furthermore, for example, in a transistor including a back gate, a wiring electrically connecting the back gate of the transistor to an external circuit or the like may be provided and a potential may be supplied to the back gate of the transistor with the external circuit or the like to change the threshold voltage of the transistor or to reduce the off-state current of the transistor.

The transistor M1 to the transistor M3 illustrated in FIG. 4B have back gates; however, the semiconductor device of one embodiment of the present invention is not limited thereto. For example, transistor M1 to the transistor M3 illustrated in FIG. 4B may each be a transistor having a structure not including a back gate, i.e., a single-gate structure. It is also possible that some transistors have a structure including a back gate and the other transistors have a structure not including a back gate.

The transistor M1 to the transistor M3 illustrated in FIG. 4B are n-channel transistors; however, the semiconductor device of one embodiment of the present invention is not limited thereto. For example, the transistor M2 and the transistor M3 may each be an n-channel transistor, and the transistor M1 may be replaced with a p-channel transistor.

The above-described examples of changes in the structure and polarity of the transistor are not limited to the transistor M1 to the transistor M3. For example, the same applies to the transistors described in other parts of this specification or transistors illustrated in other drawings.

The first terminal of the transistor M1 is electrically connected to the gate of the transistor M2 and the first terminal of the capacitor C1, a second terminal of the transistor M1 is electrically connected to the wiring WBL, and the gate of the transistor M1 is electrically connected to the wiring WWL. A first terminal of the transistor M2 is electrically connected to a first terminal of the transistor M3, and a second terminal of the transistor M2 is electrically connected to a wiring CVLB. A second terminal of the transistor M3 is electrically connected to the wiring RBL, and a gate of the transistor M3 is electrically connected to the wiring RWL.

The wiring WWL illustrated in FIG. 4B corresponds to any one of the wiring WWL_1 to the wiring WWL_u illustrated in FIG. 4A. The wiring RWL illustrated in FIG. 4B corresponds to any one of the wiring RWL_1 to the wiring RWL_u illustrated in FIG. 4A. The wiring WBL illustrated in FIG. 4B corresponds to any one of the wiring WBL_1 to the wiring WBL_v illustrated in FIG. 4A. The wiring RBL illustrated in FIG. 4B corresponds to any one of the wiring RBL_1 to the wiring RBL_v illustrated in FIG. 4A.

A wiring CVLA functions as a wiring for supplying a fixed potential. The fixed potential can be, for example, a high-level potential, a low-level potential, a ground potential, or a negative potential. Likewise, the wiring CVLB has a function of supplying any of the above fixed potentials. Note that a potential transmitted to the wiring CVLA and the wiring CVLB may be, for example, a variable potential (also referred to as a pulse voltage or a pulse signal, for example) instead of a fixed potential.

When an OS transistor is used as the transistor M1 in the storage cell MC illustrated in FIG. 4B, a current flowing between a source and a drain of the transistor M1 in an off state (sometimes referred to as leakage current) can be extremely low. That is, the storage cell MC illustrated in FIG. 4B can be used as a nonvolatile memory when an OS transistor is used as the transistor M1 and charge corresponding to data is retained in the memory circuit by utilizing a characteristic of an extremely low leakage current.

Besides the storage cell MC in FIG. 4B, the storage cell MC illustrated in FIG. 4C can be applied to the storage cell MC[1,1] to the storage cell MC[u,v] of the memory circuit MEX in FIG. 4A, for example. The storage cell MC in FIG. 4C is different from the storage cell MC in FIG. 4B in that the wiring WBL and the wiring RBL are combined into one wiring BL. In the structure of the storage cell MC illustrated in FIG. 4C, the number of wirings extending in the column direction can be smaller than that in the structure of the storage cell MC illustrated in FIG. 4B, reducing the circuit area. In some cases, the storage density of a memory storage portion can be increased.

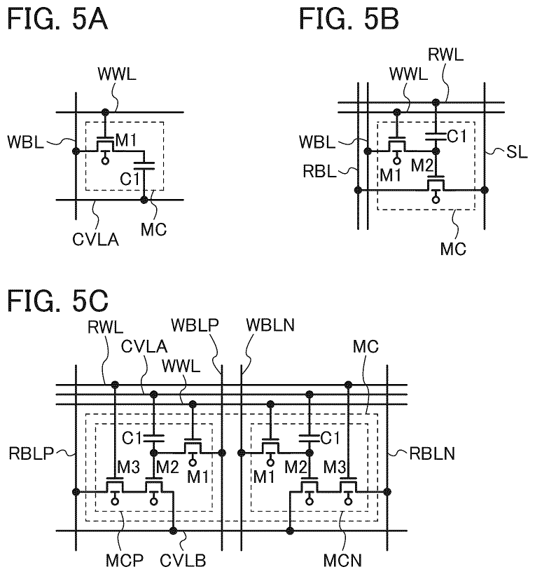

The circuit structure applicable to the memory circuit MEX in FIG. 4A is not limited to the storage cells MC illustrated in FIG. 4B and FIG. 4C. For example, the storage cell MC illustrated in FIG. 5A can be applied to the memory circuit MEX in FIG. 4A. In FIG. 5A, the storage cell MC includes the transistor M1 and the capacitor C1. The storage cell MC illustrated in FIG. 5A includes one transistor. Such a circuit formed of one transistor and one capacitor is sometimes referred to as a DRAM (Dinamic Random Access Memory). Specifically, the storage cell MC in which the transistor M1 is an OS transistor is sometimes referred to as a NOSRAM (registered trademark) (Nonvolatile Oxide Semiconductor Random Access Memory).

FIG. 5A illustrates the storage cell MC including the transistor M1 and the capacitor CL. The above-described OS transistor can be used as the transistor M1.

In FIG. 5A, the first terminal of the transistor M1 is electrically connected to the first terminal of the capacitor C1, the second terminal of the transistor M1 is electrically connected to the wiring WBL, and the gate of the transistor M1 is electrically connected to the wiring WWL. A second terminal of the capacitor C1 is electrically connected to the wiring CVLA.

The wiring WWL illustrated in FIG. 5A functions as a write word line and a read word line. Therefore, in the case where the storage cell MC in FIG. 5A is used as the storage cell MC in the memory circuit MEX in FIG. 4A, the circuit WWD illustrated in FIG. 4A preferably functions as a write word line driver circuit and a read word line driver circuit. In that case, the circuit RWD and the wiring RWL_1 to the wiring RWL_u are not necessarily provided in the memory circuit MEX in FIG. 4A.

The wiring WBL illustrated in FIG. 5A functions as a write bit line and a read bit line. Thus, in the case where the storage cell MC in FIG. 5A is used as the storage cell MC in the memory circuit MEX in FIG. 4A, the wiring WBL_1 to the wiring WBL_v illustrated in FIG. 4A are preferably electrically connected to the circuit RBD. In that case, the wiring RBL_1 to the wiring RBL_v are not necessarily provided in the memory circuit MEX in FIG. 4A.

The circuit structure applicable to the memory circuit MEX in FIG. 4A may be a circuit corresponding to a 2T (two transistors) NOSRAM like the storage cell MC in FIG. 5B, for example. FIG. 5B illustrates the memory circuit MEX including the transistor M1, the transistor M2, and the capacitor C1. The above-described OS transistors can be used as the transistor M1 and the transistor M2.

In FIG. 5B, the first terminal of the transistor M1 is electrically connected to the gate of the transistor M2 and the first terminal of the capacitor C1, the second terminal of the transistor M1 is electrically connected to the wiring WBL, and the gate of the transistor M1 is electrically connected to the wiring WWL. The first terminal of the transistor M2 is electrically connected to the wiring RBL, and the second terminal of the transistor M2 is electrically connected to a wiring SL. The second terminal of the capacitor C1 is electrically connected to the wiring RWL.

The wiring WWL illustrated in FIG. 5B functions as a write word line, and the wiring RWL illustrated in FIG. 5B functions as a read word line. The wiring WBL illustrated in FIG. 5B functions as a write bit line, and the wiring RBL illustrated in FIG. 5B functions as a read bit line.

The wiring SL illustrated in FIG. 5B functions as a source line. Note that a fixed potential or a variable potential may be supplied to the wiring SL. A freely selected amount of a current may be supplied to the wiring SL.

The circuit structure applicable to the memory circuit MEX in FIG. 4A may be a circuit in which NOSRAMs each including three transistors are combined as in the storage cell MC in FIG. 5C, for example. The storage cell MC in FIG. 5C includes a storage cell MCP and a storage cell MCN. The storage cell MCP and the storage cell MCN retain data having different logics. That is, the storage cell MCP and the storage cell MCN function as storage cells that are complementary to each other.

For the structures of the storage cell MCP and the storage cell MCN, the description of the storage cell MC illustrated in FIG. 4B can be referred to. Note that differences of the storage cell MCP and the storage cell MCN illustrated in FIG. 5C from the storage cell MC illustrated in FIG. 4B are described below.

The gates of the transistors M1 included in the storage cell MCP and the storage cell MCN are electrically connected to the wiring WWL. The second terminals of the capacitors C1 included in the storage cell MCP and the storage cell MCN are electrically connected to the wiring CVLA. The gates of the transistors M3 included in the storage cell MCP and the storage cell MCN are electrically connected to the wiring RWL. The second terminals of the transistors M2 included in the storage cell MCP and the storage cell MCN are electrically connected to the wiring CVLB.

In the storage cell MCP, the second terminal of the transistor M1 is electrically connected to a wiring WBLP. The second terminal of the transistor M3 is electrically connected to a wiring RBLP.

In the storage cell MCN, the second terminal of the transistor M1 is electrically connected to a wiring WBLN. The second terminal of the transistor M3 is electrically connected to a wiring RBLN.

The wiring WBLP and the wiring WBLN illustrated in FIG. 5C function as write bit lines. Thus, in the case where the storage cell MC in FIG. 5C is applied to the storage cell MC in the memory circuit MEX in FIG. 4A, the wiring WBLP and the wiring WBLN in FIG. 5C correspond to the wiring WBL in FIG. 4A. The wiring RBLP and the wiring RBLN illustrated in FIG. 5C function as write bit lines. Thus, in the case where the storage cell MC in FIG. 5C is applied to the storage cell MC in the memory circuit MEX in FIG. 4A, the wiring RBLP and the wiring RBLN in FIG. 5C correspond to the wiring RBL in FIG. 4A.

### [Cell Array CA]

Next, the cell array CA included in the arithmetic portion ANP is described.

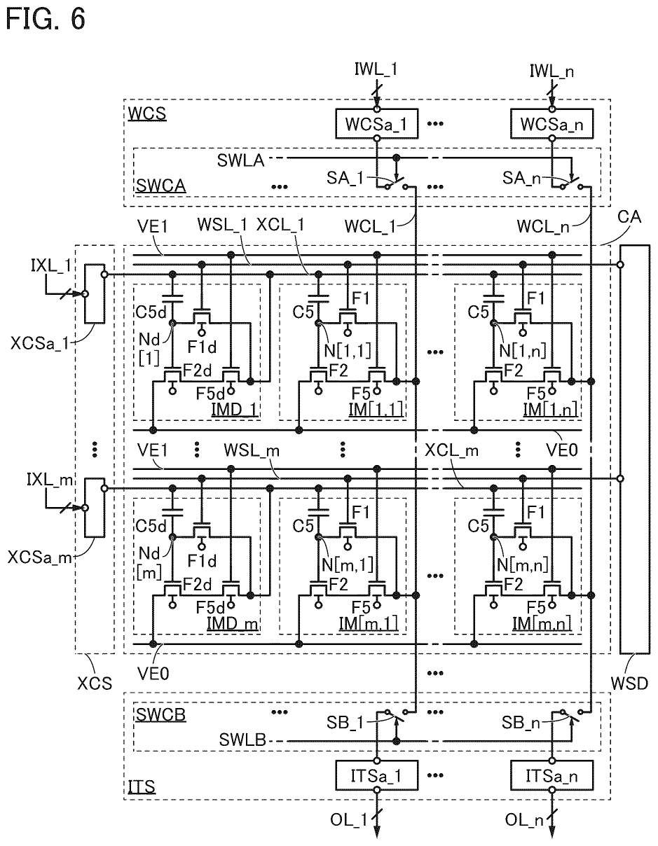

FIG. 6 is a diagram selectively illustrating the cell array CA, a circuit WSD, the circuit WCS, the circuit WSD, the circuit XCS, and the circuit ITS in the arithmetic portion ANP in FIG. 1. Specifically, FIG. 6 illustrates the cell array CA, the circuit WCS, the circuit XCS, and the circuit ITS.

The cell array CA has a function of performing a product-sum operation of a plurality of pieces of first data written to a plurality of arithmetic cells IM and a plurality of pieces of second data transmitted from the circuit XCS to the plurality of arithmetic cells, for example. In this embodiment, the first data and the second data each have a positive value or a “0” value.

The cell array CA includes an arithmetic cell IM[1,1] to an arithmetic cell IM[m,n] and a driving cell IMD_1 to a driving cell IMD_m, for example.

Note that the arithmetic cell IM[1,1] to the arithmetic cell IM[m,n] have the same structure. Thus, in the description common to the arithmetic cell IM[1,1] to the arithmetic cell IM[m,n], the notation of the address is omitted in some cases. Similarly, the driving cell IMD_1 to the driving cell IMD_m have the same structure, and in the description common to the driving cell IMD_1 to the driving cell IMD_m, the notation of the address is omitted in some cases.

The arithmetic cell IM[1,1] to the arithmetic cell IM[m,n] each function as a cell performing multiplication, for example. The driving cell IMD_1 to the driving cell IMD_m each have a function of retaining a potential corresponding to reference data to enable an arithmetic operation to be performed in the arithmetic cell IM[1,1] to the arithmetic cell IM[m,n], for example. Note that the reference data will be described later in detail.

The arithmetic cell IM includes a transistor F1, a transistor F2, a transistor F5, and a capacitor C5, for example. The driving cell IMD includes a transistor F1d, a transistor F2d, a transistor F5d, and a capacitor C5d, for example.

In particular, the structures (e.g., the channel lengths, the channel widths, and the shapes) of the transistors F1 included in the arithmetic cell IM[1,1] to the arithmetic cell IM[m,n] are preferably the same, the structures of the transistors F2 included in the arithmetic cell IM[1,1] to the arithmetic cell IM[m,n] are preferably the same, and the structures of the transistors F5 included in the arithmetic cell IM[1,1] to the arithmetic cell IM[m,n] are preferably the same. The structures of the transistors Fid included in the driving cell IMD_1 to the driving cell IMD_m are preferably the same, the structures of the transistors F2d included in the driving cell IMD_1 to the driving cell IMD_m are preferably the same, and the structures of the transistors F5d included in the driving cell IMD_1 to the driving cell IMD_m are preferably the same. The structures of the transistor F1 and the transistor F1d are preferably the same, the structures of the transistor F2 and the transistor F2d are preferably the same, and the structures of the transistor F5 and the transistor F5d are preferably the same.

By making the transistors have the same structure, the transistors can have substantially the same electrical characteristics. Thus, by making the transistors F1 included in the arithmetic cell IM[1,1] to the arithmetic cell IM[m,n] have the same structure, making the transistors F2 included in the arithmetic cell IM[1,1] to the arithmetic cell IM[m,n] have the same structure, and making the transistors F5 included in the arithmetic cell IM[1,1] to the arithmetic cell IM[m,n] have the same structure, the arithmetic cell IM[1,1] to the arithmetic cell IM[m,n] can perform almost the same operation when under the same conditions. The same conditions here refer to, for example, the potentials of a source, a drain, and a gate of the transistor F1, the potentials of a source, a drain, and a gate of the transistor F2, the potentials of a source, a drain, and a gate of the transistor F5, and voltages input to the arithmetic cell IM[1,1] to the arithmetic cell IM[m,n]. Similarly, by making the transistors F1d included in the driving cell IMD_1 to the driving cell IMD_m have the same structure, making the transistors F2d included in the driving cell IMD_1 to the driving cell IMD_m have the same structure, and making the transistors F5d included in the driving cell IMD_1 to the driving cell IMD_m have the same structure, the driving cell IMD_1 to the driving cell IMD_m can perform almost the same operation when under the same conditions. The same conditions here refer to, for example, the potentials of a source, a drain, and a gate of the transistor F1d, the potentials of a source, a drain, and a gate of the transistor F2d, the potentials of a source, a drain, and a gate of the transistor F5d, and voltages input to the driving cell IMD_1 to the driving cell IMD_m.

Note that the transistor F1 and the transistor F1d may function as switching elements unless otherwise specified. In other words, the gate voltage, the source voltage, and the drain voltage of each of the above transistors may be appropriately biased to voltages in the range where the transistor operates as switching elements. However, one embodiment of the present invention is not limited thereto. For example, the transistor F1 and the transistor F1d in an on state may operate in a linear region or a saturation region or may operate both in a linear region and a saturation region.

Unless otherwise specified, the transistor F2 and the transistor F2d may operate in the subthreshold region (i.e., the gate-source voltage may be lower than the threshold voltage in the transistor F2 or the transistor F2d, further preferably, the drain current increases exponentially with respect to the gate-source voltage). In other words, the gate voltage, the source voltage, and the drain voltage of each of the above transistors may be appropriately biased to voltages in the range where the transistor operates in the subthreshold region. Thus, the transistor F2 and the transistor F2d may operate such that an off-state current flows between the source and the drain.

The transistor F5 and the transistor F5d each function as a clamp transistor (also called a clamp FET in some cases), for example. Thus, a fixed potential is preferably applied to the gates of the transistor F5 and the transistor F5d. Providing the transistor F5 (transistor F5d) can prevent drain-induced barrier lowering (DIBL) in the transistor F2 (transistor F2d), which will be described later in detail.

Meanwhile, in the case where drain-induced barrier lowering (DIBL) in the transistor F2 (transistor F2d) can be ignored, the arithmetic cell IM (driving cell IMD) may have a structure in which the transistor F5 (transistor F5d) is not provided.

As each of the transistor F1, the transistor F1d, the transistor F2, the transistor F2d, the transistor F5, and the transistor F5d, a transistor that can be used as each of the transistor M1 to the transistor M3 can be used. In particular, each of the transistor F1, the transistor F1d, the transistor F2, the transistor F2d, the transistor F5, and the transistor F5d is preferably an OS transistor.

The use of an OS transistor as one or both of the transistor F1 and the transistor F1d can reduce the leakage current of one or both of the transistor F1 and the transistor F1d, so that power consumption of the arithmetic circuit can be reduced. Specifically, the amount of a leakage current from a retention node (e.g., a later-described node N or a later-described node Nd) to a write word line can be extremely small when one or both of the transistor F1 and the transistor F1d is in a non-conduction state; thus, the frequency of refresh operations for the potential of the retention node can be reduced. By reducing the frequency of refresh operations, power consumption of the arithmetic circuit can be reduced. An extremely low leakage current from the retention node to the wiring WCL or the wiring XCL allows the cell to retain the potential of the retention node for a long time, increasing the arithmetic operation accuracy of the arithmetic circuit.

Using an OS transistor also as one or both of the transistor F2 and the transistor F2d enables an operation with a wide range of a current in the subthreshold region, leading to a reduction in the current consumption.

Using OS transistors also as the transistor F2, the transistor F2d, the transistor F5, and the transistor F5d allows the transistor F2, the transistor F2d, the transistor F5, and the transistor F5d to be manufactured concurrently with the transistor F1 and the transistor F1d, which sometimes shortens the manufacturing process of the arithmetic circuit. The transistor F2, the transistor F2d, the transistor F5, and the transistor F5d can be, if not OS transistors, Si transistors.

In each of the arithmetic cell IM[1,1] to the arithmetic cell IM[m,n], a first terminal of the transistor F1 is electrically connected to the gate of the transistor F2. A first terminal of the transistor F2 is electrically connected to a wiring VE0. A first terminal of the capacitor C5 is electrically connected to the gate of the transistor F2. A second terminal of the transistor F2 is electrically connected to a first terminal of the transistor F5. A second terminal of the transistor F5 is electrically connected to a second terminal of the transistor F1, and the gate of the transistor F5 is electrically connected to a wiring VE1.

In each of the arithmetic cell IM[1,1] to the arithmetic cell IM[m,n], the second terminal of the transistor F2 and the wiring WCL are electrically connected in series with each other through the first terminal and the second terminal of the transistor F5, thereby preventing direct application of a high-level potential from the wiring WCL to the second terminal of the transistor F2. Thus, drain-induced barrier lowering in the transistor F2 can be prevented.

In the case where the second terminal of the transistor F2 is directly electrically connected to the wiring WCL (i.e., the case where the transistor F5 is not provided) in each of the arithmetic cell IM[1,1] to the arithmetic cell IM[m,n], direct application of the high-level potential from the wiring WCL to the second terminal of the transistor F2 might cause drain-induced barrier lowering in the transistor F2. When drain-induced barrier lowering occurs in the transistor F2, the threshold voltage of the transistor F2 is lowered, so that the voltage range of the subthreshold region of the transistor F2 might change. As a result, when the arithmetic cell IM[1,1] to the arithmetic cell IM[m,n] each have a structure in which the transistor F5 is not provided, a current in the subthreshold region that flows through the transistor F2 might vary.

In each of the driving cell IMD_1 to the driving cell IMD_m, a first terminal of the transistor F1d is electrically connected to the gate of the transistor F2d. A first terminal of the transistor F2d is electrically connected to the wiring VE0. A first terminal of the capacitor C5d is electrically connected to the gate of the transistor F2d. A second terminal of the transistor F2d is electrically connected to a first terminal of the transistor F5d. A second terminal of the transistor F5d is electrically connected to a second terminal of the transistor F1d, and the gate of the transistor F5d is electrically connected to the wiring VE1.

Like the transistors F5 in the arithmetic cell IM[1,1] to the arithmetic cell IM[m,n], the transistors F5d in the driving cell IMD_1 to the driving cell IMD_m each have a function of preventing drain-induced barrier lowering in the transistor F2d.

The wiring VE0 functions as a wiring for making a current flow between the first terminal and the second terminal of the transistor F2 in each of the arithmetic cell IM[1,1] to the arithmetic cell IM[m,n]. The wiring VE0 functions as a wiring for making a current flow between the first terminal and the second terminal of the transistor F2d in each of the driving cell IMD_1 to the driving cell IMD_m. The wiring VE0 functions as a wiring for supplying a fixed potential, for example. The fixed potential can be, for example, a low-level potential or the ground potential.

The wiring VE1 functions as a wiring for applying a potential to the gates of the transistors F5 in the arithmetic cell IM[1,1] to the arithmetic cell IM[m,n] and the gates of the transistors F5d in the driving cell IMD_1 to the driving cell IMD_m. Note that the potential is preferably a potential within a range where the transistors F5 and the transistors F5d function as clamp transistors.

In the arithmetic cell IM[1,1], the second terminal of the transistor F1 and the second terminal of the transistor F5 are electrically connected to the wiring WCL_1, and the gate of the transistor F1 is electrically connected to a wiring WSL_1. A second terminal of the capacitor C5 is electrically connected to the wiring XCL_1. In the arithmetic cell IM[1,1] in FIG. 6, a connection portion of the first terminal of the transistor F1, the gate of the transistor F2, and the first terminal of the capacitor C5 is a node N[1,1].

In the arithmetic cell IM[m,1], the second terminal of the transistor F1 and the second terminal of the transistor F5 are electrically connected to the wiring WCL_1, and the gate of the transistor F1 is electrically connected to the wiring WSL_m. The second terminal of the capacitor C5 is electrically connected to the wiring XCL_m. In the arithmetic cell IM[m,1] in FIG. 6, a connection portion of the first terminal of the transistor F1, the gate of the transistor F2, and the first terminal of the capacitor C5 is a node N[m,1].

In the arithmetic cell IM[1,n], the second terminal of the transistor F1 and the second terminal of the transistor F5 are electrically connected to the wiring WCL_n, and the gate of the transistor F1 is electrically connected to the wiring WSL_1. The second terminal of the capacitor C5 is electrically connected to the wiring XCL_1. In the arithmetic cell IM[1,n] in FIG. 6, a connection portion of the first terminal of the transistor F1, the gate of the transistor F2, and the first terminal of the capacitor C5 is a node N[1,n].

In the arithmetic cell IM[m,n], the second terminal of the transistor F1 and the second terminal of the transistor F5 are electrically connected to the wiring WCL_n, and the gate of the transistor F1 is electrically connected to the wiring WSL_m. The second terminal of the capacitor C5 is electrically connected to the wiring XCL_m. In the arithmetic cell IM[m,n] in FIG. 6, a connection portion of the first terminal of the transistor F1, the gate of the transistor F2, and the first terminal of the capacitor C5 is a node N[m,n].

In the driving cell IMD_1, the second terminal of the transistor F1d and the second terminal of the transistor F5d are electrically connected to the wiring XCL_1, and the gate of the transistor F1d is electrically connected to the wiring WSL_1. A second terminal of the capacitor C5d is electrically connected to the wiring XCL_1. In the driving cell IMD_1 in FIG. 6, a connection portion of the first terminal of the transistor F1d, the gate of the transistor F2d, and the first terminal of the capacitor C5d is a node Nd[1].

In the driving cell IMD_m, the second terminal of the transistor F1d and the second terminal of the transistor F5d are electrically connected to the wiring XCL_m, and the gate of the transistor F1d is electrically connected to the wiring WSL_1. The second terminal of the capacitor C5d is electrically connected to the wiring XCL_m. In the driving cell IMD_m in FIG. 6, a connection portion of the first terminal of the transistor F1d, the gate of the transistor F2d, and the first terminal of the capacitor C5d is a node Nd[s].

Note that the node N[1,1], the node N[1,n], the node N[m,1], the node N[m,n], the node Nd[1], and a node Nd[m] function as retention nodes of their respective cells.

In each of the arithmetic cell IM[1,1] to the arithmetic cell IM[m,n], for example, when the transistor F1 and the transistor F5 are in an on state, a conduction state is established between the gate and the second terminal of the transistor F2. When a fixed potential applied from the wiring VE0 is the ground potential (GND), the transistor F1 is in an on state, and a current in a current amount I flows from the wiring WCL to the second terminal of the transistor F2, the potential of the gate of the transistor F2 (the node N) is determined in accordance with a current amount I. Since the transistor F1 is in an on state, the potential of the second terminal of the transistor F2 is ideally equal to that of the gate of the transistor F2 (the node N). Here, by turning off the transistor F1, the potential of the gate of the transistor F2 (the node N) is retained by the capacitor C5. Accordingly, the transistor F2 can make a current in a current amount I corresponding to the ground potential of the first terminal of the transistor F2 and the potential of the gate of the transistor F2 (the node N) flow between the source and the drain of the transistor F2. In this specification and the like, such an operation is called “setting (programing) the amount of a current flowing between the source and the drain of the transistor F2 in the arithmetic cell IM to T”, for example.

In a similar manner, the amount of a current flowing between the source and the drain of the transistor F2d in each of the driving cell IMD_1 to the driving cell IMD_m can be set when the transistor F1 is replaced with the transistor F1d, the transistor F2 is replaced with the transistor F2d, and the node N is replaced with the node Nd in the above description.

### [Circuit WSD]

The circuit WSD has a function of selecting a row in the cell array CA to which the first data is to be written, by supplying a predetermined signal to each of the wiring WSL_1 to the wiring WSL_m at the time of writing the first data to the arithmetic cells IM included in the cell array CA, for example.

For example, in FIG. 6, when the circuit WSD supplies a high-level potential to the wiring WSL_1 and supplies a low-level potential to the wiring WSL_2 (not shown) to the wiring WSL_m, the transistor F1 and the transistor F1d each including a gate electrically connected to the wiring WSL1[1] can be turned on and the transistors F1 and the transistors F1d including gates electrically connected to the wiring WSL_2 to the wiring WSL_m can be turned off.

### [Circuit WCS]

The circuit WCS has a function of obtaining the first data, which is digital data, from the memory circuit portion ME11, converting the first data into analog data (current amount), and further supplying the first data converted into the analog data to the arithmetic cells IM included in the cell array CA, for example. In the case where the circuit WCS writes the first data to the arithmetic cell IM[1,1] included in the cell array CA, for example, the circuit WSD described above selects the arithmetic cell IM[1,1] to the arithmetic cell IM[1,n] in the first row of the cell array CA, and then, the circuit WCS supplies the first data to the arithmetic cells in the first column in the cell array CA through the wiring WCL_1.

The circuit WCS includes a circuit SWCA and a circuit WCSa_1 to a circuit WCSa_n, for example.

The circuit SWCA has a function of establishing a conduction state or a non-conduction state between the wiring WCL_1 and the circuit WCSa_1. The circuit SWCA has a function of establishing a conduction state or a non-conduction state between the wiring WCL_n and the circuit WCSa_n.

The circuit SWCA includes a switch SA_1 to a switch SA_n, for example.

A first terminal of the switch SA_1 is electrically connected to the wiring WCL_1, a second terminal of the switch SA_1 is electrically connected to the circuit WCSa_1, and a control terminal of the switch SA_1 is electrically connected to a wiring SWLA. Similarly, a first terminal of the switch SA_n is electrically connected to the wiring WCL_n, a second terminal of the switch SA_n is electrically connected to the circuit WCSa_n, and a control terminal of the switch SA_n is electrically connected to the wiring SWLA.

As each of the switch SA_1 to the switch SA_n, an electrical switch such as an analog switch or a transistor can be used, for example. Specifically, as an electrical switch for each of the switch SA_1 to the switch SA_n, the above-described transistor is preferably used, and in particular, an OS transistor is further preferably used. In the case where an electrical switch is used as each of the switch SA_1 to the switch SA_n, the electrical switch can be a Si transistor other than an OS transistor, for example. For another example, a mechanical switch may be used as each of the switch SA_1 to the switch SA_n.

In this specification and the like, each of the switch SA_1 to the switch SA_n illustrated in FIG. 6 is in an on state when a high-level potential is supplied to the control terminal, and each of the switch SA_1 to the switch SA_n illustrated in FIG. 6 is in an off state when a low-level potential is supplied to the control terminal.

The wiring SWLA functions as a wiring for switching an on state and an off state of each of the switch SA_1 to the switch SA_n, for example. Accordingly, the wiring SWLA is supplied with a high-level potential or a low-level potential.

As described above, the circuit SWCA functions as a circuit that establishes a conduction state or a non-conduction state between the circuit WCSa_1 and the wiring WCL_1, and functions as a circuit that establishes a conduction state or a non-conduction state between the circuit WCSa_n and the wiring WCL_n.

The circuit WCSa_1 is electrically connected to the wiring IWL_1, and the circuit WCSa_n is electrically connected to the wiring IWL_n.

The circuit WCSa_1 has a function of obtaining the first data from the wiring IWL_1 and supplying a signal corresponding to the first data to the wiring WCL_1, for example. Specifically, when the switch SA_1 is in an on state, the circuit WCSa_1 supplies the first data to be stored in any one of the arithmetic cell IM[1,1] to the arithmetic cell IM[m,1] arranged in the first column of the cell array CA. In a similar manner, the circuit WCSa_n has a function of obtaining the first data from the wiring IWL_n and supplying a signal corresponding to the first data to the wiring WCL_n, for example. Specifically, when the switch SA_n is in an on state, the circuit WCSa_n supplies the first data to be stored in any one of the arithmetic cell IM[1,n] to the arithmetic cell IM[m,n] arranged in the n-th column of the cell array CA. Note that in the case of the cell array CA in FIG. 6, the signals are preferably analog data (current amount).

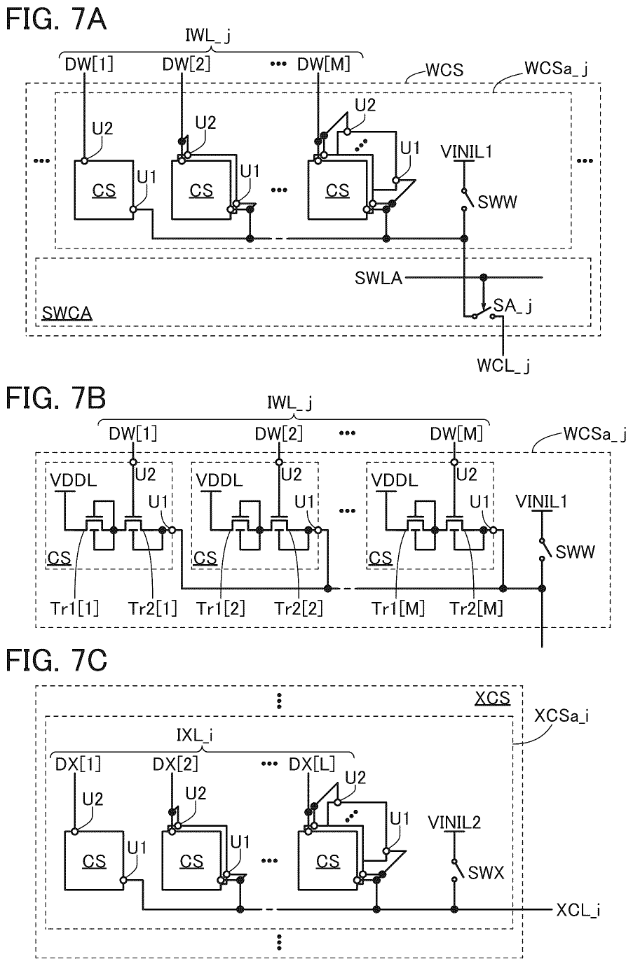

The circuit WCSa_j (j is an integer greater than or equal to 1 and less than or equal to n) can have a structure illustrated in FIG. 7A, for example. FIG. 7A also shows the circuit SWCA, the switch SA_j, the wiring SWLA, and the wiring WCL_j to illustrate electrical connection between the circuit WCSa_j and its peripheral circuits.

The switch SA_j illustrated in FIG. 7A is any one of the switch SA_1 to the switch SA_n included in the circuit SWCA in FIG. 6. Similarly, the wiring WCL_j is any one of the wiring WCL_1 to the wiring WCL_n extending in the cell array CA in FIG. 6.

That is, the circuit WCSa_j is electrically connected to the wiring WCL_j through the switch SA_j.

The circuit WCSa_j illustrated in FIG. 7A includes a switch SWW, for example. A first terminal of the switch SWW is electrically connected to a second terminal of the switch SA_j, and a second terminal of the switch SWW is electrically connected to a wiring VINIL1. The wiring VINIL1 functions as a wiring for supplying an initialization potential to the wiring WCL_j, and the initialization potential can be set to the ground potential (GND), a low-level potential, or a high-level potential. Note that the switch SWW is in an on state only when the initialization potential is supplied to the wiring WCL_j; otherwise, the switch is in an off state.

As the switch SWW, an electrical switch (e.g., an analog switch or a transistor) can be used, for example. When a transistor is used as the switch SWW, for example, the transistor can be a transistor having a structure similar to that of the transistor F1 or the transistor F2. Other than the electrical switch, a mechanical switch may be used.

The circuit WCSa_j in FIG. 7A includes a plurality of current sources CS, for example. Specifically, the circuit WCSa_j has a function of outputting M-bit first data (2^{M} values) (M is an integer greater than or equal to 1) as a current amount; in this case, the circuit WCSa_j includes 2^{M}−1 current sources CS. The circuit WCSa_j includes one current source CS that outputs information corresponding to the first bit value as a current, two current sources CS that output information corresponding to the second bit value as a current, and 2^{M}−1 current sources CS that output information corresponding to the M-th bit value as a current, for example.

Each of the current sources CS in FIG. 7A includes a terminal U1 and a terminal U2. The terminal U1 of each of the current sources CS is electrically connected to the second terminal of the switch SA_j included in the circuit SWCA. The terminal U2 of the one current source CS is electrically connected to a wiring DW[1], the terminals U2 of the two current sources CS are electrically connected to a wiring DW[2], and the terminals U2 of the 2^{K-1} current sources CS are electrically connected to a wiring DW[M].

The plurality of current sources CS included in the circuit WCSa_j have a function of outputting the same amount, I_{Wut}, of a constant current from the terminals U1. In practice, at the manufacturing stage of the semiconductor device CDV, the transistors included in the current sources CS may have different electrical characteristics; this may yield an error. The error between the amounts I_{Wut} of the constant currents output from the terminals U1 of the plurality of current sources CS is thus preferably within 10%, further preferably within 5%, still further preferably within 1%. In this embodiment, the description is made on the assumption that there is no error between the amounts I_{Wut} of the constant currents output from the terminals U1 of the plurality of current sources CS included in the circuit WCSa_j.

The wiring DW[1] to the wiring DW[M] correspond to the wiring IWL_j described above and function as wirings for obtaining the first data, which is digital data from the outside. Specifically, the wiring DW[1] to the wiring DW[M] function as wirings for transmitting signals to make each of the current sources CS electrically connected to the wiring DW[1] to the wiring DW[M] output a constant current of I_{Wut}. For example, when a high-level potential is supplied to the wiring DW[1], the current source CS electrically connected to the wiring DW[1] makes I_{Wut} as the amount of a constant current flow to the second terminal of the switch SA_j, and when a low-level potential is supplied to the wiring DW[1], the current source CS electrically connected to the wiring DW[1] does not output a constant current of I_{Wut}. For example, when a high-level potential is supplied to the wiring DW[2], the two current sources CS electrically connected to the wiring DW[2] make a constant current of 2I_{Wut} in total flow to the second terminal of the switch SA_j, and when a low-level potential is supplied to the wiring DW[2], the current sources CS electrically connected to the wiring DW[2] do not output a constant current of 2I_{Wut} in total. For example, when a high-level potential is supplied to the wiring DW[M], the 2^{M-1} current sources CS electrically connected to the wiring DW[M] make a constant current of 2^{M-1}I_{Wut} in total flow to the second terminal of the switch SA_j, and when a low-level potential is supplied to the wiring DW[M], the current sources CS electrically connected to the wiring DW[M] do not output a constant current of 2^{M-1}I_{Wut} in total.

The current flowing from the one current source CS electrically connected to the wiring DW[1] corresponds to the value of the first bit, the current flowing from the two current sources CS electrically connected to the wiring DW[2] corresponds to the value of the second bit, and the amount of the current flowing from the 2^{M-1} current sources CS electrically connected to the wiring DW[M] corresponds to the value of the M-th bit. The circuit WCSa_j with M of 2 is considered here. For example, when the value of the first bit is “1” and the value of the second bit is “0”, the high-level potential is supplied to the wiring DW[1], and the low-level potential is supplied to the wiring DW[2]. In this case, I_{Wut} flows as a constant current to the second terminal of the switch SA_j of the circuit SWCA from the circuit WCSa_j. For example, when the value of the first bit is “0” and the value of the second bit is “1”, the low-level potential is supplied to the wiring DW[1], and the high-level potential is supplied to the wiring DW[2]. In this case, 2I_{Wut} flows as a constant current to the second terminal of the switch SA_j of the circuit SWCA from the circuit WCSa_j. For example, when the value of the first bit is “1” and the value of the second bit is “1”, the high-level potentials are supplied to the wiring DW[1] and the wiring DW[2]. In this case, 3I_{Wut} flows as a constant current to the second terminal of the switch SA_j of the circuit SWCA from the circuit WCSa_j. For example, when the value of the first bit is “0” and the value of the second bit is “0”, the low-level potentials are supplied to the wiring DW[1] and the wiring DW[2]. In this case, no constant current flows from the circuit WCSa to the second terminal of the switch SA_j of the circuit SWCA.

FIG. 7A illustrates the circuit WCSa_j where M is an integer greater than or equal to 3; when M is 1, the current sources CS electrically connected to the wiring DW[2] to the wiring DW[M] are not provided in the circuit WCSa_j in FIG. 7A. When M is 2, the current sources CS electrically connected to the wiring DW[3](not shown) to the wiring DW[M] are not provided in the circuit WCSa_j in FIG. 7A.

Next, a specific structure example of the current source CS is described.

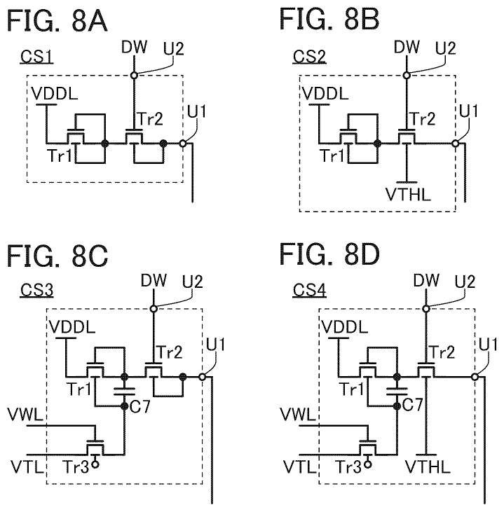

A current source CS1 illustrated in FIG. 8A is a circuit that can be used as the current source CS included in the circuit WCSa in FIG. 7A, and the current source CS1 includes a transistor Tr and a transistor Tr2.

A first terminal of the transistor Tr is electrically connected to a wiring VDDL, and a second terminal of the transistor Tr is electrically connected to a gate of the transistor Tl, a back gate of the transistor Tr1, and a first terminal of the transistor Tr2. A second terminal of the transistor Tr2 is electrically connected to the terminal U1, and a gate of the transistor Tr2 is electrically connected to the terminal U2. The terminal U2 is electrically connected to the wiring DW.

The wiring DW is any one of the wiring DW[1] to the wiring DW[M] in FIG. 7A.

The wiring VDDL functions as a wiring for supplying a fixed potential. The fixed potential can be a high-level potential, for example.

When the fixed potential supplied from the wiring VDDL is the high-level potential, the high-level potential is input to the first terminal of the transistor Tr1. The potential of the second terminal of the transistor Tr is lower than the high-level potential. At this time, the first terminal of the transistor Tr functions as a drain, and the second terminal of the transistor Tr functions as a source. Since the gate of the transistor Tr is electrically connected to the second terminal of the transistor Tr1, the gate-source voltage of the transistor Tr is 0 V. Thus, when the threshold voltage of the transistor Tr is within an appropriate range, a current in the current range of the subthreshold region (drain current) flows between the first terminal and the second terminal of the transistor Tr1. The amount of the current is preferably smaller than or equal to 1.0×10⁻⁸ A, further preferably smaller than or equal to 1.0×10⁻¹² A, still further preferably smaller than or equal to 1.0×10⁻¹⁵ A, for example, when the transistor Tr is an OS transistor. For example, the current is further preferably within a range where the current exponentially increases with respect to the gate-source voltage. That is, the transistor Tr functions as a current source for supplying a current within a current range of the transistor Tr operating in the subthreshold region. The current corresponds to I_{Wut} described above or I_{Xut} described later.

The transistor Tr2 functions as a switching element. When the potential of the first terminal of the transistor Tr2 is higher than the potential of the second terminal of the transistor Tr2, the first terminal of the transistor Tr2 functions as a drain and the second terminal of the transistor Tr2 functions as a source. Since a back gate of the transistor Tr2 and the second terminal of the transistor Tr2 are electrically connected to each other, a back gate-source voltage becomes 0 V. Thus, when the threshold voltage of the transistor Tr2 is within an appropriate range and a high-level potential is input to the gate of the transistor Tr2, the transistor Tr2 is turned on; when a low-level potential is input to the gate of the transistor Tr2, the transistor Tr2 is turned off. Specifically, when the transistor Tr2 is in an on state, the current within the current range of the subthreshold region flows from the second terminal of the transistor Tr to the terminal U1, and when the transistor Tr2 is in an off state, the current does not flow from the second terminal of the transistor Tr to the terminal U1.

The circuit that can be used as the current source CS included in the circuit WCSa_j in FIG. 7A is not limited to the current source CS1 in FIG. 8A. For example, the back gate of the transistor Tr2, which is electrically connected to the second terminal of the transistor Tr2 in the current source CS1, may be electrically connected to another wiring. Such a structure example is illustrated in FIG. 8B. In a current source CS2 illustrated in FIG. 8B, the back gate of the transistor Tr2 is electrically connected to a wiring VTHL. When the wiring VTHL of the current source CS2 is electrically connected to an external circuit or the like, the external circuit or the like supplies a predetermined potential to the wiring VTHL and the back gate of the transistor Tr2 can be supplied with the predetermined potential. This can change the threshold voltage of the transistor Tr2. In particular, the off-state current of the transistor Tr2 can be reduced by an increase in the threshold voltage of the transistor Tr2.

For another example, although the current source CS1 has a structure in which the back gate of the transistor Tr and the second terminal of the transistor Tr are electrically connected to each other, the voltage between the back gate and the second terminal of the transistor Tr2 may be retained with a capacitor. Such a structure example is illustrated in FIG. 8C. A current source CS3 illustrated in FIG. 8C includes a transistor Tr3 and a capacitor C7 in addition to the transistor Tr and the transistor Tr2. The current source CS3 is different from the current source CS1 in that the second terminal of the transistor Tr and the back gate of the transistor Tr are electrically connected to each other through the capacitor C7, and the back gate of the transistor Tr and a first terminal of the transistor Tr3 are electrically connected to each other. In the current source CS3, a second terminal of the transistor Tr3 is electrically connected to a wiring VTL, and a gate of the transistor Tr3 is electrically connected to a wiring VWL. In the current source CS3, the wiring VWL is supplied with a high-level potential to turn on the transistor Tr3, so that a conduction state is established between the wiring VTL and the back gate of the transistor Tr1. In this case, a predetermined potential can be input to the back gate of the transistor Tr from the wiring VTL. The wiring VWL is supplied with a low-level potential to turn off the transistor Tr3, so that the voltage between the second terminal of the transistor Tr and the back gate of the transistor Tr can be retained with the capacitor C7. The threshold voltage of the transistor Tr can be changed when the voltage supplied to the back gate of the transistor Tr is determined by the wiring VTL, and the threshold voltage of the transistor Tr can be fixed with the transistor Tr3 and the capacitor C7.

For example, as the circuit structure that can be used as the current source CS included in the circuit WCSa_j in FIG. 7A, a current source CS4 illustrated in FIG. 8D may be used. The current source CS4 is different from the current source CS3 in FIG. 8C in that the back gate of the transistor Tr2 is electrically connected not to the second terminal of the transistor Tr2 but to the wiring VTHL. That is, in the current source CS4, the threshold voltage of the transistor Tr2 can be changed with the potential supplied from the wiring VTHL, as in the current source CS2 in FIG. 8B.

When a high current flows between the first terminal and the second terminal of the transistor Tr in the current source CS4, to make the current flow from the terminal U1 to the outside of the current source CS4, the on-state current of the transistor Tr2 needs to be increased. In this case, in the current source CS4, the wiring VTHL is supplied with a high-level potential to reduce the threshold voltage of the transistor Tr2 and increase the on-state current of the transistor Tr2, whereby a high current flowing between the first terminal and the second terminal of the transistor Tr can be made to flow from the terminal U1 to the outside of the current source CS4.

The use of any one of the current source CS1 to the current source CS4 illustrated in FIG. 8A to FIG. 8D as each of the current sources CS included in the circuit WCSa_j in FIG. 7A enables the circuit WCSa to output a current corresponding to the M-bit first data. The amount of the current can be the amount of a current flowing between the first terminal and the second terminal of the transistor F1 in the range where the transistor F1 operates in the subthreshold region, for example.

As the circuit WCSa_j in FIG. 7A, the circuit WCSa_j illustrated in FIG. 7B may be used. In the circuit WCSa_j in FIG. 7B, one current source CS in FIG. 8A is connected to each of the wiring DW[1] to the wiring DW[M]. When the channel width of a transistor Tr1[1] is w[1], the channel width of a transistor Tr1[2] is w[2], and the channel width of a transistor Tr1[M] is w[M], the ratio between the channel widths is w[1]:w[2]:w[M]=1:2:2^{M-1}. Since a current flowing between a source and a drain of a transistor that operates in the subthreshold region is proportional to the channel width, the circuit WCSa_j illustrated in FIG. 7B can output a current corresponding to the M-bit first data like the circuit WCSa in FIG. 7A.

As the transistor Tr (including the transistor Tr1[1] to the transistor Tr1[M]), the transistor Tr2 (including a transistor Tr2[1] to a transistor Tr2[M]), and the transistor Tr3, transistors that can be used as the transistor F1 or the transistor F2 can be used, for example. Specifically, as the transistor Tr (including the transistor Tr1[1] to the transistor Tr1[M]), the transistor Tr2 (including the transistor Tr2[1] to the transistor Tr2[M]), and the transistor Tr3, OS transistors are preferably used.

### [Circuit XCS]

The circuit XCS has a function of obtaining the second data, which is digital data, from the memory circuit portion ME11, converting the second data into analog data (current amount), and further supplying the second data to the arithmetic cells included in the cell array CA, for example. In the case where the circuit XCS supplies the second data to the arithmetic cell IM[1,1] to the arithmetic cell IM[1,n] in the first row in the cell array CA, for example, the circuit XCS supplies the second data to the arithmetic cells in the first row in the cell array CA through the wiring XCL_1.

The circuit XCS includes a circuit XCSa_1 to a circuit XCSa_m, for example.

The circuit XCSa_1 is electrically connected to the wiring IXL_1. The circuit XCSa_m is electrically connected to the wiring IXL_m.

The wiring IXL_1 to the wiring IXL_m function as wirings for transmitting the second data, which is digital data, respectively to the circuit XCSa_1 to the circuit XCSa_m from the memory circuit portion ME11.

The circuit XCSa_1 to the circuit XCSa_m have a function of obtaining the later-described reference data from the wiring IXL_1 to the wiring IXL_m and supplying signals corresponding to the reference data to the wiring XCL_1 to the wiring XCL_m, for example. Alternatively, the circuit XCSa_1 to the circuit XCSa_m have a function of obtaining the second data from the wiring IXL_1 to the wiring IXL_m and supplying signals corresponding to the second data, for example. Note that in the case of the cell array CA in FIG. 6, the above signals are preferably analog data (current amount).

FIG. 7C is a block diagram illustrating an example of the circuit XCSa_i (i is an integer greater than or equal to 1 and less than or equal to m) that can be used for the circuit XCS in FIG. 6. FIG. 7C selectively illustrates the circuit XCSa_i corresponding to any one of the circuit XCSa_1 to the circuit XCSa_m. FIG. 7C also shows the wiring XCL_i to illustrate electrical connection between the circuit XCS and its peripheral circuits. Accordingly, the circuit XCSa_i is electrically connected to the wiring XCL_i.

The circuit XCSa_i illustrated in FIG. 7C includes a switch SWX, for example. A first terminal of the switch SWX is electrically connected to the wiring XCL_i, and a second terminal of the switch SWX is electrically connected to a wiring VINIL2. The wiring VINIL2 functions as a wiring for supplying an initialization potential to the wiring XCL_i, and the initialization potential can be set to the ground potential (GND), a low-level potential, or a high-level potential. The initialization potential supplied from the wiring VINIL2 may be the same as the potential supplied from the wiring VINIL1. The switch SWX is in an on state only when the initialization potential is supplied to the wiring XCL_i; otherwise, the switch is in an off state.

As the switch SWX, for example, a switch that can be used as the switch SWW can be used.

The circuit XCSa_i in FIG. 7C can have substantially the same structure as the circuit WCSa_j in FIG. 7A. Specifically, the circuit XCSa_i has a function of outputting the reference data as a current amount, and a function of outputting L-bit second data (2^{L} values) (L is an integer greater than or equal to 1) as a current amount; in this case, the circuit XCSa_i includes 2^{L}−1 current sources CS. The circuit XCSa_i includes one current source CS that outputs information corresponding to the first bit value as a current, two current sources CS that output information corresponding to the second bit value as a current, and 2^{L}−1 current sources CS that output information corresponding to the L-th bit value as a current.

The reference data output from the circuit XCSa_i as a current can be information in which the first bit value is “1” and the second and subsequent bit values are “0”, for example.

In FIG. 7C, the terminal U2 of the one current source CS is electrically connected to a wiring DX[1], the terminals U2 of the two current sources CS are electrically connected to a wiring DX[2], and the terminals U2 of the 2^{L}−1 current sources CS are electrically connected to a wiring DX[L].

The plurality of current sources CS included in the circuit XCSa_i have a function of outputting the same amount, I_{Xut}, of a constant current from the terminals U1. The wiring DX[1] to the wiring DX[L] correspond to the wiring IXL_i described above and function as wirings for obtaining the reference data, which is digital data from the outside, or the second data. Specifically, the wiring DX[1] to the wiring DX[L] function as wirings for transmitting control signals to make each of the current sources CS electrically connected to the wiring DX[1] to the wiring DX[L] output I_{Xut}. In other words, the circuit XCSa_i has a function of making a current in the amount corresponding to the L-bit information transmitted from the wiring DX[1] to the wiring DX[L] flow to the wiring XCL_i.

Specifically, the circuit XCSa_i with L of 2 is considered here. For example, when the value of the first bit is “1” and the value of the second bit is “0”, a high-level potential is supplied to the wiring DX[1], and a low-level potential is supplied to the wiring DX[2]. In this case, I_{Xut} flows as a constant current from the circuit XCSa_i to the wiring XCL_i. For example, when the value of the first bit is “0” and the value of the second bit is “1”, a low-level potential is supplied to the wiring DX[1], and a high-level potential is supplied to the wiring DX[2]. In this case, 2I_{Xut} flows as a constant current from the circuit XCSa_i to the wiring XCL_i. For example, when the value of the first bit is “1” and the value of the second bit is “1”, the high-level potentials are supplied to the wiring DX[1] and the wiring DX[2]. In this case, 3I_{Xut} flows as a constant current from the circuit XCSa_i to the wiring XCL_i. For example, when the value of the first bit is “0” and the value of the second bit is “0”, the low-level potentials are supplied to the wiring DX[1] and the wiring DX[2]. In this case, no constant current flows from the circuit XCSa_i to the wiring XCL_i. In this specification and the like, this case is sometimes rephrased as “a current in an amount of 0 flows from the circuit XCSa_i to the wiring XCL_i”. A current amount 0, I_{Xut}, 2I_{Xut}, 3I_{Xut}, or the like output from the circuit XCSa_i can be the second data output from the circuit XCSa_i; specifically, a current amount I_{Xut} output from the circuit XCSa_i can be the reference data output from the circuit XCSa_i.

When the transistors in the current sources CS included in the circuit XCSa_i have different electrical characteristics and this yields an error, the error between the amounts I_{Xut} of the constant currents output from the terminals U1 of the plurality of current sources CS is preferably within 10%, further preferably within 5%, still further preferably within 1%. In this embodiment, the description is made on the assumption that there is no error between the amounts I_{Xut} of the constant currents output from the terminals U1 of the plurality of current sources CS included in the circuit XCSa_i.

As each of the current sources CS of the circuit XCSa_i, any one of the current source CS1 to the current source CS4 in FIG. 8A to FIG. 8D can be used in a manner similar to that of the current sources CS of the circuit WCSa_j. In that case, the wiring DW[1] to the wiring DW[M] illustrated in FIG. 8A to FIG. 8D are replaced with the wiring DX[1] to the wiring DX[L]. This allows the circuit XCSa_i to make a current within the current range of the subthreshold region flow to the wiring XCL_i as the reference data or the L-bit second data.

The circuit XCSa_i in FIG. 7C can have a circuit structure similar to that of the circuit WCSa_j illustrated in FIG. 7B. In that case, the circuit WCSa_j illustrated in FIG. 7B is replaced with the circuit XCSa_i, the wiring IWL_j is replaced with the wiring IXL_i, the wiring DW[1] is replaced with the wiring DX[1], the wiring DW[2] is replaced with the wiring DX[2], the wiring DW[M] is replaced with the wiring DX[L], the switch SWW is replaced with the switch SWX, and the wiring VINIL1 is replaced with the wiring VINIL2.

### [Circuit ITS]

The circuit ITS includes, for example, an arithmetic circuit of a function system (e.g., a nonlinear function system) and an analog-digital converter circuit. In particular, the arithmetic circuit of a function system preferably has a function of performing an arithmetic operation of a function system using a value corresponding to the amount of an input current as an input value and outputting digital data (voltage) corresponding to the result of the arithmetic operation, for example.

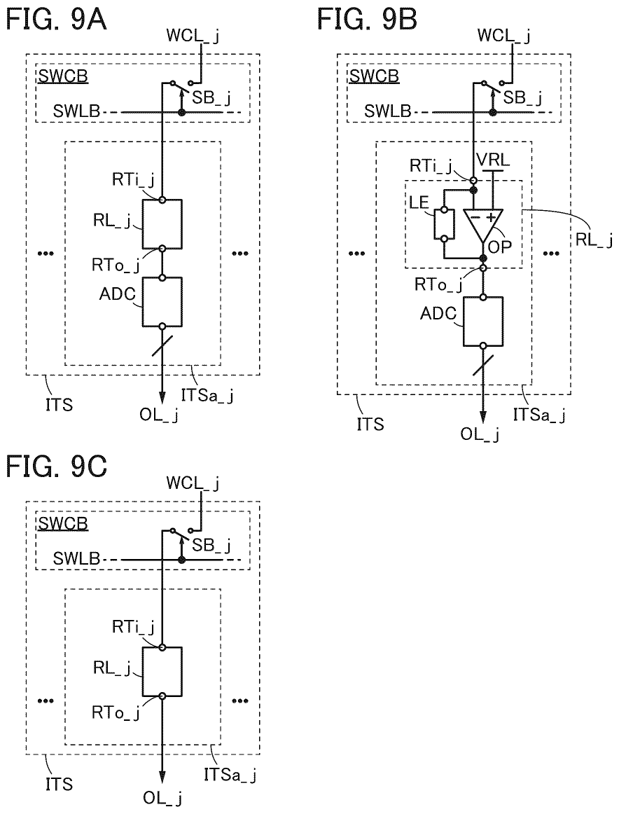

FIG. 9A illustrates a circuit structure example of the circuit ITS. The circuit ITS illustrated in FIG. 9A is an example of a circuit that can be used as the circuit ITS illustrated in FIG. 1 and FIG. 6. FIG. 9A also shows the wiring WCL_j to illustrate electrical connection between the circuit ITS and its peripheral circuit. The wiring WCL_j is any one of the wiring WCL_1 to the wiring WCL_n illustrated in FIG. 1 and FIG. 6, and a switch SB_j is any one of a switch SB_1 to a switch SB_n included in a circuit SWCB illustrated in FIG. 6.

As the switch SB_j, for example, a switch that can be used as the switch SA_1 to the switch SA_n illustrated in FIG. 6 can be used. For example, an electrical switch or a mechanical switch can be used as the switch SB_j.

The circuit ITS in FIG. 9A includes the circuit SWCB and a circuit ITSa_1 to a circuit ITSa_n. Note that FIG. 9A selectively illustrates the circuit ITSa_j, which is any one of the circuit ITSa_1 to the circuit ITSa_n. The circuit ITSa_j includes a converter circuit RL_j and an analog-digital converter circuit ADC.

The converter circuit RL_j includes a terminal RTi_j and a terminal RTo_j.

A first terminal of the switch SB_j is electrically connected to the wiring WCL_j, a second terminal of the switch SB_j is electrically connected to the terminal RTi_j of the converter circuit RL_j, and a control terminal of the switch SB_j is electrically connected to a wiring SWLB. The terminal RTo_j of the converter circuit RL_j is electrically connected to an input terminal of the analog-digital converter circuit ADC, and an output terminal of the analog-digital converter circuit ADC is electrically connected to a wiring OL_j.

The wiring SWLB functions as a wiring for switching an on state and an off state of each of the switch SB_1 to the switch SB_n, for example. Accordingly, the wiring SWLB is supplied with a high-level potential or a low-level potential.

The wiring OL_j (the wiring OL_1 to the wiring OL_n in FIG. 1) functions as a wiring for outputting the result of an arithmetic operation performed in the semiconductor device CDV, as digital data, to the memory circuit portion ME11.

The converter circuit RL_j can be the above-described arithmetic circuit of a function system. The arithmetic circuit of a function system can be, for example, an arithmetic circuit of a nonlinear function such as a sigmoid function, a tanh function, a softmax function, a ReLU function, or a threshold function. The converter circuit RL_j may include a circuit performing pooling processing, instead of the arithmetic circuit of a function system. In the case of the structure in FIG. 9A, the converter circuit RL_j preferably outputs a voltage from the terminal RTo_j.

The converter circuit RL_j may be a current-voltage converter circuit.

In the case where the converter circuit RL_j is a current-voltage converter circuit, for example, the converter circuit RL_j preferably generates an analog voltage corresponding to a current input from the wiring WCL_j to the terminal RTi_j of the converter circuit RL_j through the switch SB_j and outputs the analog voltage to the terminal RTo_j of the converter circuit RL_j.

The analog-digital converter circuit ADC preferably converts an analog voltage supplied from the terminal RTo_j of the converter circuit RL_j into a digital signal and outputs the digital signal to the wiring OL_j.

FIG. 9B illustrates a structure example of the circuit ITS in which the converter circuit RL_j is a current-voltage converter circuit. The converter circuit RL_j illustrated in FIG. 9B includes a load LE and an operational amplifier OP, for example.

An inverting input terminal of the operational amplifier OP is electrically connected to a first terminal of the load LE and the second terminal of the switch SB_j. A non-inverting input terminal of the operational amplifier OP is electrically connected to a wiring VRL. An output terminal of the operational amplifier OP is electrically connected to a second terminal of the load LE and the terminal RTo_j.

The wiring VRL functions as a wiring for supplying a fixed potential. The fixed potential can be the ground potential (GND), a low-level potential, or the like, for example.

In particular, by setting the fixed potential supplied from the wiring VRL to the ground potential (GND), the inverting input terminal of the operational amplifier OP is virtually grounded, and thus, the analog voltage output to the wiring OL_j can be a voltage with reference to the ground potential (GND).

By having the structure in FIG. 9B, the circuit ITS can output a value corresponding to the amount of a current flowing from the wiring WCL_j to the terminal RTi_j of the converter circuit RL_j through the switch SB_j, as an analog voltage, to the terminal RTo_j. The analog voltage can be converted into a digital signal by the analog-digital converter circuit ADC, and the digital signal can be output to the wiring OL_j.

Note that in the case where the circuit ITS outputs not a digital signal but an analog voltage to the wiring OL_j, the analog-digital converter circuit ADC in the circuit ITSa_j may be omitted as in the circuit ITS illustrated in FIG. 9C. In FIG. 9C, the converter circuit RL_j preferably performs an arithmetic operation of a function system using, as an input value, a value corresponding to the amount of a current flowing to the terminal RTi_j, and outputs the result of the arithmetic operation as an analog current to the terminal RTo_j. This makes the circuit ITS illustrated in FIG. 9C effective in the case where the result of the arithmetic operation in the circuit ITS is not retained in the memory circuit portion ME11 but directly input to an analog arithmetic circuit that performs an arithmetic operation in the next fully connected layer, for example.

### Operation Example of Semiconductor Device

Next, an operation example of the semiconductor device CDV illustrated in FIG. 1 is described. Note that the switching circuit D10 and the arithmetic circuit D20 included in the semiconductor device CDV have the structures illustrated in FIG. 3A.

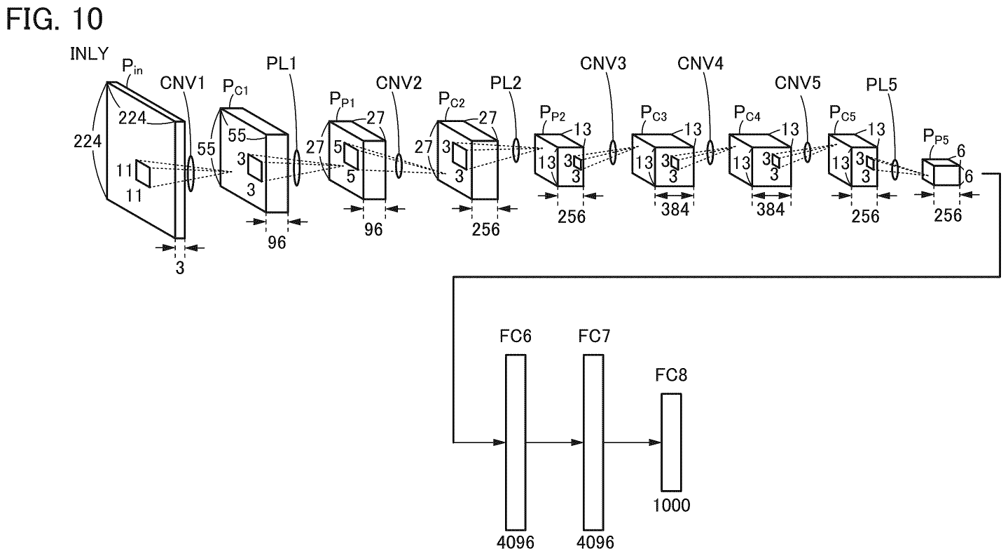

Here, an operation of the semiconductor device CDV for performing an arithmetic operation of an AlexNet illustrated in FIG. 10 is described. The AlexNet in FIG. 10 includes an input layer INLY, a convolution layer CNV1 to a convolution layer CNV5, a pooling layer PL1, a pooling layer PL2, a pooling layer PL5, and a fully connected layer FC6 to a fully connected layer FC8. Note that in the AlexNet in FIG. 10, the input layer INLY, the convolution layer CNV1, the pooling layer PL1, the convolution layer CNV2, the pooling layer PL2, the convolution layer CNV3, the convolution layer CNV4, the convolution layer CNV5, the pooling layer PL5, the fully connected layer FC6, the fully connected layer FC7, and the fully connected layer FC8 are provided in this order.

### [Input Layer INLY]

In the operation in the input layer INLY, the image Pᵢₙ of 224×224 pixels is input to the semiconductor device CDV in FIG. 1, for example. Note that one pixel includes subpixels of red, green, and blue, and the total number of subpixels is three colors (red, green, and blue)×224×224. The number of channels of the image Pᵢₙ is three: red, green, and blue. Thus, the number of pieces of image data included in the image Pᵢₙ and input to the semiconductor device CDV is 3×224×224.

In the semiconductor device CDV in FIG. 1, the image Pᵢₙ is input to the wirings ILA. Thus, the image Pᵢₙ is input to the input terminals TM1i of the switching circuit D10 in the arithmetic portion DGP.

Note that in this operation example, the input value in the x-th row and the y-th column included in the z-th (here, z is an integer greater than or equal to 1 and less than or equal to 3) input channel in the image Pᵢₙ is denoted as pᵢₙ[x,y,z]. Note that x indicates the address of a row of the image Pin, and y indicates the address of a column of the image Pin. That is, in the input layer INLY, x is an integer greater than or equal to 1 and less than or equal to 224, and y is an integer greater than or equal to 1 and less than or equal to 224.

### [Convolution Layer CNV1]

In the convolution layer CNV1, the arithmetic circuit D20 performs convolution processing on the image Pᵢₙ. Specifically, the arithmetic circuit D20 performs a product-sum operation of a filter (also referred to as kernel) used for the convolution processing CNV1 and image data included in a region Aᵢₙ selected from the image Pᵢₙ.

In the convolution layer CNV1, convolution processing is performed on a region selected from the image Pᵢₙ with the filter size (also referred to as kernel size) set to 11, the number of output channels (also referred to as the number of kernels) set to 96, and the stride set to 4. The number of filter values in one kernel is (filter size)²×(the number of input channels). Since the number of input channels of the image Pᵢₙ is 3, the number of filter values for one kernel in the convolution layer CNV1 is 11×11×3.

Here, the s-th (s is an integer greater than or equal to 1 and less than or equal to 96 here) kernel in the convolution layer CNV1 is referred to as K_{C1}^{(s)}. A filter value included in a kernel K_{C1} is denoted as k_{C1}^{(s)}[p,q,r]. Note that p indicates the address of a row of the kernel, q indicates the address of a column of the kernel, and r indicates the ordinal number of the input channel. That is, in the convolution layer CNV1, p is an integer greater than or equal to 1 and less than or equal to 11, q is an integer greater than or equal to 1 and less than or equal to 11, and r is an integer greater than or equal to 1 and less than or equal to 3.

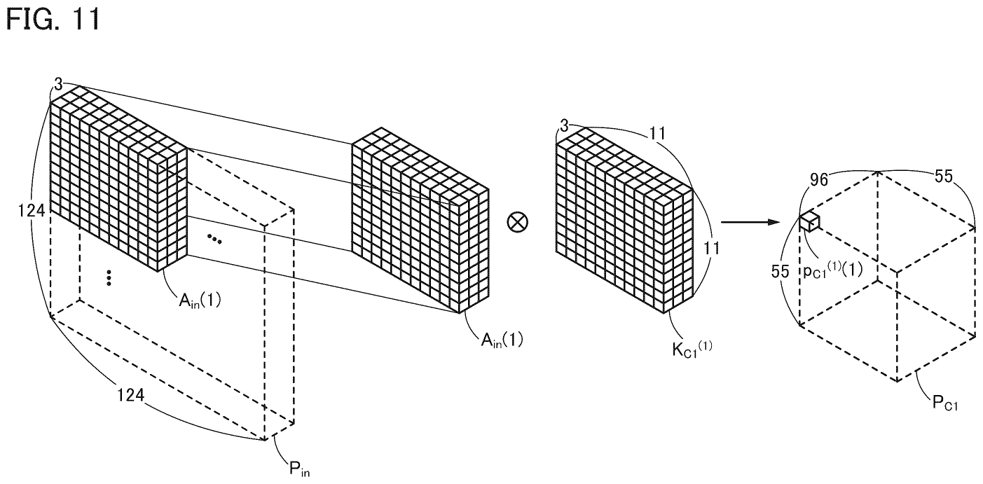

For example, FIG. 11 illustrates an example in which a product-sum operation of a region Aᵢₙ(1) selected from the image Pᵢₙ and a kernel K_{C1}⁽¹⁾ is performed and data p_{C1}⁽¹⁾(1) that is the arithmetic operation result is output. Note that x of a region Aᵢₙ(x) represents the ordinal number of the region selected from the image Pᵢₙ. Furthermore, s of data p_{C1}^{(s)}(x) represents the ordinal number of the output channel. Furthermore, x of the data p_{C1}^{(s)}(x) corresponds to the ordinal number x of the region Aᵢₙ(x).

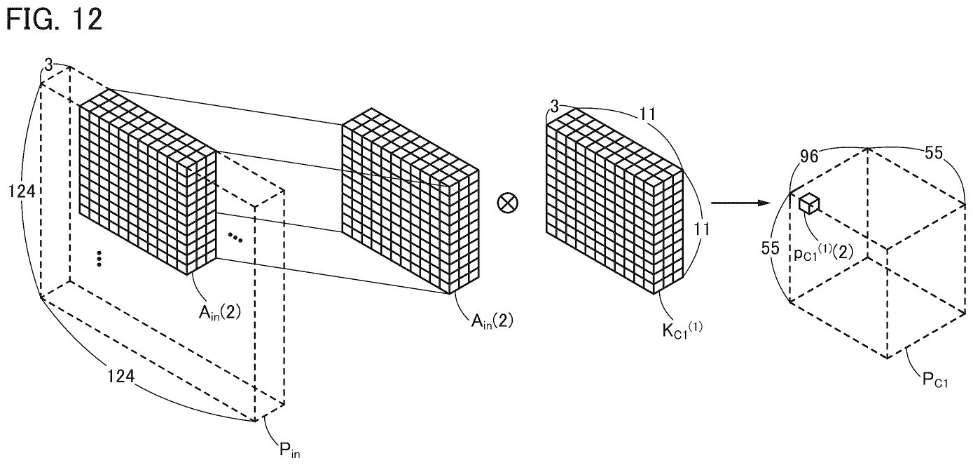

Since the stride is 4, a region shifted from the region Aᵢₙ(1) by 4 in the row direction is a region Aᵢₙ(2). For example, FIG. 12 illustrates an example in which a product-sum operation of the region Aᵢₙ(2) selected from the image Pᵢₙ and the kernel K_{C1}⁽¹⁾ is performed and data p_{C1}⁽¹⁾(2) that is the arithmetic operation result is output.

Note that in the case where the number of pixels of the image Pᵢₙ is 224×224 and the stride is 4, the number of regions selected from the image Pᵢₙ is 3025 (=55²). In this embodiment, the regions are referred to as the region Aᵢₙ(1) to a region Aᵢₙ(3025).

As described above, the region selected from the image Pᵢₙ is sequentially shifted in accordance with the stride, and every time the region is shifted, a product-sum operation of the region and the kernel K_{C1}⁽¹⁾ is performed, so that output data in a matrix of 55 rows and 55 columns can be obtained. Since the kernels included in the convolution layer CNV1 are the kernel K_{C1}⁽¹⁾ to a kernel K_{C1}⁽⁹⁶⁾ (since the number of kernels of the convolution layer CNV1 is 96), P_{C1}, which is 55×55×96 pieces of output data, is resultantly output from the convolution layer CNV1.

In the convolution processing in the convolution layer CNV1, product-sum operations of one kernel and a plurality of regions selected from the image Pᵢₙ are performed. Thus, in a preferable structure of the arithmetic circuit, calculations of the products of filter values included in one kernel and data included in the plurality of regions selected from the image Pᵢₙ are collectively performed, for example.

For example, in the structure of the semiconductor device CDV illustrated in FIG. 1 and FIG. 3, it is preferable that data included in the region Aᵢₙ(1) be transmitted to the input terminal TN1i of the arithmetic circuit D20_1 (the wiring MLA_1), data included in the region Aᵢₙ(2) be transmitted to the input terminal TN1i of the arithmetic circuit D20_2 (not illustrated) (the wiring MLA_2), and data included in the region Aᵢₙ(3) be transmitted to the input terminal TN1i of the arithmetic circuit D20_3 (not illustrated) (the wiring MLA_3). Similarly, it is preferable that data included in the region Aᵢₙ(3025) be transmitted to the wiring MLA_3025. In that case, k of each of the wiring MLA_k and the arithmetic circuit D20_k illustrated in FIG. 3 is preferably greater than or equal to 3025.

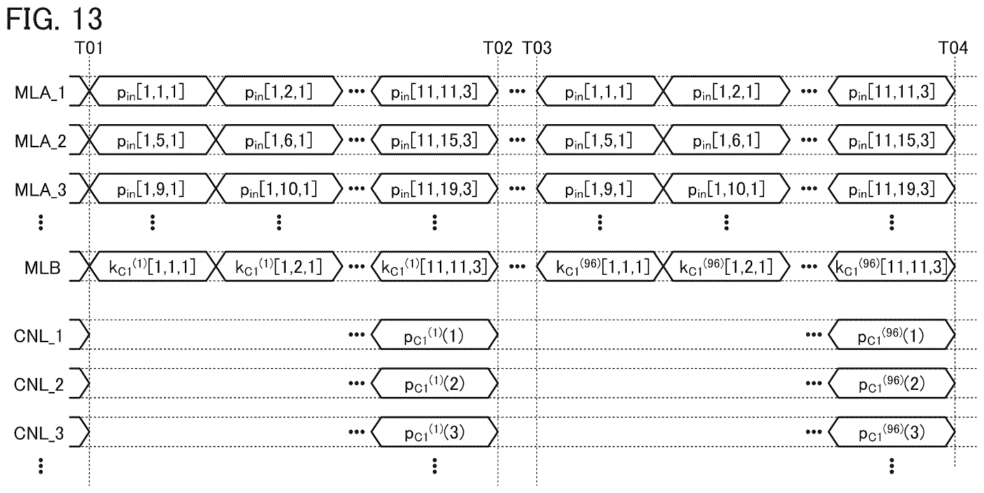

A specific transmission order of data is shown in the timing chart in FIG. 13. The timing chart in FIG. 13 shows data input to the wiring MLA_1 to the wiring MLA_3 (the input terminals TN1i of the arithmetic circuits D20), filter values input to the wiring MLB (the input terminals TN2i of the arithmetic circuits D20), and data output to the wiring CNL_1 to the wiring CNL_3 (the output terminals TNo of the arithmetic circuits D20) in and around the period from Time T01 to Time T04.

First, the period from Time T01 to Time T02 is considered. It is preferable that when a filter value k_{C1}⁽¹⁾[1,1,1] of the kernel K_{C1}⁽¹⁾ is input to the wiring MLB (i.e., when the filter value k_{C1}⁽¹⁾[1,1,1] is read from the memory circuit portion ME12), pᵢₙ[1,1,1] be input to the wiring MLA_1, pᵢₙ[1,5,1] be input to the wiring MLA_2, and pᵢₙ[1,9,1] be input to the wiring MLA_3. Furthermore, it is preferable that when the filter value input to the wiring MLB changes from k_{C1}⁽¹⁾[1,1,1] to k_{C1}⁽¹⁾[1,2,1] (i.e., when the filter value k_{C1}⁽¹⁾[1,2,1] is read from the memory circuit portion ME12), pᵢₙ[1,2,1] be input to the wiring MLA_1, pᵢₙ[1,6,1] be input to the wiring MLA_2, and pᵢₙ[1,10,1] be input to the wiring MLA_3.

In the above manner, calculations of the products of the data included in the region Aᵢₙ(1) to the region Aᵢₙ(3025) and the filter values included in the kernel K_{C1}⁽¹⁾ proceed to the end, so that the arithmetic circuit D20_1 outputs p_{C1}⁽¹⁾(1), which is the result of the product-sum operation of the region Aᵢₙ(1) and the kernel K_{C1}⁽¹⁾, to the wiring CNL_1. The arithmetic circuit D20_2 outputs p_{C1}⁽¹⁾(2), which is the result of the product-sum operation of the region Aᵢₙ(2) and the kernel K_{C1}⁽¹⁾, to the wiring CNL_2. The arithmetic circuit D20_3 outputs p_{C1}⁽¹⁾(3), which is the result of the product-sum operation of the region Aᵢₙ(3) and the kernel K_{C1}⁽¹⁾, to the wiring CNL_3.

Furthermore, p_{C1}⁽¹⁾(1) to p_{C1}⁽¹⁾(3025) output to the wiring CNL_1 to the wiring CNL_3025 are written to the memory circuit portion ME11.

In the period from Time T02 to Time T03, convolution processing for the region Aᵢₙ(1) to the region Aᵢₙ(3025) is performed using the kernel K_{C1}⁽²⁾ as in the period from Time T01 to Time T02. At this time, the obtained data (e.g., p_{C1}⁽²⁾(1) to p_{C1}⁽²⁾(3025)) is written to the memory circuit portion ME11.

After the convolution processing with the kernel K_{C1}⁽²⁾ ends, convolution processing for the region Aᵢₙ(1) to the region Aᵢₙ(3025) is performed using the kernel K_{C1}⁽³⁾ to the kernel K_{C1}⁽⁹⁵⁾ sequentially changed. Data output from the wiring CNL_1 to the wiring CNL_3025 for each of the kernel K_{C1}⁽³⁾ to the kernel K_{C1}⁽⁹⁵⁾ is written to the memory circuit portion ME11 in the above manner.

In the period from Time T03 to Time T04, convolution processing for the region Aᵢₙ(1) to the region Aᵢₙ(3025) is performed using the kernel K_{C1}⁽⁹⁶⁾ as in the period from Time T01 to Time T02. Calculations of the products of the data included in the region Aᵢₙ(1) to the region Aᵢₙ(3025) and the filter values included in the kernel K_{C1}⁽⁹⁶⁾ proceed to the end, so that the arithmetic circuit D20_1 outputs p_{C1}⁽⁹⁶⁾(1), which is the result of the product-sum operation of the region Aᵢₙ(1) and the kernel K_{C1}⁽⁹⁶⁾, to the wiring CNL_1. The arithmetic circuit D20_2 outputs p_{C1}⁽⁹⁶⁾(2), which is the result of the product-sum operation of the region Aᵢₙ(2) and the kernel K_{C1}⁽⁹⁶⁾, to the wiring CNL_2. The arithmetic circuit D20_3 outputs p_{C1}⁽⁹⁶⁾(3), which is the result of the product-sum operation of the region Aᵢₙ(3) and the kernel K_{C1}⁽⁹⁶⁾, to the wiring CNL_3.

Furthermore, p_{C1}⁽⁹⁶⁾(1) to p_{C1}⁽⁹⁶⁾(3025) output to the wiring CNL_1 to the wiring CNL_3025 are written to the memory circuit portion ME11.

As shown in the timing chart in FIG. 13, data included in the regions corresponding to a plurality of the first terminals of the arithmetic circuits D20 is sequentially transmitted to the plurality of first terminals, and filter values included in a kernel are sequentially transmitted to the second terminals of the arithmetic circuits D20, whereby the arithmetic circuits D20 can perform convolution processing for the plurality of regions (the region Aᵢₙ(1) to the region Aᵢₙ(3025) in the above description) concurrently with one kernel. By sequentially switching kernels and repeating similar arithmetic operations, P_{C1} can be obtained as output data from the convolution layer CNV1.

### [Pooling Layer PL1]

In the pooling layer PL1, pooling processing is performed on P_{C1}, which is the output data from the convolution layer CNV1. In pooling processing, predetermined regions of data output from a convolution layer or the like are sequentially selected, predetermined processing is performed in each region to extract feature values, and the feature values are arranged in a matrix.

As illustrated in FIG. 10, in the pooling layer PL1, pooling processing is performed on the regions selected from the data P_{C1}, with the kernel size set to 3. Note that the stride is set to 2, and the pooling processing is max pooling.

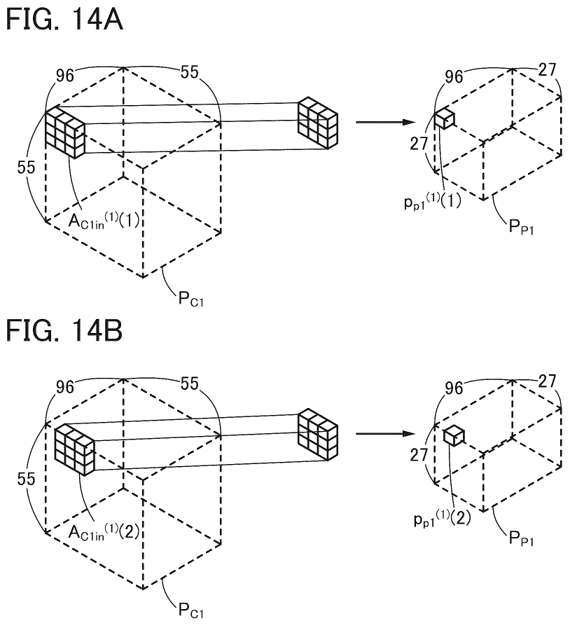

For example, FIG. 14A illustrates an example in which max pooling processing is performed in a region A_{C1in}⁽¹⁾(1) selected from the first input channel of the data P_{C1} and data pₚ₁⁽¹⁾(1) as the processing result is output. Since the kernel size is 3, the region A_{C1in}⁽¹⁾(1) includes 3×3 pieces of data.

Note that s of a region A_{C1in}^{(s)}(A) represents the ordinal number of the input channel of the data P_{C1}, A of the region A_{C1in}^{(s)}(A) represents the ordinal number of the region selected from the data P_{C1}, s of data pₚ₁^{(s)}(A) represents the ordinal number of the output channel, and A of the data pₚ₁^{(s)}(A) corresponds to the ordinal number A of the region A_{C1in}^{(s)}(A).

Since the stride is 2, a region shifted from the region A_{C1in}⁽¹⁾(1) by 2 in the row direction is a region A_{C1in}⁽¹⁾(2). For example, FIG. 14B illustrates an example in which max pooling processing is performed in the region A_{Clin}⁽¹⁾(2) selected from the data P_{C1} and data pₚ₁⁽¹⁾(2) as the processing result is output.

Note that in the case where the number of pieces of the data P_{C1} is 55×55×96 and the stride is 2, the number of regions selected from the data P_{C1} is 729 (=27²).

As described above, by sequentially performing pooling processing on the regions selected from the data P_{C1} in accordance with the stride, the output data in a matrix of 27 rows and 27 columns can be obtained. Although the first input channel of the data P_{C1} is described above, pooling processing is similarly performed for the 2nd to 96th input channels, so that P_{P1}, which is 27×27×96 pieces of output data, is output from the pooling layer PL1.

In an operation in the semiconductor device CDV illustrated in FIG. 1, for example, P_{C1}, which is the output data from the convolution layer CNV1, is read from the memory circuit portion ME11 and pooling processing is performed in the processing circuit D30. When the pooling processing is completed, the processing circuit D30 outputs the data P_{P1} as the result of the pooling processing. The data P_{P1} output from the processing circuit D30 is written to the memory circuit portion ME11.

### [Convolution Layer CNV2]

In the convolution layer CNV2, convolution processing is performed on the data P_{P1} output from the pooling layer PL1. Specifically, a product-sum operation of a kernel used for the convolution processing CNV2 and data included in a region selected from Pₚ₁ is performed.

As illustrated in FIG. 10, in the convolution layer CNV2, convolution processing is performed on the region selected from P_{P1}, with the kernel size set to 5 and the number of kernels set to 256. Note that the stride is 1.

As in the description of the convolution layer CNV1, the convolution layer CNV2 performs the convolution processing to output P_{C2}, which is 27×27×256 pieces of output data.

In an operation in the semiconductor device CDV illustrated in FIG. 1, for example, P_{P1}, which is the output data from the pooling layer PL1, is read from the memory circuit portion ME11 and transmitted to the wirings ILB. Then, the switching circuit D10 performs switching such that the signals input to the wirings ILB are transmitted to the wiring MLA_1 to the wiring MLA_p, and P_{P1} is input to a plurality of the input terminals of the arithmetic circuits D20.

As in the convolution layer CNV1, 256 kernels of the convolution layer CNV2 are sequentially read from the memory circuit portion ME12, and convolution processing of P_{P1} is performed in the arithmetic circuits D20. Accordingly, the data P_{C2} output from the arithmetic circuits D20 is written to the memory circuit portion ME11.

### [Pooling Layer PL2]

In the pooling layer PL2, pooling processing is performed on P_{C2}, which is the output data from the convolution layer CNV2.

As illustrated in FIG. 10, in the pooling layer PL2, pooling processing is performed on the regions selected from the data P_{C2}, with the kernel size set to 3. Note that the stride is set to 2, and the pooling processing is max pooling.

As in the description of the pooling layer PL1, the pooling layer PL2 performs the pooling processing to output P_{P2}, which is 13×13×256 pieces of output data.

For the operation of the semiconductor device CDV illustrated in FIG. 1 in the pooling layer PL2, the description of the operation of the semiconductor device CDV in the pooling layer PL1 can be referred to.

### [Convolution Layer CNV3]

In the convolution layer CNV3, convolution processing is performed on the data P_{P2} output from the pooling layer PL2. Specifically, a product-sum operation of a kernel used for the convolution processing CNV3 and data included in a region selected from P_{P2} is performed.

As illustrated in FIG. 10, in the convolution layer CNV3, convolution processing is performed on the region selected from P_{P2}, with the kernel size set to 3 and the number of kernels set to 384. Note that the stride is 1.

As in the description of the convolution layer CNV1, the convolution layer CNV3 performs the convolution processing to output P_{C3}, which is 13×13×384 pieces of output data.

For the operation of the semiconductor device CDV illustrated in FIG. 1 in the convolution layer CNV3, the description of the operation of the semiconductor device CDV in the convolution layer CNV2 can be referred to.

### [Convolution Layer CNV4]

In the convolution layer CNV4, convolution processing is performed on the data P_{C3} output from the convolution layer CNV3. Specifically, a product-sum operation of a kernel used for the convolution processing CNV4 and data included in a region selected from P_{C3} is performed.

As illustrated in FIG. 10, in the convolution layer CNV4, convolution processing is performed on the region selected from P_{C3}, with the kernel size set to 3 and the number of kernels set to 384. Note that the stride is 1.

As in the description of the convolution layer CNV1, the convolution layer CNV4 performs the convolution processing to output P_{C4}, which is 13×13×384 pieces of output data.

For the operation of the semiconductor device CDV illustrated in FIG. 1 in the convolution layer CNV4, the description of the operation of the semiconductor device CDV in the convolution layer CNV2 can be referred to.

### [Convolution Layer CNV5]

In the convolution layer CNV5, convolution processing is performed on the data P_{C4} output from the convolution layer CNV4. Specifically, a product-sum operation of a kernel used for the convolution processing CNV5 and data included in a region selected from P_{C4} is performed.

As illustrated in FIG. 10, in the convolution layer CNV5, convolution processing is performed on the region selected from P_{C4}, with the kernel size set to 3 and the number of kernels set to 256. Note that the stride is 1.

As in the description of the convolution layer CNV1, the convolution layer CNV5 performs the convolution processing to output P_{C5}, which is 13×13×256 pieces of output data.

For the operation of the semiconductor device CDV illustrated in FIG. 1 in the convolution layer CNV5, the description of the operation of the semiconductor device CDV in the convolution layer CNV2 can be referred to.

### [Pooling Layer PL5]

In the pooling layer PL5, pooling processing is performed on P_{C5}, which is the output data from the convolution layer CNV5.

As illustrated in FIG. 10, in the pooling layer PL5, pooling processing is performed on the regions selected from the data P_{C5}, with the kernel size set to 3. Note that the stride is set to 2, and the pooling processing is max pooling.

As in the description of the pooling layer PL1, the pooling layer PL5 performs the pooling processing to output P_{P5}, which is 6×6×256 pieces of output data.

For the operation of the semiconductor device CDV illustrated in FIG. 1 in the pooling layer PL5, the description of the operation of the semiconductor device CDV in the pooling layer PL1 can be referred to.

### [Fully Connected Layer FC6]

In the fully connected layer FC6, an arithmetic operation of a fully connected neural network is performed on P_{P5}, which is the output data from the pooling layer PL5.

In the fully connected layer FC6, the number of input channels is 9126 (=6×6×256) and the number of output channels is 4096 as shown in FIG. 10. In the fully connected layer, for one output channel, a product-sum operation of data of all input channels and corresponding weight coefficients (first data) is performed and the value of an activation function is calculated using the result as an input value. Thus, in the fully connected layer FC6, the number of necessary weight coefficients (first data) is 4096×9126.

When data to be the N-th output channel (here, N is an integer greater than or equal to 1 and less than or equal to 4096) of the fully connected layer FC6 is z_{FC6}(N), z_{FC6}(N) can be given by Formula (1.1) below.

$$\begin{matrix}[ Formula 1 ] & \\ {z}_{FC 6} ( N ) = f ( {u}_{FC 6} ( N ) ) & ( 1.1 )\end{matrix}$$

Note that f is the activation function in the fully connected layer FC6. Examples of the activation function include a sigmoid function, a tanh function, a softmax function, a ReLU function, and a threshold function. In addition, u_{FC6}(N) is as shown in Formula (1.2) below.

$$\begin{matrix}[ Formula 2 ] & \\ {u}_{FC 6} ( N ) = {\sum }_{s = 1}^{256} {\sum }_{A = 1}^{{6}^{2}} {p}_{P 5}^{( s )} ( A ) \cdot {w}_{FC 6 ( N )}^{( s )} ( A ) & ( 1.2 )\end{matrix}$$

Note that pₚ₅^{(s)}(A) is the A-th data of the s-th output channel output from the pooling layer PL5. Furthermore, w_{FC6(N)}^{(s)}(A) is a weight coefficient (first data) corresponding to the N-th channel of the fully connected layer FC6 and pₚ₅^{(s)}(A).

By using Formula (1.1) and Formula (1.2) above, z_{FC6}(1) to z_{FC6}(4096) that are data of the 1st to 4096th output channels of the fully connected layer FC6 can be obtained.

Next, an operation of the semiconductor device CDV illustrated in FIG. 1 in the fully connected layer FC6 will be described.

First, the first data (weight coefficients), which is digital data, is read from the memory circuit portion ME13 and input to the wiring IWL_1 to the wiring IWL_n (here, n is preferably an integer greater than or equal to 4096, for example).

Here, on the assumption that the circuit WCS included in the semiconductor device CDV in FIG. 1 is the circuit WCS illustrated in FIG. 7A, the circuit WCSa_1 to the circuit WCSa_n generate currents in the amounts corresponding to the values of digital data transmitted to the wiring IWL_1 to the wiring IWL_n. When the switch SA_1 to the switch SA_n of the circuit SWCA are in an on state, the currents generated by the circuit WCSa_1 to the circuit WCSa_n flow to the wiring WCL_1 to the wiring WCL_n.

When the circuit WSD in FIG. 6 selects the i-th row in the cell array CA, for example, the currents from the wiring WCL_1 to the wiring WCL_n flow to the arithmetic cell IM[i,1] to the arithmetic cell IM[i,n] arranged in the i-th row. Here, retaining the potentials of the gates of the transistors F2 in the arithmetic cell IM[i,1] to the arithmetic cell IM[i,n] enables setting the amounts of currents flowing between the sources and the drains of the transistors F2. Note that the current amounts are set in the arithmetic cells IM of the cell array CA from the 1st row to the 9126th row. Thus, m, which is the number of rows of the cell array CA, is preferably greater than or equal to 9126 here.

In the above, while the currents from the wiring WCL_1 to the wiring WCL_n flow to the arithmetic cell IM[i,1] to the arithmetic cell IM[i,n] arranged in the i-th row of the cell array CA, the circuit XCS makes a reference current Irem flow to the wiring XCL_i, so that the gate potential of the transistor F2d of the driving cell IMD_i is retained. Thus, the amount of a current flowing between the source and the drain of the transistor F2d in the driving cell IMD_i can be set to Irem. Note that setting of the amount of a current in the driving cell IMD in the cell array CA accompanies setting of the amount of a current in the arithmetic cell IM. That is, when the amounts of currents are set in the arithmetic cells IM in the cell array CA from the 1st row to the 9126th row, the setting is also performed in the driving cells IMD in the 1st row to the 9126th row at the same time.

Note that the amount of a reference current I_{ref0} is, for example, the amount of a current that flows through the wiring XCL when the second data transmitted to the arithmetic cell IM is “1”.

Through the above operation, the amount I₀[i,j] of a current flowing through the transistor F2 in the arithmetic cell IM[i,j] is as given by Formula (1.3) below.

$$\begin{matrix}[ Formula 3 ] & \\ {I}_{0} [ i , j ] = w [ i , j ] {I}_{ref 0} & ( 1.3 )\end{matrix}$$

Note that w[i,j] is a weight coefficient that corresponds to w_{FC6(N)}^{(s)}(A) in Formula (1.2) above and that is written to the arithmetic cell IM[i,j]. Furthermore, w[i,j] is defined as in Formula (1.4) below. Furthermore, I_{ref0} is as given by Formula (1.5) below.

$$\begin{matrix}[ Formula 4 ] & \\ w [ i , j ] = exp \{ J ( {V}_{g} [ i , j ] - {V}_{t h} [ i , j ] - {V}_{g m} [ i ] + {V}_{t h m} [ i ] ) \} & ( 1.4 )\end{matrix}$$

$${I}_{ref 0} = {I}_{a} exp \{ J ( {V}_{g m} [ i ] - {V}_{t h m} [ i ] ) \} \qquad ( 1.5 )$$

Note that V_{g}[i,j] is the gate-source voltage of the transistor F2 in the arithmetic cell IM[i,j], and Vth[i,j] is the threshold voltage of the transistor F2 in the arithmetic cell IM[i,j]. Furthermore, V_{g}m[i] is the gate-source voltage of the transistor F2d in the driving cell IMD_i, and Vₜₕₘ[i] is the threshold voltage of the transistor F2 in the driving cell IMD_i. Furthermore, Iₐ is a current amount of I_{ref0} of the case where V_{gm}[i] is Vₜₕₘ[i], and J is a correction coefficient determined with the temperature, the device structure, and the like.

Next, the second data (P_{P5}), which is digital data, is read from the memory circuit portion ME11 and input to the wiring IXL_1 to the wiring IXL_m (m is preferably an integer greater than or equal to 9126, for example, as described above).

Here, on the assumption that the circuit XCS included in the semiconductor device CDV in FIG. 1 is the circuit XCS illustrated in FIG. 7C, the circuit XCSa_1 to the circuit XCSa_m generate currents in the amounts corresponding to the values of digital data transmitted to the wiring IXL_1 to the wiring IXL_m. Accordingly, the currents generated by the circuit XCSa_1 to the circuit XCSa_m flow to the wiring XCL_1 to the wiring XCL_m.

The potential of each of the wiring XCL_1 to the wiring XCL_m depends on the amount of a current flowing through the wiring. When the potentials of the wiring XCL_1 to the wiring XCL_m change, the potentials of the gates (nodes N) of the transistors F2 in the arithmetic cell IM[1,1] to the arithmetic cell IM[m,n] change. At this time, the amount of a current I₁[i,j] flowing through the transistor F2 in the arithmetic cell IM[i,j] is as given by Formula (1.6) below.

$$\begin{matrix}[ Formula 5 ] & \\ {I}_{1} [ i , j ] = x [ i ] w [ i , j ] {I}_{ref 0} & ( 1.6 )\end{matrix}$$

Note that x[i] is input data that corresponds to pₚ₅^{(s)}(A) in Formula (1.2) above and that is transmitted from the circuit XCSa_i to the wiring XCL_i. Furthermore, x[i] is as given by Formula (1.7) below.

$$\begin{matrix}[ Formula 6 ] & \\ x [ i ] = exp ( Jp Δ V [ i ] ) & ( 1.7 )\end{matrix}$$

ΔV[i] represents the amount of change in the potential of the wiring XCL_i at the time when the amount of a current flowing through the wiring XCL_i changes from Irem to the current amount corresponding to pₚ₅^{(s)}(A). Furthermore, p is a coupling capacitance coefficient between the first terminal and the second terminal of the capacitor C1 in the arithmetic cell IM[i,j].

Here, it is assumed that the circuit ITS included in the semiconductor device CDV in FIG. 1 is the circuit ITS illustrated in FIG. 9A. At this time, the switch SA_1 to the switch SA_n of the circuit SWCA included in the circuit WCS are turned off and the switch SB_1 to the switch SB_n of the circuit SWCB included in the circuit ITS are turned on. Accordingly, the sum of the amounts of currents flowing through the arithmetic cell IM[1,j] to the arithmetic cell IM[m,j] in the j-th column of the cell array CA is input to the circuit ITSa_j. Here, the amount I_{SUM}[j] of the current input to the circuit ITSa_j is as follows.

$$\begin{matrix}[ Formula 7 ] & \\ {I}_{S U M} [ j ] = {I}_{ref 0} {\sum }_{i = 1}^{9216} x [ i ] w [ i , j ] & ( 1.8 )\end{matrix}$$

That is, the amount I_{SUM}[j] of the current flowing to the circuit ITSa_j depends on the result of the product-sum operation of the first data and the second data.

In the circuit ITSa_j, I_{SUM}[j], which is the result of the above product-sum operation, is input to the terminal RTi_j of the converter circuit RL_j. Thus, the converter circuit RL_j performs an arithmetic operation of a function system using I_{SUM}[j] as an input value. The converter circuit RL_j outputs the result of the arithmetic operation of the function system to the terminal RTo_j as an analog potential, and the analog potential is input to the analog-digital converter circuit ADC. The analog-digital converter circuit ADC converts the analog potential into digital data. The digital data is input to the memory circuit portion ME11 through the wiring OL_j. That is, z_{FC6}(1) to z_{FC6}(4096), which are the data of the 1st to 4096th output channels of the fully connected layer FC6 converted into the digital data, are written to the memory circuit portion ME11.

### [Fully Connected Layer FC7]

In the fully connected layer FC7, an arithmetic operation of a fully connected neural network is performed on z_{FC6}(1) to z_{FC6}(4096), which are the data of the output channels from the fully connected layer FC6.

In the fully connected layer FC7, the number of input channels is 4096 and the number of output channels is 4096 as shown in FIG. 10. As in the fully connected layer FC6, in the fully connected layer FC7, for one output channel, a product-sum operation of data of all the input channels and corresponding weight coefficients (first data) is performed and the value of an activation function is calculated using the result as an input value. Thus, in the fully connected layer FC7, the number of necessary weight coefficients (first data) is 4096×4096.

For the product-sum operation and the arithmetic operation of the activation function in the fully connected layer FC7, the description of the fully connected layer FC6 can be referred to.

When z_{FC6}(1) to z_{FC6}(4096), which are the data of the output channels from the fully connected layer FC6, are input to the fully connected layer FC7, the fully connected layer FC7 outputs z_{FC7}(1) to z_{FC7}(4096), which are the data of the 1st to 4096th output channels of the fully connected layer FC7.

For the operation of the semiconductor device CDV illustrated in FIG. 1 in the fully connected layer FC7, the description of the operation of the semiconductor device CDV in the fully connected layer FC6 can be referred to.

### [Fully Connected Layer FC8]

In the fully connected layer FC8, an arithmetic operation of a fully connected neural network is performed on z_{FC7}(1) to z_{FC7}(4096), which are the data of the output channels from the fully connected layer FC7.

In the fully connected layer FC8, the number of input channels is 4096 and the number of output channels is 1000 as shown in FIG. 10. As in the fully connected layer FC6, in the fully connected layer FC8, for one output channel, a product-sum operation of data of all input channels and corresponding weight coefficients (first data) is performed and the value of an activation function is calculated using the result as an input value. Thus, in the fully connected layer FC8, the number of necessary weight coefficients (first data) is 1000×4096.

For the product-sum operation and the arithmetic operation of the activation function in the fully connected layer FC8, the description of the fully connected layer FC6 can be referred to.

When z_{FC7}(1) to z_{FC7}(4096), which are the data of the output channels from the fully connected layer FC7, are input to the fully connected layer FC8, the fully connected layer FC8 outputs z_{FC8}(1) to z_{FC8}(1000), which are the data of the 1st to 1000th output channels of the fully connected layer FC8.

For the operation of the semiconductor device CDV illustrated in FIG. 1 in the fully connected layer FC8, the description of the operation of the semiconductor device CDV in the fully connected layer FC6 can be referred to.

As described above, the arithmetic operation of the AlexNet illustrated in FIG. 10 can be performed using the semiconductor device CDV. Since the convolution processing is performed through a digital arithmetic operation using the arithmetic portion DGP of the semiconductor device CDV, the frequency of updating the filter value can be lower than that in a conventional structure; hence, power needed for updating the filter value can be reduced.

When the processing in the fully connected layers is performed through an analog arithmetic operation using the arithmetic portion ANP of the semiconductor device CDV, a large-scale arithmetic operation, such as product-sum operations in the fully connected layer FC6 to the fully connected layer FC8, can be performed, for example. Specifically, since subthreshold currents flow through the transistors F2 in the arithmetic cell IM[1,1] to the arithmetic cell IM[m,n] included in the cell array CA, the power consumption per arithmetic cell IM can be low. Thus, the number of arithmetic cells IM included in the cell array CA can be increased, so that the product-sum operations of the fully connected layers can be performed with one cell array CA.

Note that although the operation in which the semiconductor device CDV performs the arithmetic operation of the AlexNet illustrated in FIG. 10 is described in this operation example, the model of the arithmetic operation performed by the semiconductor device CDV is not limited to an AlexNet. For example, although the image Pᵢₙ of 224×224 pixels is input to the semiconductor device CDV in the input layer INLY, the image size may be freely set. The number of kernels used for the convolution layer CNV1 to the convolution layer CNV5 and the filter values included in the kernels may also be freely set. A convolutional neural network using an arithmetic model other than the AlexNet in FIG. 10 may be operated by the semiconductor device CDV.

One embodiment of the present invention is not limited to the semiconductor device CDV described in this embodiment. Depending on the situation, one embodiment of the present invention may have a modified structure of the semiconductor device CDV described in this embodiment.

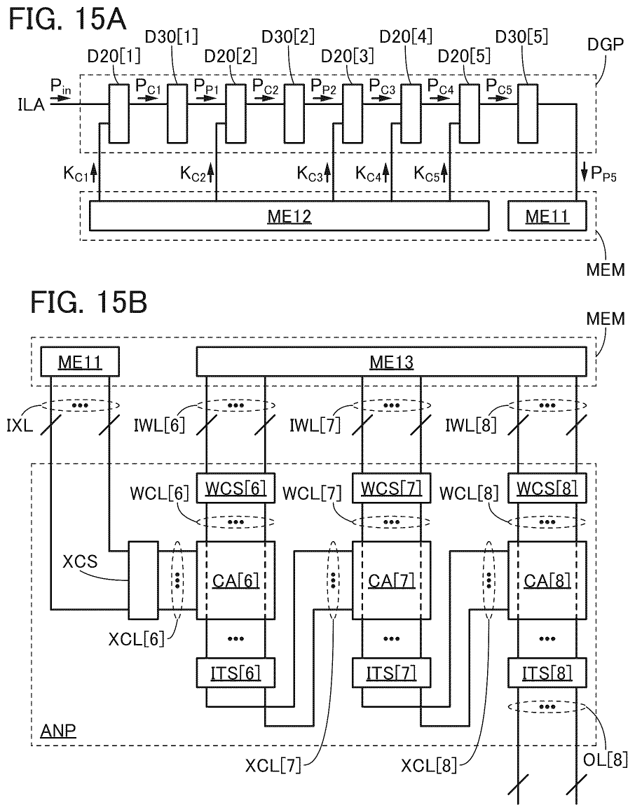

For example, the structure of the arithmetic portion DGP of the semiconductor device CDV illustrated in FIG. 1 may be changed to the structure illustrated in FIG. 15A. The arithmetic portion DGP illustrated in FIG. 15A is different from the arithmetic portion DGP in FIG. 1 in that the switching circuit D10 is not provided and a plurality of the arithmetic circuits D20 and a plurality of the processing circuits D30 are provided. Specifically, the arithmetic portion DGP illustrated in FIG. 15A includes an arithmetic circuit D20[1] to an arithmetic circuit D20[5], a processing circuit D30[1], a processing circuit D30[2], and a processing circuit D30[5].

For the arithmetic circuit D20[1] to the arithmetic circuit D20[5], the above description of the arithmetic circuit D20 can be referred to. For the processing circuit D30[1], the processing circuit D30[2], and the processing circuit D30[5], the above description of the processing circuit D30 can be referred to.

The arithmetic portion DGP illustrated in FIG. 15A includes circuits corresponding to the input layer INLY, the convolution layer CNV1 to the convolution layer CNV5, the pooling layer PL1, the pooling layer PL2, and the pooling layer PL5 of the convolutional neural network illustrated in FIG. 10. For example, the input layer INLY illustrated in FIG. 10 corresponds to the wiring ILA. For another example, the convolution layer CNV1 to the convolution layer CNV5 illustrated in FIG. 10 correspond to the arithmetic circuit D20[1] to the arithmetic circuit D20[5]. For another example, the pooling layer PL1, the pooling layer PL2, and the pooling layer PL5 illustrated in FIG. 10 correspond to the processing circuit D30[1], the processing circuit D30[2], and the processing circuit D30[5]. That is, in the arithmetic portion DGP in FIG. 15A, the arithmetic circuit D20[1], the processing circuit D30[1], the arithmetic circuit D20[2], the processing circuit D30[2], the arithmetic circuit D20[3], the arithmetic circuit D20[4], the arithmetic circuit D20[5], and the processing circuit D30[5] are provided in this order between the wiring ILA and the memory circuit portion ME11.

In the case where the arithmetic portion DGP of the semiconductor device CDV illustrated in FIG. 1 executes arithmetic operations of the convolution layer CNV1 to the pooling layer PL5 of the convolutional neural network in FIG. 10, the arithmetic operations are performed through repetitive operations of one arithmetic circuit D20 and one processing circuit D30. Meanwhile, in the case where the arithmetic portion DGP illustrated in FIG. 15A executes arithmetic operations of the convolution layer CNV1 to the pooling layer PL5 of the convolutional neural network in FIG. 10, the arithmetic operations are performed through sequential operations of the arithmetic circuit D20 (the convolution layer CNV1) to the processing circuit D30 (the pooling layer PL5).

In order to temporarily store output data of each layer after the arithmetic operation in each layer, the arithmetic portion DGP and the storage portion MEM may store the output data in the memory circuit portion of the storage portion MEM, although this structure is not illustrated in FIG. 15A.

For example, the structure of the arithmetic portion ANP of the semiconductor device CDV illustrated in FIG. 1 may be changed to the structure illustrated in FIG. 15B. The arithmetic portion ANP illustrated in FIG. 15B is different from the arithmetic portion ANP in FIG. 1 in that a plurality of the cell arrays CA, a plurality of the circuits WCS, and a plurality of the circuits ITS are provided. Specifically, the arithmetic portion ANP illustrated in FIG. 15B includes a cell array CA[6] to a cell array CA[8], a circuit WCS[6] to a circuit WCS[8], the circuit XCS, and a circuit ITS[6] to a circuit ITS[8].

For the cell array CA[6] to the cell array CA[8] in FIG. 15B, the description of the cell array CA illustrated in FIG. 1 can be referred to. For the circuit WCS[6] to the circuit WCS[8] in FIG. 15B, the description of the circuit WCS illustrated in FIG. 1 can be referred to. For the circuit XCS in FIG. 15B, the description of the circuit XCS illustrated in FIG. 1 can be referred to.

As each of the circuit ITS[6] and the circuit ITS[7], the circuit ITS illustrated in FIG. 9C can be used. As the circuit ITS[8], the circuit ITS illustrated in FIG. 9A or FIG. 9B can be used.

The memory circuit portion ME13 is electrically connected to the circuit WCS[6] through a wiring IWL[6]. The memory circuit portion ME13 is electrically connected to the circuit WCS[7] through a wiring IWL[7]. The memory circuit portion ME13 is electrically connected to the circuit WCS[8] through a wiring IWL[8].

Note that the wiring IWL[6] to the wiring IWL[8] can each be a wiring group including a plurality of wirings. The wiring IWL[6] to the wiring IWL[8] each correspond to the wiring IWL_1 to the wiring IWL_n illustrated in FIG. 1.

The memory circuit portion ME11 is electrically connected to the circuit XCS through the wiring IXL. Note that the wiring IXL here can be a wiring group including a plurality of wirings. The wiring IXL corresponds to the wiring IWL_1 to the wiring IWL_n illustrated in FIG. 1.

The circuit WCS[6] is electrically connected to the circuit ITS[6] through a wiring WCL[6]. The circuit WCS[7] is electrically connected to the circuit ITS[7] through a wiring WCL[7]. The circuit WCS[8] is electrically connected to the circuit ITS[8] through a wiring WCL[8].

Note that the wiring WCL[6] to the wiring WCL[8] can each be a wiring group including a plurality of wirings. The wiring WCL[6] to the wiring WCL[8] each correspond to the wiring WCL_1 to the wiring WCL_n illustrated in FIG. 1. The wiring WCL[6] extends in the column direction of the cell array CA[6], the wiring WCL[7] extends in the column direction of the cell array CA[7], and the wiring WCL[8] extends in the column direction of the cell array CA[8].

The circuit XCS is electrically connected to a wiring XCL[6]. Note that the wiring XCL[6] can be a wiring group including a plurality of wirings. The wiring XCL[6] corresponds to the wiring XCL_1 to the wiring XCL_m illustrated in FIG. 1. The wiring XCL[6] extends in the row direction of the cell array CA[6].

The circuit ITS[6] is electrically connected to a wiring XCL[7]. Note that the wiring XCL[7] can be a wiring group including a plurality of wirings. The wiring XCL[7] corresponds to the wiring XCL_1 to the wiring XCL_m illustrated in FIG. 1. The wiring XCL[7] extends in the row direction of the cell array CA[7].

The circuit ITS[7] is electrically connected to a wiring XCL[8]. Note that the wiring XCL[8] can be a wiring group including a plurality of wirings. The wiring XCL[8] corresponds to the wiring XCL_1 to the wiring XCL_m illustrated in FIG. 1. The wiring XCL[8] extends in the row direction of the cell array CA[8].

The circuit ITS[8] is electrically connected to a wiring OL[8]. Note that the wiring OL[8] can be a wiring group including a plurality of wirings. The wiring OL[8] corresponds to the wiring OL_1 to the wiring OL_n illustrated in FIG. 1.

The arithmetic portion ANP illustrated in FIG. 15B includes circuits corresponding to the fully connected layer FC6 to the fully connected layer FC8 of the convolutional neural network illustrated in FIG. 10. For example, the fully connected layer FC6 illustrated in FIG. 10 corresponds to the cell array CA[6] and the circuit ITS[6]. For another example, the fully connected layer FC7 illustrated in FIG. 10 corresponds to the cell array CA[7] and the circuit ITS[7]. The fully connected layer FC8 illustrated in FIG. 10 corresponds to the cell array CA[8] and the circuit ITS[8].

In the case where the arithmetic portion ANP of the semiconductor device CDV illustrated in FIG. 1 executes arithmetic operations of the fully connected layer FC6 to the fully connected layer FC8 of the convolutional neural network in FIG. 10, the arithmetic operations are performed through repetitive operations of one cell array CA, one circuit WCS, one circuit XCS, and one circuit ITS. Meanwhile, in the case where the arithmetic portion ANP illustrated in FIG. 15B executes arithmetic operations of the fully connected layer FC6 to the fully connected layer FC8 of the convolutional neural network in FIG. 10, the arithmetic operations are performed through sequential operations of the cell arrays CA and the circuits ITS that correspond to the fully connected layers.

The arithmetic portion ANP illustrated in FIG. 15B is different from the arithmetic portion ANP of the semiconductor device CDV in FIG. 1 also in not performing analog-digital conversion in the circuit ITS[6] and the circuit ITS[7]. That is, the arithmetic portion ANP illustrated in FIG. 15B has a structure in which no analog-digital converter circuit is provided in the circuit ITS[6] and the circuit ITS[7]. When no analog-digital converter circuit is provided in the circuit ITS[6] and the circuit ITS[7], the circuit area and the power consumption of the semiconductor device CDV can be reduced.

In order to temporarily store output data of each fully connected layer after the arithmetic operation in each layer, the arithmetic portion ANP and the storage portion MEM may store the output data in the memory circuit portion of the storage portion MEM, although this structure is not illustrated in FIG. 15B.

Although the pooling processing in the description of this operation example is max pooling, for example, average pooling, Lp pooling, or the like may be employed depending on circumstances.

Note that this embodiment can be combined with any of the other embodiments in this specification as appropriate. For example, the configurations, structures, methods, and the like described in this embodiment can be used in an appropriate combination with any of the configurations, structures, methods, and the like described in the other embodiments and the like.

### Embodiment 2

In this embodiment, a structure example of the semiconductor device CDV described in the above embodiment will be described.

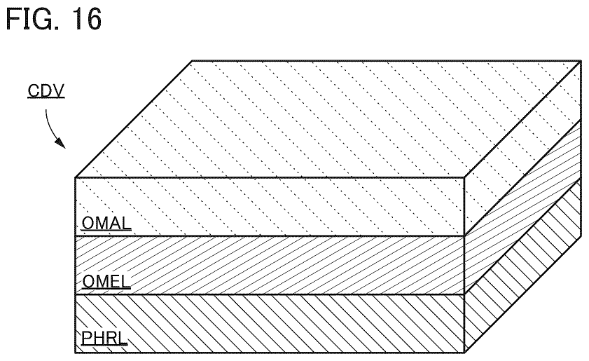

FIG. 16 is a schematic perspective view showing the semiconductor device CDV of one embodiment of the present invention. The semiconductor device CDV shown in FIG. 16 includes a circuit layer PHRL, a storage layer OMEL, and an arithmetic layer OMAL, for example. The circuit layer PHRL is positioned below the storage layer OMEL, and the arithmetic layer OMAL is positioned above the storage layer OMEL. That is, the circuit layer PHRL, the storage layer OMEL, and the arithmetic layer OMAL are stacked in this order from the bottom in the semiconductor device CDV shown in FIG. 16.

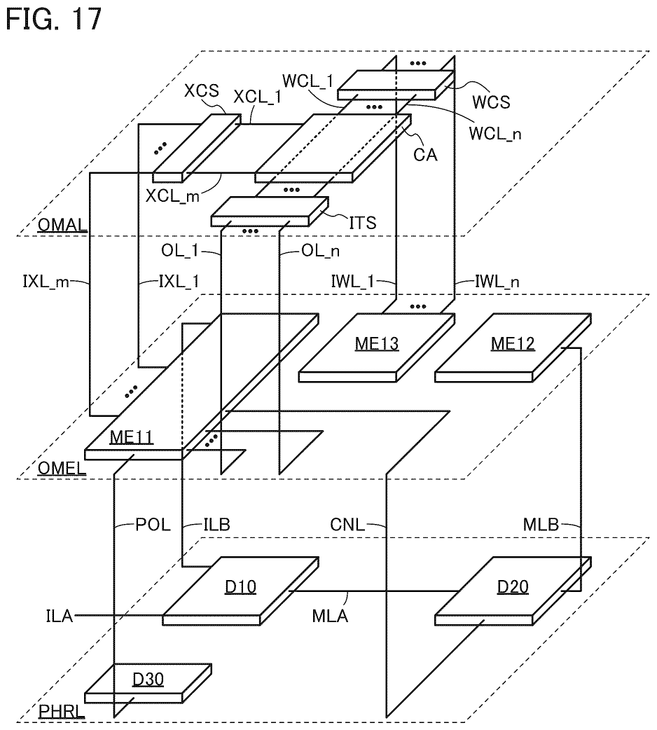

FIG. 17 is a block diagram showing structure examples of the circuit layer PHRL, the storage layer OMEL, and the arithmetic layer OMAL shown in FIG. 16.

In FIG. 17, the circuit layer PHRL includes, for example, the switching circuit D10, the arithmetic circuit D20, and the processing circuit D30 that are illustrated in FIG. 1. The storage layer OMEL includes, for example, the memory circuit portion ME11, the memory circuit portion ME12, and the memory circuit portion ME13 that are illustrated in FIG. 1. The arithmetic layer OMAL includes, for example, the cell array CA, the circuit WCS, the circuit XCS, and the circuit ITS.

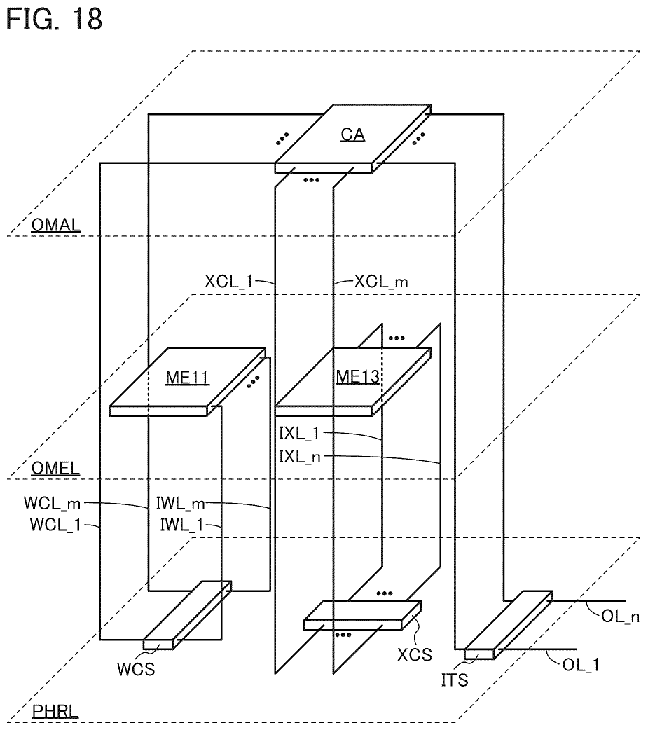

Note that the circuit WCS, the circuit XCS, and the circuit ITS illustrated in FIG. 1 may be included in the circuit layer PHRL as illustrated in FIG. 18. Note that FIG. 18 selectively illustrates the cell array CA, the circuit WCS, the circuit XCS, the circuit ITS, the memory circuit portion ME11, and the memory circuit portion ME13. Alternatively, one or more selected from the circuit WCS, the circuit XCS, and the circuit ITS illustrated in FIG. 1 may be included in the storage layer OMEL.

The circuit layer PHRL can be formed by providing a circuit element such as a transistor or a capacitor over a substrate, for example. As the substrate, a semiconductor substrate (e.g., a single crystal substrate including silicon or germanium as a material) can be used. Besides such a semiconductor substrate, for example, any of the following can be used: an SOI (Silicon On Insulator) substrate, a glass substrate, a quartz substrate, a plastic substrate, a sapphire glass substrate, a metal substrate, a stainless steel substrate, a substrate including stainless steel foil, a tungsten substrate, a substrate including tungsten foil, a flexible substrate, an attachment film, and paper and a base film each including a fibrous material. Examples of the glass substrate include a barium borosilicate glass substrate, an aluminoborosilicate glass substrate, and a soda lime glass substrate. Examples of materials for the flexible substrate, the attachment film, or the base film include plastics typified by polyethylene terephthalate (PET), polyethylene naphthalate (PEN), polyethersulfone (PES), and polytetrafluoroethylene (PTFE). Another example is a synthetic resin such as acrylic. Other examples are polypropylene, polyester, polyvinyl fluoride, and polyvinyl chloride. Other examples are polyamide, polyimide, aramid, an epoxy resin, an inorganic vapor-deposited film, and paper. Note that in the case where the manufacturing process of the semiconductor device CDV involves heat treatment, a highly heat-resistant material is preferably selected for the substrate.

Note that the substrate included in the circuit layer PHRL is described as a semiconductor substrate including silicon in this embodiment.

When the substrate included in the circuit layer PHRL is a semiconductor substrate including silicon as a material, for example, the transistors included in the switching circuit D10, the arithmetic circuit D20, and the processing circuit D30 can be formed on the semiconductor substrate. In that case, the transistors are Si transistors. The Si transistor has high field-effect mobility and thus can make a high on-state current flow. Accordingly, the driving speed of each of the above-described circuits can be increased, and the range of a signal can be expanded, for example. In the case where the semiconductor device CDV is the structure example illustrated in FIG. 18, the transistors included in the circuit WCS, the circuit XCS, and the circuit ITS can also be formed over the semiconductor substrate including silicon as a material, which enables increasing the driving speed of each of the circuit WCS, the circuit XCS, and the circuit ITS and expanding the range of a signal, for example.

The stacked-layer structure of the circuit layer PHRL and the storage layer OMEL can be fabricated by directly forming the storage layer OMEL on the circuit layer PHRL. Alternatively, the stacked-layer structure can be fabricated in the following manner: the storage layer OMEL is formed by providing a circuit element such as a transistor or a capacitor over a substrate, and the substrate is mounted over the circuit layer PHRL.

In the case where the storage layer OMEL is directly formed on the circuit layer PHRL, the storage layer OMEL preferably includes an OS transistor. The OS transistor can be formed not only over a semiconductor substrate but also over an insulator substrate, a conductor substrate, a conductive film, an insulating film, and a semiconductor film and thus can be easily provided over a semiconductor substrate where a Si transistor is formed (over the circuit layer PHRL).

In the case where the storage layer OMEL is formed by forming a circuit element such as a transistor or a capacitor over a substrate and the substrate is mounted over the circuit layer PHRL, a flip-chip bonding method or a wire bonding method can be used. Alternatively, the storage layer OMEL may be mounted over the circuit layer PHRL in the following manner: a first bonding layer is provided on the circuit layer PHRL side, a second bonding layer is provided on the substrate of the storage layer OMEL, and the first bonding layer and the second bonding layer are bonded to each other by one or both of a surface activated bonding method and a hydrophilic bonding method. Specifically, in what is called Cu—Cu junction, the first bonding layer and the second bonding layer each include copper (Cu) as a conductor, and copper (Cu) of the first bonding layer and that of the second bonding layer are bonded to each other.

### Cross-Sectional Structure Example 1

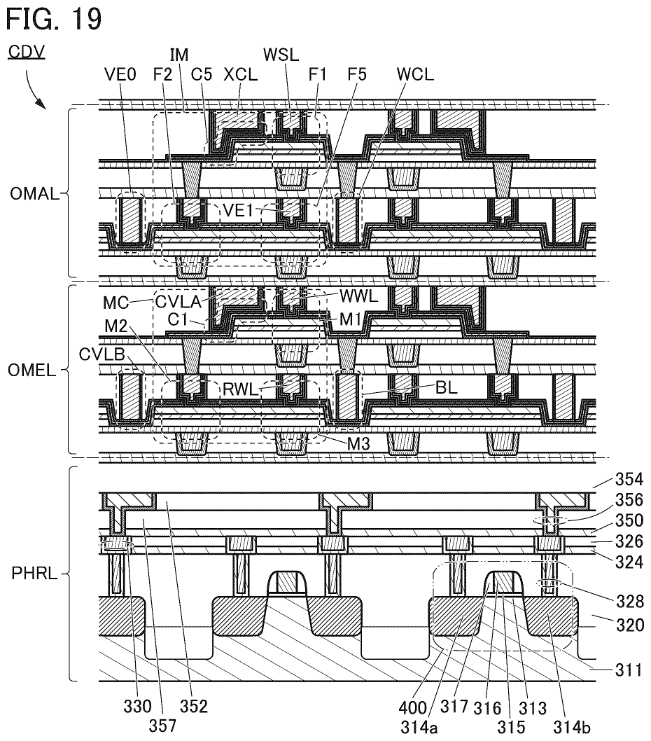

Next, a specific structure example of the semiconductor device CDV shown in FIG. 16 and FIG. 17 is described. FIG. 19 is a schematic cross-sectional view showing an example of the semiconductor device CDV shown in FIG. 16 and FIG. 17.

The schematic cross-sectional view in FIG. 19 shows the circuit layer PHRL, the storage layer OMEL, and the arithmetic layer OMAL. Note that the semiconductor device CDV shown in FIG. 19 has a structure in which the storage layer OMEL is directly formed on the circuit layer PHRL and the arithmetic layer OMAL is directly formed on the storage layer OMEL.

FIG. 19 shows a transistor 400 included in the circuit layer PHRL. The transistor 400 is provided on a substrate 311 and includes a conductor 316 functioning as a gate, an insulator 315 and an insulator 317 functioning as gate insulators, a semiconductor region 313 that includes part of the substrate 311, and a low-resistance region 314a and a low-resistance region 314b that include part of the substrate and function as a source region and a drain region. The transistor 400 may be a p-channel transistor or an n-channel transistor. As the substrate 311, a single crystal silicon substrate can be used, for example.

In the transistor 400 illustrated in FIG. 19, the semiconductor region 313 (part of the substrate 311) in which a channel is formed has a protruding shape. Furthermore, the conductor 316 is provided to cover the side and top surfaces of the semiconductor region 313 with the insulator 315 therebetween. Note that the conductor 316 may be formed using a material for adjusting the work function. Such a transistor 400 is also referred to as a FIN-type transistor because it utilizes a protruding portion of a semiconductor substrate. An insulator functioning as a mask for forming the protruding portion may be provided in contact with an upper portion of the protruding portion. Although the case where the protruding portion is formed by processing part of the semiconductor substrate is described here, a semiconductor film having a protruding shape may be formed by processing an SOI substrate.

Note that the transistor 400 shown in FIG. 19 is just an example and is not limited to the structure shown therein; an appropriate transistor may be used in accordance with a circuit structure or a driving method.

Wiring layers including an interlayer film, a wiring, and a plug may be provided between the structure bodies. A plurality of wiring layers can be provided in accordance with the design. Furthermore, in this specification and the like, a wiring and a plug electrically connected to the wiring may be a single component. That is, part of a conductor functions as a wiring in some cases and part of the conductor functions as a plug in other cases.

For example, an insulator 320, an insulator 324, and an insulator 326 are stacked over the transistor 400 in this order as interlayer films. A conductor 328 or the like is embedded in the insulator 320. A conductor 330 or the like is embedded in the insulator 324 and the insulator 326. Note that the conductor 328 and the conductor 330 function as contact plugs or wirings.

The insulator functioning as an interlayer film may function as a planarization film that covers an uneven shape thereunder. For example, the top surface of the insulator 320 may be planarized by planarization treatment using a chemical mechanical polishing (CMP) method to improve planarity.

A wiring layer may be provided over the insulator 326 and the conductor 330. For example, in FIG. 19, an insulator 350, an insulator 357, an insulator 352, and an insulator 354 are stacked in this order over the insulator 326 and the conductor 330. A conductor 356 is formed in the insulator 350, the insulator 357, and the insulator 352. The conductor 356 functions as a contact plug or a wiring.

The insulator 354 is provided over the insulator 352 and the conductor 356. In the insulator 354, a contact plug or a wiring for electrical connection to an upper circuit (e.g., a circuit included in the storage layer OMEL or a circuit included in the arithmetic layer OMAL) may be embedded.

FIG. 19 shows the storage cell MC included in the storage layer OMEL. Specifically, FIG. 19 shows the transistor M1, the transistor M2, the transistor M3, and the capacitor C1 included in the storage cell MC. Note that the storage cell MC can be the storage cell MC described in the above embodiment and illustrated in FIG. 4C.

In the storage layer OMEL of the semiconductor device CDV in FIG. 19, the transistor M1 and the capacitor C1 are positioned above the transistor M2 and the transistor M3.

In the storage layer OMEL in FIG. 19, the transistor M2 and the transistor M3 are provided to share one island-shaped semiconductor layer. Specifically, a gate insulating film and a gate electrode of the transistor M2 are formed in one of two regions of the one island-shaped semiconductor layer, and a gate insulating film and a gate electrode of the transistor M3 are formed in the other of the two regions of the one island-shaped semiconductor layer.

In the storage layer OMEL in FIG. 19, a transistor that includes a back gate is used as each of the transistor M2 and the transistor M3. Specifically, the back gate of the transistor M2 is positioned in a region overlapping with the gate insulating film and the gate electrode of the transistor M2 that are below the above-described one island-shaped semiconductor layer, and the back gate of the transistor M3 is positioned in a region overlapping with the gate insulating film and the gate electrode of the transistor M3 that are below the above-described one island-shaped semiconductor layer.

A conductor corresponding to the wiring CVLB is electrically connected to one of a source electrode and a drain electrode of the transistor M2. A conductor corresponding to the wiring BL is electrically connected to the one of the source electrode and the drain electrode of the transistor M2. The wiring CVLB and the wiring BL extend in the channel width direction of the transistor M2 or the transistor M3, for example.

A conductor as the gate electrode of the transistor M3 extends in the channel width direction. This conductor corresponds to the wiring RWL.

An insulator serving as an interlayer film is formed between the transistor M1 and each of the transistor M2 and the transistor M3. The insulator includes an opening portion in each of a region overlapping with the gate electrode of the transistor M2 and a region overlapping with the wiring BL, and conductors are embedded in the opening portions. One conductor is electrically connected to one of a source electrode and a drain electrode of the transistor M1, and the other conductor is electrically connected to the other of the source electrode and the drain electrode of the transistor M1.

As already described above, the transistor M1 is positioned above the transistor M2 and the transistor M3. A dielectric of the capacitor C1 is formed to cover an end portion of an island-shaped semiconductor layer of the transistor M1, and a conductor corresponding to the second terminal of the capacitor C1 is formed over the dielectric. The conductor corresponds to the wiring CVLA.

As described in Embodiment 1, the wiring CVLA and the wiring CVLB may supply the same potential. In the case where the wiring CVLA and the wiring CVLB supply the same potential, the wiring CVLA and the wiring CVLB may be electrically connected to each other (not shown).

In a region of the island-shaped semiconductor layer of the transistor M1, a gate insulating film and a gate electrode of the transistor M1 are formed. Specifically, a conductor as the gate electrode of the transistor M1 extends in the channel width direction. This conductor corresponds to the wiring WWL.

The transistor M1 is a transistor that includes a back gate like the transistor M2 and the transistor M3. Specifically, the back gate of the transistor M1 is positioned in a region overlapping with the gate insulating film and the gate electrode of the transistor M1 that are below the island-shaped semiconductor layer.

As described above, in each of the transistor M1, the transistor M2, and the transistor M3, the gate and the back gate are positioned to interpose a channel formation region of the semiconductor. The gate and the back gate are each formed using a conductor. The back gate can function in a manner similar to that of the gate. In addition, by changing the potential of the back gate, the threshold voltage of the transistor can be changed. The potential of the back gate may be the same as that of the gate or may be a ground potential or a freely selected potential.

Each of the gate and the back gate is formed using a conductor and thus has a function of preventing an electric field generated in the outside of the transistor from influencing the semiconductor in which the channel is formed (particularly, a function of blocking static electricity). That is, a variation in the electrical characteristics of the transistor due to the influence of an external electric field such as static electricity can be prevented. By providing the back gate, the amount of change in threshold voltage of the transistor before and after a bias-temperature stress test (which is sometimes referred to as BT test) can be reduced.

For example, when a transistor including a back gate is used as the transistor M1, the transistor M1 is less affected by an external electric field and can keep on being in an off state stably. As a result, data written to the first terminal of the capacitor C1 can be stably retained. Providing the back gate can make the operation of the storage cell MC stable and increase the reliability of the storage layer OMEL that includes the storage cell MC.

For each of the semiconductor layers in which the channels of the transistor M1, the transistor M2, and the transistor M3 are formed, one or a combination of two or more of a single crystal semiconductor, a polycrystalline semiconductor, a microcrystalline semiconductor, an amorphous semiconductor, and the like can be used. As a semiconductor material, for example, silicon or germanium can be used as described in Embodiment 1. For another example, a compound semiconductor such as silicon germanium, silicon carbide, gallium arsenide, an oxide semiconductor, or a nitride semiconductor may be used.

Each of the transistor M1, the transistor M2, and the transistor M3 is preferably a transistor using an oxide semiconductor, which is one type of metal oxide, in its semiconductor layer where a channel is formed (also referred to as an OS transistor). An oxide semiconductor has a band gap greater than or equal to 2 eV and thus enables an extremely low off-state current. Thus, power consumption of the storage cell MC can be reduced. Accordingly, power consumption of the semiconductor device CDV that includes the storage cell MC can be reduced.

A memory cell including an OS transistor can be referred to as an “OS memory”. The semiconductor device CDV that includes the memory cell can also be referred to as an “OS memory”.

In addition, the OS transistor operates stably even in a high-temperature environment and has small fluctuation in characteristics. For example, the off-state current hardly increases even in a high-temperature environment. Specifically, the off-state current hardly increases even at an environment temperature higher than or equal to room temperature and lower than or equal to 200° C. In addition, the on-state current is less likely to decrease even in a high-temperature environment. Thus, the OS memory can operate stably and have high reliability even in a high-temperature environment.

FIG. 19 shows the arithmetic cell IM included in the arithmetic layer OMAL. Specifically, FIG. 19 shows the transistor F1, the transistor F2, the transistor F5, and the capacitor C5 included in the arithmetic cell IM. Note that the arithmetic cell IM can be the arithmetic cell IM described in the above embodiment and illustrated in FIG. 6.

As shown in FIG. 19, the structure of the arithmetic cell IM included in the arithmetic layer OMAL can be the same as that of the storage cell MC included in the storage layer OMEL. Thus, the above description of the storage cell MC included in the storage layer OMEL is to be referred to for the structure of the arithmetic cell IM included in the arithmetic layer OMAL. The description of the cell IM included in the arithmetic layer OMAL is made when, in the description of the storage cell MC included in the storage layer OMEL, the transistor M1 is replaced with the transistor F1, the transistor M2 is replaced with the transistor F2, the transistor M3 is replaced with the transistor F5, the capacitor C1 is replaced with the capacitor C5, the wiring BL is replaced with the wiring WCL, the wiring CVLB is replaced with the wiring VE0, the wiring RWL is replaced with the wiring VE1, the wiring CVLA is replaced with the wiring XCL, and the wiring WWL is replaced with the wiring WSL.

### Cross-Sectional Structure Example 2

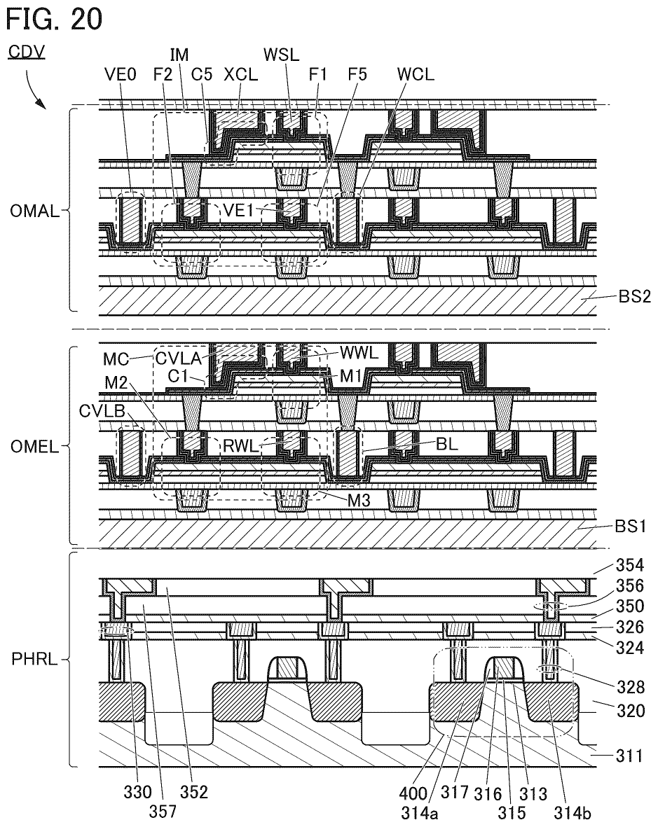

FIG. 20 is a schematic cross-sectional view, which differs from FIG. 19, showing an example of the semiconductor device CDV shown in FIG. 16 and FIG. 17.

The semiconductor device CDV in FIG. 20 differs from the semiconductor device CDV in FIG. 19 in that each of the storage layer OMEL and the arithmetic layer OMAL includes a substrate.

The storage layer OMEL of the semiconductor device CDV in FIG. 20 includes a substrate BS1. The transistor M1, the transistor M2, the transistor M3, and the capacitor C1 are formed over the substrate BS1. The structure of the storage cell MC formed over the substrate BS1 is the same as that of the storage cell MC of the semiconductor device CDV in FIG. 19; however, the structure of the storage cell MC in FIG. 20 may be changed depending on circumstances.

The arithmetic layer OMAL of the semiconductor device CDV in FIG. 20 includes a substrate BS2. The transistor F1, the transistor F2, the transistor F5, and the capacitor C5 are formed over the substrate BS2. The structure of the cell IM formed over the substrate BS2 is the same as that of the arithmetic cell of the semiconductor device CDV in FIG. 19; however, the structure of the cell IM in FIG. 20 may be changed depending on circumstances.

That is, in the semiconductor device CDV in FIG. 20, the substrate BS1 included in the storage layer OMEL and the substrate BS2 included in the arithmetic layer OMAL are mounted over the substrate 311 over which the switching circuit D10, the arithmetic circuit D20, and the processing circuit D30 are formed.

As each of the substrate BS1 and the substrate BS2, a substrate that can be applied to the substrate (e.g., the substrate 311) included in the circuit layer PURL can be used. For example, when a semiconductor substrate including silicon as a material is used as each of the substrate BS1 and the substrate BS2, the transistor F1, the transistor F2, the transistor F5, the transistor M1, the transistor M2, and the transistor M3 can be Si transistors.

As a method for mounting the substrate BS1 over the substrate 311 and a method for mounting the substrate BS2 over the substrate BS1, a flip-chip bonding method or a wire bonding method can be used as described above. A bonding layer may be provided between the substrates to be bonded, and one or both of a surface activated bonding method and a hydrophilic bonding method may be used.

The structure of a semiconductor device of one embodiment of the present invention is not limited to the structures shown in FIG. 16, FIG. 17, FIG. 19, and FIG. 20. Any of the structures shown in FIG. 16, FIG. 17, FIG. 19, and FIG. 20 may be modified as appropriate to be used for the semiconductor device of one embodiment of the present invention.

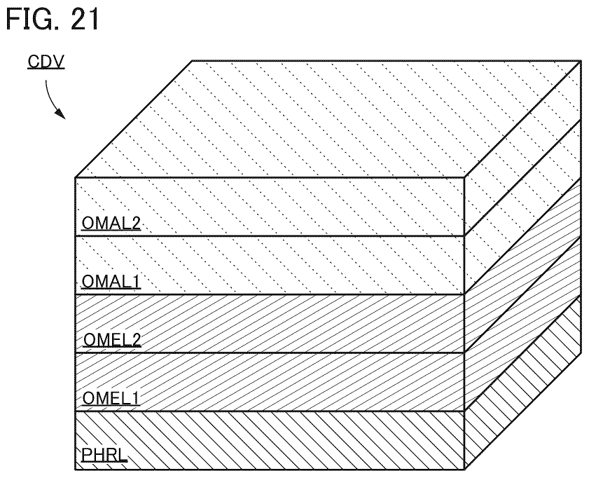

FIG. 21 shows a modification example of the semiconductor device CDV shown in FIG. 16. The semiconductor device CDV shown in FIG. 21 differs from the semiconductor device CDV in FIG. 16 in including a storage layer OMEL1 and a storage layer OMEL2 instead of the storage layer OMEL and including an arithmetic layer OMAL1 and an arithmetic layer OMAL2 instead of the arithmetic layer OMAL. In other words, the semiconductor device CDV in FIG. 21 includes the circuit layer PHRL, the storage layer OMEL1, the storage layer OMEL2, the arithmetic layer OMAL1, and the arithmetic layer OMAL2.

As described above, in the semiconductor device CDV, two or four of the storage layer(s) OMEL and the arithmetic layer(s) OMAL can be provided over the circuit layer PHRL. Note that the total number of the storage layers OMEL and the arithmetic layers OMAL provided over the circuit layer PHRL may be three or five or more.

Note that this embodiment can be combined with any of the other embodiments in this specification as appropriate. For example, the configurations, structures, methods, and the like described in this embodiment can be used in an appropriate combination with any of the configurations, structures, methods, and the like described in the other embodiments and the like.

### Embodiment 3

In this embodiment, a transistor whose channel formation region includes an oxide semiconductor (OS transistor) is described. In the description of the OS transistor, comparison with a transistor whose channel formation region includes silicon (also referred to as Si transistor) is also described briefly.

### [OS Transistor]

An oxide semiconductor having a low carrier concentration is preferably used for the OS transistor. For example, the carrier concentration in a channel formation region of an oxide semiconductor is lower than or equal to 1×10¹⁸ cm⁻³, preferably lower than 1×10¹⁷ cm⁻³, further preferably lower than 1×10¹⁶ cm⁻³, still further preferably lower than 1×10¹³ cm⁻³, yet still further preferably lower than 1×10¹⁰ cm⁻³, and higher than or equal to 1×10⁻⁹ cm⁻³. In order to reduce the carrier concentration of an oxide semiconductor film, the impurity concentration in the oxide semiconductor film is reduced so that the density of defect states can be reduced. In this specification and the like, a state with a low impurity concentration and a low density of defect states is referred to as a highly purified intrinsic or substantially highly purified intrinsic state. Note that an oxide semiconductor having a low carrier concentration may be referred to as a highly purified intrinsic or substantially highly purified intrinsic oxide semiconductor.

A highly purified intrinsic or substantially highly purified intrinsic oxide semiconductor has a low density of defect states and accordingly has a low density of trap states in some cases. Charge trapped by the trap states in the oxide semiconductor takes a long time to disappear and might behave like fixed charge. A transistor whose channel formation region is formed in an oxide semiconductor having a high density of trap states has unstable electrical characteristics in some cases.

Accordingly, in order to obtain stable electrical characteristics of the transistor, reducing the concentration of impurities in the oxide semiconductor is effective. In order to reduce the impurity concentration in the oxide semiconductor, the impurity concentration in a film that is adjacent to the oxide semiconductor is preferably reduced. As examples of the impurity, hydrogen, nitrogen, and the like are given. Note that an impurity in an oxide semiconductor refers to, for example, elements other than the main components of the oxide semiconductor. For example, an element with a concentration lower than 0.1 atomic % is regarded as an impurity.

When impurities and oxygen vacancies are in a channel formation region of an oxide semiconductor in an OS transistor, electrical characteristics of the OS transistor easily vary and the reliability thereof might worsen. In the OS transistor, a defect that is an oxygen vacancy in the oxide semiconductor into which hydrogen enters (hereinafter sometimes referred to as V_{O}H) may be formed and may generate an electron serving as a carrier. When V_{O}H is formed in the channel formation region, the donor concentration in the channel formation region increases in some cases. As the donor concentration in the channel formation region increases, the threshold voltage might vary. Accordingly, when the channel formation region in the oxide semiconductor includes oxygen vacancies, the transistor tends to have normally-on characteristics (a state where a channel exists and a current flows through the transistor even when no voltage is applied to the gate electrode). Therefore, the impurities, oxygen vacancies, and V_{O}H are preferably reduced as much as possible in the channel formation region in the oxide semiconductor.

The band gap of the oxide semiconductor is preferably larger than the band gap of silicon (typically 1.1 eV), further preferably larger than or equal to 2 eV, still further preferably larger than or equal to 2.5 eV, yet still further preferably larger than or equal to 3.0 eV. With use of an oxide semiconductor having a larger band gap than silicon, the off-state current (also referred to as Ioff) of the transistor can be reduced.

In a Si transistor, a short-channel effect (also referred to as SCE) appears as miniaturization of the transistor proceeds. Thus, it is difficult to miniaturize the Si transistor. One factor that causes the short-channel effect is a small band gap of silicon. By contrast, the OS transistor includes an oxide semiconductor that is a semiconductor material having a wide band gap, and thus can suppress the short-channel effect. In other words, a short-channel effect does not appear or hardly appears in an OS transistor.

The short-channel effect refers to degradation of electrical characteristics which becomes obvious along with miniaturization of a transistor (a decrease in channel length). Specific examples of the short-channel effect include a decrease in threshold voltage, an increase in subthreshold swing value (sometimes also referred to as S value), an increase in leakage current, and the like. Here, the S value means the amount of change in gate voltage in the subthreshold region when the drain voltage keeps constant and the drain current changes by one order of magnitude.

The characteristic length is widely used as an indicator of resistance to a short-channel effect. The characteristic length is an indicator of curving of potential in a channel formation region. When the characteristic length is shorter, the potential rises more sharply, which means that the resistance to a short-channel effect is high.

The OS transistor is an accumulation-type transistor and the Si transistor is an inversion-type transistor. Accordingly, an OS transistor has a shorter characteristic length between a source region and a channel formation region and a shorter characteristic length between a drain region and the channel formation region than a Si transistor. Therefore, an OS transistor has higher resistance to a short-channel effect than a Si transistor. That is, in the case where a transistor with a short channel length is to be manufactured, an OS transistor is more suitable than a Si transistor.

Even in the case where the carrier concentration in the oxide semiconductor is reduced until the channel formation region becomes an i-type or substantially i-type region, the conduction band minimum of the channel formation region in a short-channel transistor decreases because of the Conduction-Band-Lowering (CBL) effect; thus, the energy difference between the conduction band minimum of the source region or the drain region and that of the channel formation region might decrease to greater than or equal to 0.1 eV and less than or equal to 0.2 eV. Accordingly, the OS transistor can be regarded as having an n⁺/n⁻/n⁺ accumulation-type junction-less transistor structure or an n⁺/n⁻/n⁺ accumulation-type non-junction transistor structure in which the channel formation region becomes an n⁻-type region and the source region and the drain region become n⁺-type regions.

An OS transistor having the above structure enables a semiconductor device to have favorable electrical characteristics even when the semiconductor device is miniaturized or highly integrated. For example, the semiconductor device can have favorable electrical characteristics even when the OS transistor has a gate length less than or equal to 20 nm, less than or equal to 15 nm, less than or equal to 10 nm, less than or equal to 7 nm, or less than or equal to 6 nm and greater than or equal to 1 nm, greater than or equal to 3 nm, or greater than or equal to 5 nm. In contrast, it is sometimes difficult for a Si transistor to have a gate length less than or equal to 20 nm or less than or equal to 15 nm because of appearance of a short-channel effect. Therefore, an OS transistor can be suitably used as a transistor having a short channel length as compared with a Si transistor. Note that the gate length refers to the length of a gate electrode in a direction in which carriers move inside a channel formation region during an operation of the transistor and to the width of a bottom surface of the gate electrode in a plan view of the transistor.

Miniaturization of an OS transistor can improve the high frequency characteristics of the transistor. Specifically, the cutoff frequency of the transistor can be improved. When the gate length of the OS transistor is within the above range, the cutoff frequency of the transistor can be greater than or equal to 50 GHz, preferably greater than or equal to 100 GHz, further preferably greater than or equal to 150 GHz at room temperature, for example.

As described above, an OS transistor has an effect superior to that of a Si transistor, such as a low off-state current and capability of having a short channel length.

Note that this embodiment can be combined with any of the other embodiments in this specification as appropriate. For example, the configurations, structures, methods, and the like described in this embodiment can be used in an appropriate combination with any of the configurations, structures, methods, and the like described in the other embodiments and the like.

### Embodiment 4

In this embodiment, electronic components, electronic devices, a large computer, space equipment, and a data center (also referred to as DC) in which the semiconductor device described in the above embodiment can be used will be described. Electronic components, electronic devices, a large computer, space equipment, and a data center in which the semiconductor device of one embodiment of the present invention is used are effective in improving performance, e.g., reducing power consumption.

### [Electronic Component]

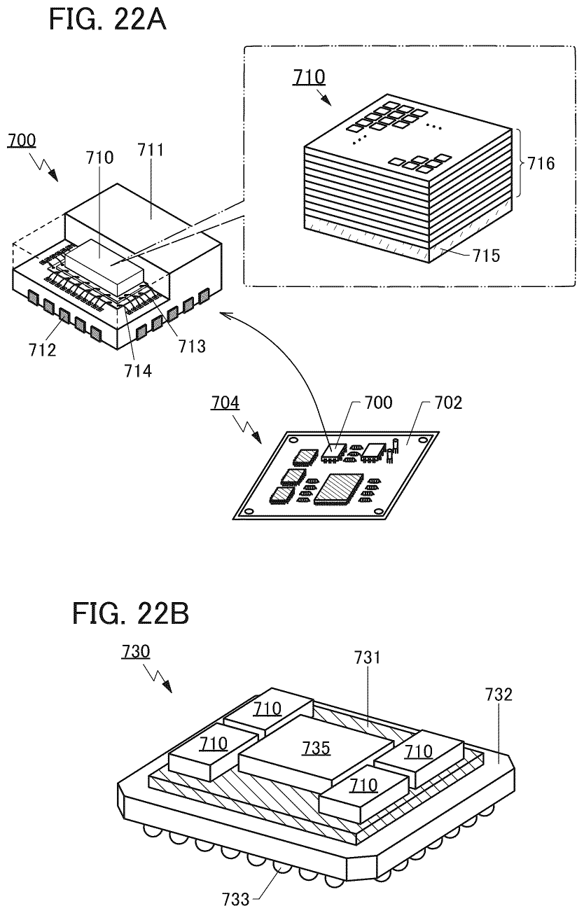

FIG. 22A is a perspective view of a substrate (a circuit board 704) on which an electronic component 700 is mounted. The electronic component 700 illustrated in FIG. 22A includes a semiconductor device 710 in a mold 711. Some components are omitted in FIG. 22A to show the inside of the electronic component 700. The electronic component 700 includes a land 712 outside the mold 711. The land 712 is electrically connected to an electrode pad 713, and the electrode pad 713 is electrically connected to the semiconductor device 710 through a wire 714. The electronic component 700 is mounted on a printed circuit board 702, for example. A plurality of such electronic components are combined and electrically connected to each other on the printed circuit board 702, which forms the circuit board 704.

The semiconductor device 710 includes a driver circuit layer 715 and a storage layer 716. The storage layer 716 has a structure in which a plurality of memory cell arrays are stacked. A stacked-layer structure of the driver circuit layer 715 and the storage layer 716 can be a monolithic stacked-layer structure. In the monolithic stacked-layer structure, layers can be connected to each other without using a through electrode technique such as TSV (Through Silicon Via) or a bonding technique such as Cu-to-Cu direct bonding. The monolithic stacked-layer structure of the driver circuit layer 715 and the storage layer 716 enables, for example, what is called an on-chip memory structure in which a memory is directly formed on a processor. The on-chip memory structure allows an interface portion between the processor and the memory to operate at high speed.

With the on-chip memory structure, the sizes of a connection wiring and the like can be smaller than those in the case where the through electrode technique such as TSV is employed; thus, the number of connection pins can be increased. An increase in the number of connection pins enables parallel operations, which can increase the bandwidth of the memory (also referred to as a memory bandwidth).

It is preferable that the plurality of memory cell arrays included in the storage layer 716 be formed using OS transistors and be monolithically stacked. Monolithically stacking the plurality of memory cell arrays can improve one or both of a memory bandwidth and a memory access latency. Note that a bandwidth refers to a data transfer volume per unit time, and an access latency refers to time from access to start of data transmission. In the case where the storage layer 716 is formed using Si transistors, it is difficult to obtain the monolithic stacked-layer structure as compared with the case where the storage layer 716 is formed using OS transistors. Thus, an OS transistor is superior to a Si transistor in the monolithic stacked-layer structure.

The semiconductor device 710 may be referred to as a die. In this specification and the like, a die refers to each of chip pieces obtained by dividing a circuit pattern formed on a circular substrate (also referred to as a wafer) or the like into dice in the manufacturing process of a semiconductor chip, for example. Examples of a semiconductor material that can be used for a die include silicon (Si), silicon carbide (SiC), and gallium nitride (GaN). A die obtained from a silicon substrate (also referred to as a silicon wafer) may be referred to as a silicon die, for example.

FIG. 22B is a perspective view of an electronic component 730. The electronic component 730 is an example of a SiP (System in Package) or an MCM (Multi Chip Module). In the electronic component 730, an interposer 731 is provided over a package substrate 732 (printed circuit board), and a semiconductor device 735 and a plurality of the semiconductor devices 710 are provided over the interposer 731.

The electronic component 730 that includes the semiconductor device 710 as a high bandwidth memory (HBM) is illustrated as an example. The semiconductor device 735 can be used for an integrated circuit such as a CPU (Central Processing Unit), a GPU (Graphics Processing Unit), or an FPGA (Field Programmable Gate Array), for example.

As the package substrate 732, a ceramic substrate, a plastic substrate, or a glass epoxy substrate can be used, for example. As the interposer 731, a silicon interposer or a resin interposer can be used, for example.

The interposer 731 includes a plurality of wirings and has a function of electrically connecting a plurality of integrated circuits with different terminal pitches. The plurality of wirings are provided in a single layer or multiple layers. In addition, the interposer 731 has a function of electrically connecting an integrated circuit provided on the interposer 731 to an electrode provided on the package substrate 732. Accordingly, the interposer is referred to as a “redistribution substrate” or an “intermediate substrate” in some cases. Furthermore, a through electrode is provided in the interposer 731 and the through electrode is used to electrically connect an integrated circuit and the package substrate 732 in some cases. Moreover, in the case of using a silicon interposer, a TSV can also be used as the through electrode.

An HBM needs to be connected to many wirings to achieve a wide memory bandwidth. Therefore, an interposer on which an HBM is mounted requires minute and densely formed wirings. For this reason, a silicon interposer is preferably used as the interposer on which an HBM is mounted.

In a SiP or an MCM that includes a silicon interposer, a decrease in reliability due to a difference in the coefficient of expansion between an integrated circuit and the interposer is less likely to occur. Furthermore, a surface of a silicon interposer has high planarity; thus, poor connection between the silicon interposer and an integrated circuit provided on the silicon interposer is less likely to occur. It is particularly preferable to use a silicon interposer for a 2.5D package (2.5-dimensional mounting) in which a plurality of integrated circuits are arranged side by side on the interposer.

Meanwhile, in the case where a plurality of integrated circuits with different terminal pitches are electrically connected to each other using a silicon interposer, TSV, and the like, a space for the width of the terminal pitches and the like is needed. Thus, in the case where the size of the electronic component 730 is to be reduced, the width of the terminal pitches causes a problem, which sometimes makes it difficult to provide a large number of wirings for a wide memory bandwidth. For this reason, the above-described monolithic stacked-layer structure using OS transistors is suitable. A composite structure combining memory cell arrays stacked using TSV and monolithically stacked memory cell arrays may be employed.

In addition, a heat sink (a radiator plate) may be provided to overlap with the electronic component 730. In the case of providing a heat sink, the heights of integrated circuits provided on the interposer 731 are preferably equal to each other. For example, in the electronic component 730 described in this embodiment, the heights of the semiconductor devices 710 and the semiconductor device 735 are preferably equal to each other.

To mount the electronic component 730 on another substrate, an electrode 733 may be provided on a bottom portion of the package substrate 732. FIG. 22B illustrates an example in which the electrode 733 is formed of a solder ball. Solder balls are provided in a matrix on the bottom portion of the package substrate 732, so that BGA (Ball Grid Array) mounting can be achieved. Alternatively, the electrode 733 may be formed of a conductive pin. When conductive pins are provided in a matrix on the bottom portion of the package substrate 732, PGA (Pin Grid Array) mounting can be achieved.

The electronic component 730 can be mounted on another substrate by any of various mounting methods not limited to BGA and PGA. Examples of a mounting method include an SPGA (Staggered Pin Grid Array), an LGA (Land Grid Array), a QFP (Quad Flat Package), a QFJ (Quad Flat J-leaded package), and a QFN (Quad Flat Non-leaded package).

### [Electronic Device]

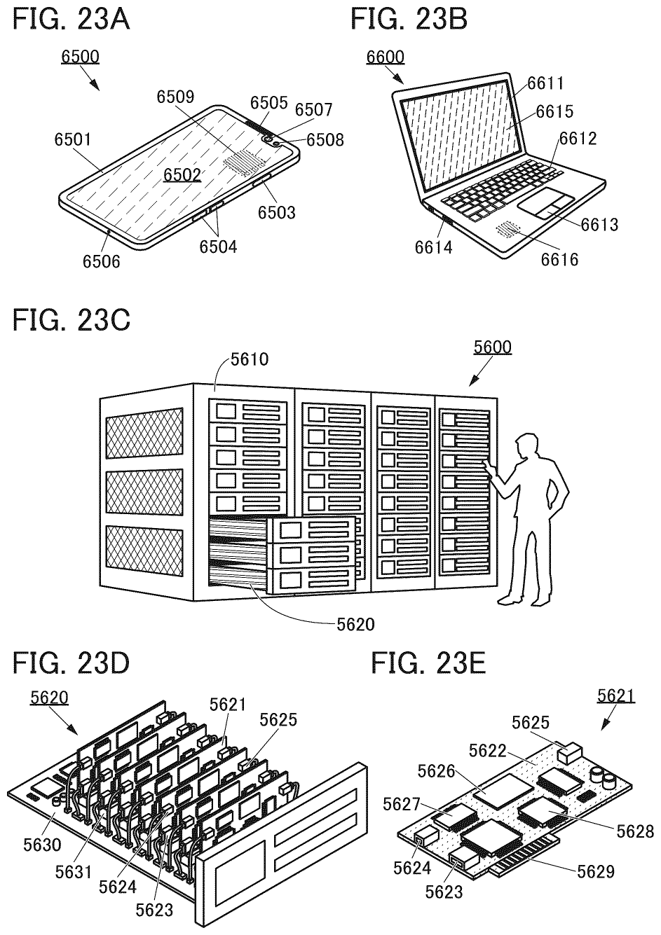

FIG. 23A is a perspective view of an electronic device 6500. The electronic device 6500 illustrated in FIG. 23A is a portable information terminal that can be used as a smartphone. The electronic device 6500 includes a housing 6501, a display portion 6502, a power button 6503, buttons 6504, a speaker 6505, a microphone 6506, a camera 6507, a light source 6508, a control device 6509, and the like. One or more selected from a CPU, a GPU, and a storage device are provided as the control device 6509, for example. The semiconductor device of one embodiment of the present invention can be used for the display portion 6502, the control device 6509, and the like.

An electronic device 6600 illustrated in FIG. 23B is an information terminal that can be used as a notebook personal computer. The electronic device 6600 includes a housing 6611, a keyboard 6612, a pointing device 6613, an external connection port 6614, a display portion 6615, a control device 6616, and the like. One or more selected from a CPU, a GPU, and a storage device are provided as the control device 6616, for example. The semiconductor device of one embodiment of the present invention can be used for the display portion 6615, the control device 6616, and the like. Note that the semiconductor device of one embodiment of the present invention is preferably used for the control device 6509 and the control device 6616, in which case power consumption can be reduced.

### [Large Computer]

FIG. 23C is a perspective view of a large computer 5600. In the large computer 5600 illustrated in FIG. 23C, a plurality of rack mount computers 5620 are stored in a rack 5610. Note that the large computer 5600 may be referred to as a supercomputer.

The computer 5620 can have a structure in a perspective view of FIG. 23D, for example. In FIG. 23D, the computer 5620 includes a motherboard 5630, and the motherboard 5630 includes a plurality of slots 5631 and a plurality of connection terminals. A PC card 5621 is inserted in the slot 5631. In addition, the PC card 5621 includes a connection terminal 5623, a connection terminal 5624, and a connection terminal 5625, each of which is connected to the motherboard 5630.

The PC card 5621 illustrated in FIG. 23E is an example of a processing board provided with a CPU, a GPU, a storage device, and the like. The PC card 5621 includes a board 5622. The board 5622 includes the connection terminal 5623, the connection terminal 5624, the connection terminal 5625, a semiconductor device 5626, a semiconductor device 5627, a semiconductor device 5628, and a connection terminal 5629. Although FIG. 23E illustrates semiconductor devices other than the semiconductor device 5626, the semiconductor device 5627, and the semiconductor device 5628, the following description of the semiconductor device 5626, the semiconductor device 5627, and the semiconductor device 5628 is referred to for these semiconductor devices.

The connection terminal 5629 has a shape with which the connection terminal 5629 can be inserted in the slot 5631 of the motherboard 5630, and the connection terminal 5629 functions as an interface for connecting the PC card 5621 and the motherboard 5630. An example of the standard for the connection terminal 5629 is PCIe.

The connection terminal 5623, the connection terminal 5624, and the connection terminal 5625 can serve as, for example, an interface for performing power supply, signal input, or the like to the PC card 5621. For another example, they can serve as an interface for outputting a signal calculated by the PC card 5621. Examples of the standard for each of the connection terminal 5623, the connection terminal 5624, and the connection terminal 5625 include USB (Universal Serial Bus), SATA (Serial ATA), and SCSI (Small Computer System Interface). In the case where video signals are output from the connection terminal 5623, the connection terminal 5624, and the connection terminal 5625, an example of the standard therefor is HDMI (registered trademark).

The semiconductor device 5626 includes a terminal (not shown) for inputting and outputting signals, and when the terminal is inserted in a socket (not shown) of the board 5622, the semiconductor device 5626 and the board 5622 can be electrically connected to each other.

The semiconductor device 5627 includes a plurality of terminals, and when the terminals are reflow-soldered, for example, to wirings of the board 5622, the semiconductor device 5627 and the board 5622 can be electrically connected to each other. Examples of the semiconductor device 5627 include an FPGA, a GPU, and a CPU. As the semiconductor device 5627, the electronic component 730 can be used, for example.

The semiconductor device 5628 includes a plurality of terminals, and when the terminals are reflow-soldered, for example, to wirings of the board 5622, the semiconductor device 5628 and the board 5622 can be electrically connected to each other. An example of the semiconductor device 5628 is a storage device. As the semiconductor device 5628, the electronic component 700 can be used, for example.

The large computer 5600 can also function as a parallel computer. When the large computer 5600 is used as a parallel computer, large-scale computation necessary for artificial intelligence learning and inference can be performed, for example.

### [Space Equipment]

The semiconductor device of one embodiment of the present invention can be suitably used as space equipment such as equipment that processes and stores information.

The semiconductor device of one embodiment of the present invention can include an OS transistor. A change in electrical characteristics of the OS transistor due to radiation irradiation is small. That is, the OS transistor is highly resistant to radiation and thus can be suitably used in an environment where radiation can enter. For example, the OS transistor can be suitably used in outer space.

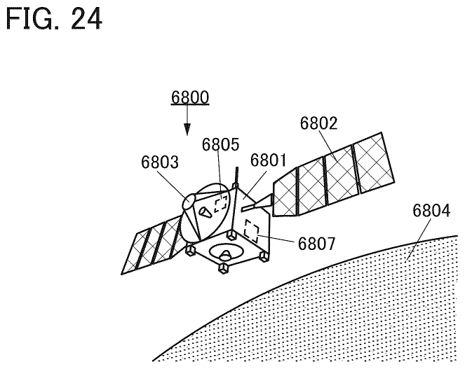

FIG. 24 illustrates an artificial satellite 6800 as an example of space equipment. The artificial satellite 6800 includes a body 6801, a solar panel 6802, an antenna 6803, a secondary battery 6805, and a control device 6807. FIG. 24 illustrates a planet 6804 in outer space, for example. Note that outer space refers to, for example, space at an altitude greater than or equal to 100 km, and outer space in this specification may also include thermosphere, mesosphere, and stratosphere.

Although not illustrated in FIG. 24, a battery management system (also referred to as BMS) or a battery control circuit may be provided in the secondary battery 6805. The battery management system or the battery control circuit preferably includes an OS transistor, in which case power consumption is low and high reliability is achieved even in outer space.

The amount of radiation in outer space is 100 or more times that on the ground. Examples of radiation include electromagnetic waves (electromagnetic radiation) typified by X-rays and gamma rays and particle radiation typified by alpha rays, beta rays, neutron beams, proton beams, heavy-ion beams, and meson beams.

When the solar panel 6802 is irradiated with sunlight, electric power required for an operation of the artificial satellite 6800 is generated. However, for example, in the situation where the solar panel is not irradiated with sunlight or the amount of sunlight with which the solar panel is irradiated is small, the amount of generated electric power is small. Accordingly, electric power required for an operation of the artificial satellite 6800 might not be generated. In order to operate the artificial satellite 6800 even with a small amount of generated electric power, the artificial satellite 6800 is preferably provided with the secondary battery 6805. Note that a solar panel is referred to as a solar cell module in some cases.

The artificial satellite 6800 can generate a signal. The signal is transmitted through the antenna 6803, and can be received by a ground-based receiver or another artificial satellite, for example. When the signal transmitted by the artificial satellite 6800 is received, the position of a receiver that receives the signal can be measured. Thus, the artificial satellite 6800 can constitute a satellite positioning system.

The control device 6807 has a function of controlling the artificial satellite 6800. One or more selected from a CPU, a GPU, and a storage device are used as the control device 6807, for example. Note that the semiconductor device of one embodiment of the present invention is suitably used for the control device 6807. A change in electrical characteristics due to radiation irradiation is smaller in an OS transistor than in a Si transistor. That is, the OS transistor has high reliability and thus can be suitably used even in an environment where radiation can enter.

The artificial satellite 6800 can include a sensor. For example, with a structure including a visible light sensor, the artificial satellite 6800 can have a function of sensing sunlight reflected by a ground-based object. Alternatively, with a structure including a thermal infrared sensor, the artificial satellite 6800 can have a function of sensing thermal infrared rays emitted from the surface of the earth. Thus, the artificial satellite 6800 can function as an earth observing satellite, for example.

Although the artificial satellite is described as an example of space equipment in this embodiment, one embodiment of the present invention is not limited thereto. The semiconductor device of one embodiment of the present invention can be suitably used for space equipment such as a spacecraft, a space capsule, or a space probe, for example.

As described above, an OS transistor has excellent effects of achieving a wide memory bandwidth and being highly resistant to radiation as compared with a Si transistor.

### [Data Center]

The semiconductor device of one embodiment of the present invention can be suitably used for a storage system in a data center, for example. Long-term management of data, such as guarantee of data immutability, is required for the data center. The management of long-term data needs an increase in building size owing to installation of storages and servers for storing an enormous amount of data, stable electric power for data retention, cooling equipment necessary for data retention, and the like.

With the use of the semiconductor device of one embodiment of the present invention for the storage system used in the data center, electric power required for data retention can be reduced and a semiconductor device retaining data can be downsized. Thus, downsizing of the storage system, downsizing of the power supply for retaining data, downscaling of the cooling equipment, and the like can be achieved, for example. This can reduce the space of the data center.

Since the semiconductor device of one embodiment of the present invention has low power consumption, heat generation from a circuit can be reduced. Accordingly, adverse effects of the heat generation on each of the circuit itself, the peripheral circuit, and the module can be reduced. Furthermore, the use of the semiconductor device of one embodiment of the present invention enables a data center that operates stably even in a high-temperature environment. Thus, the reliability of the data center can be increased.

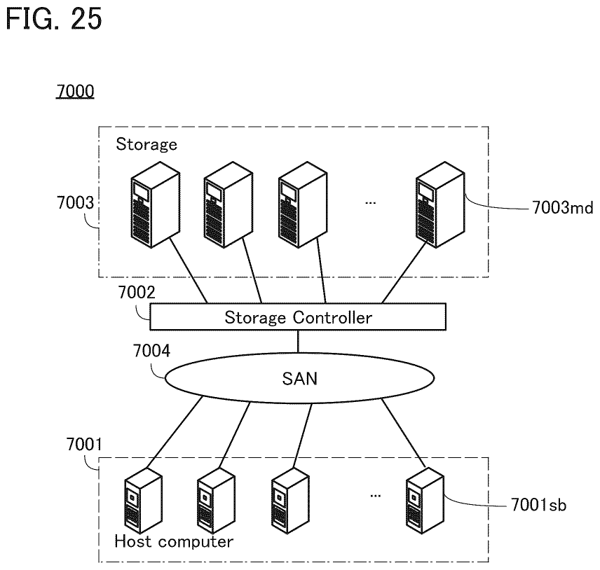

FIG. 25 illustrates a storage system that can be used in a data center. A storage system 7000 illustrated in FIG. 25 includes a plurality of servers 7001sb as a host 7001 (indicated as “Host Computer” in the diagram). The storage system 7000 includes a plurality of storage devices 7003md as a storage 7003 (indicated as “Storage” in the diagram). In the illustrated mode, the host 7001 and the storage 7003 are connected to each other through a storage area network 7004 (indicated as “SAN” in the diagram) and a storage control circuit 7002 (indicated as “Storage Controller” in the diagram).

The host 7001 corresponds to a computer that accesses data stored in the storage 7003. The host 7001 may be connected to another host 7001 through a network.

The data access speed, i.e., the time taken for storing and outputting data, of the storage 7003 is shortened by using a flash memory, but is still considerably longer than the data access speed of a DRAM (Dynamic Random Access Memory) that can be used as a cache memory in a storage. In the storage system, in order to solve the problem of low access speed of the storage 7003, a cache memory is usually provided in the storage to shorten the time taken for storing and outputting data.

The above-described cache memory is used in the storage control circuit 7002 and the storage 7003. The data transmitted between the host 7001 and the storage 7003 is stored in the cache memories in the storage control circuit 7002 and the storage 7003 and then output to the host 7001 or the storage 7003.

The use of an OS transistor as a transistor for storing data in the cache memory to retain a potential based on data can reduce the frequency of refreshing, so that power consumption can be reduced. Furthermore, downsizing is possible by stacking memory cell arrays.

The use of the semiconductor device of one embodiment of the present invention for one or more selected from an electronic component, an electronic device, a large computer, space equipment, and a data center will produce an effect of reducing power consumption. While the demand for energy will increase with increasing performance and integration degree of semiconductor devices, the use of the semiconductor device of one embodiment of the present invention can thus reduce the emission amount of greenhouse gas typified by carbon dioxide (CO₂). The semiconductor device of one embodiment of the present invention can be effectively used as one of the global warming countermeasures because of its low power consumption.

Note that this embodiment can be combined with any of the other embodiments in this specification as appropriate. For example, the configurations, structures, methods, and the like described in this embodiment can be used in an appropriate combination with any of the configurations, structures, methods, and the like described in the other embodiments and the like.

### EXAMPLE

### Prototype Example 1

A circuit corresponding to the arithmetic portion ANP included in the semiconductor device CDV in FIG. 1 described in this specification and the like was actually prototyped.

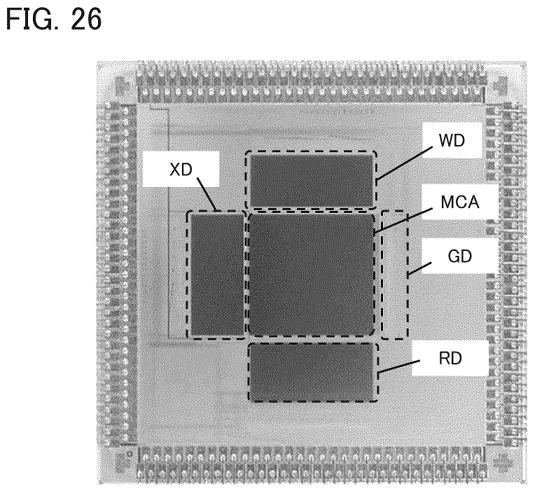

FIG. 26 is a top view photograph of the actually fabricated die (chip) including an arithmetic circuit. Note that the die is 4 mm long on each side. In the die shown in FIG. 26, a Si transistor with a process node of 55 nm was formed over a semiconductor substrate including silicon as a material and an OS transistor with a process node of 60 nm was formed above the Si transistor. Specifically, a circuit WD, a circuit XD, a circuit RD, and a circuit GD to be described later were formed over the semiconductor substrate by a process of a Si transistor, and a circuit MCA to be described later was formed by a process of an OS transistor.

Note that the numerical value of the process node in this specification and the like does not correspond to the minimum line width (also referred to as L or line), the minimum pitch width (also referred to as S or space), or the channel length of a transistor provided in an actual product in some cases. Thus, the numerical value of the process node in this specification and the like is merely one indicator of the degree of miniaturization.

Note that the structure in which the circuit WD, the circuit XD, the circuit RD, and the circuit GD are formed over the semiconductor substrate and the circuit MCA is formed thereabove corresponds to a modification example of the structure which is described in Embodiment 1 with reference to FIG. 18 and in which the circuit WCS, the circuit XCS, and the circuit ITS are included in the circuit layer PHRL and the cell array CA is included in the arithmetic layer OMAL.

The circuit WD, the circuit XD, the circuit RD, the circuit GD, and the circuit MCA shown in FIG. 26 correspond to the circuits included in the arithmetic portion ANP described in Embodiment 1 with reference to FIG. 6. Specifically, the circuit WD corresponds to the circuit WCS in FIG. 6, the circuit XD corresponds to the circuit XCS in FIG. 6, the circuit GD corresponds to the circuit WSD in FIG. 6, and the circuit RD corresponds to the circuit ITS in FIG. 6. The circuit MCA corresponds to the cell array CA in FIG. 6.

### Prototype Example 2

Also actually prototyped was a circuit having a structure in which output data of a fully connected layer corresponding to the previous layer is directly input to a fully connected layer corresponding to the subsequent layer in a fully connected neural network as in the arithmetic portion ANP in FIG. 15B described in this specification and the like.

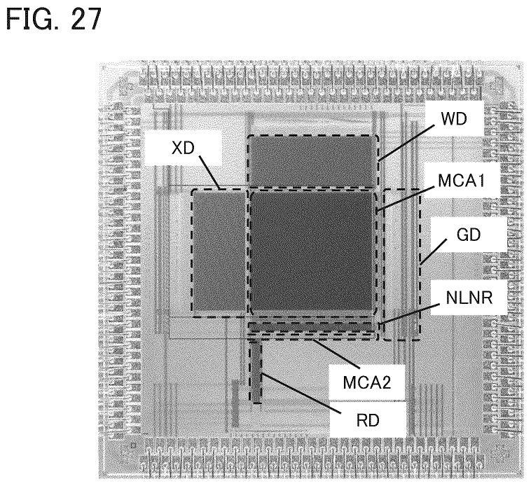

FIG. 27 is a top view photograph of the actually fabricated die (chip) provided with two cell arrays. Note that the die is 4 mm long on each side. As in FIG. 26, in the die shown in FIG. 27, a Si transistor with a process node of 55 nm was formed over a semiconductor substrate including silicon as a material and an OS transistor with a process node of 60 nm was formed above the Si transistor. Specifically, the circuit WD, the circuit XD, the circuit RD, the circuit GD, and a circuit NLNR to be described later were formed over the semiconductor substrate by a process of a Si transistor, and a circuit MCA1 and a circuit MCA2 to be described later were formed by a process of an OS transistor.

The circuit MCA1 corresponds to the cell array CA in FIG. 6 and includes a plurality of arithmetic cells arranged in a matrix. Like the circuit MCA1, the circuit MCA2 also includes a plurality of arithmetic cells arranged in a matrix. The circuit WD corresponds to the circuit WCS in FIG. 6 and has a function of making an analog current corresponding to the first data (e.g., weight coefficient) flow to each of the circuit MCA1 and the circuit MCA2. The circuit GD corresponds to the circuit WSD in FIG. 6 and has a function of transmitting, to each of the circuit MCA1 and the circuit MCA2, a selection signal for selecting an arithmetic cell to which the first data is to be written. The circuit XD corresponds to the circuit XCS in FIG. 6 and has a function of making an analog current corresponding to the second data (e.g., a signal output from a neuron in the previous layer) flow to the circuit MCA1. The circuit RD corresponds to the circuit ITS in FIG. 6 and has a function of performing an arithmetic operation of a function system (e.g., a nonlinear function system) using the result of the product-sum operation in the circuit MCA2 as an input value and a function of converting the result of the arithmetic operation of the function system into digital data and outputting the digital data to the outside of the circuit RD.

The circuit NLNR has a function of performing an arithmetic operation of a function system (e.g., a nonlinear function system) using the result of the product-sum operation in the circuit MCA1 as an input value. The circuit NLNR includes no digital-analog converter circuit like the circuit ITSa_j illustrated in FIG. 9C.

In the die (chip) shown in FIG. 27, the circuit MCA1 performs the (first) product-sum operation of a first weight coefficient transmitted from the circuit WD and data transmitted from the circuit XD. The circuit NLNR performs an arithmetic operation of a function system using the result of the (first) product-sum operation as an input value. The circuit MCA2 performs the (second) product-sum operation of a second weight coefficient transmitted from the circuit WD and the result of the arithmetic operation in the circuit NLNR. The circuit RD performs an arithmetic operation of a function system using the result of the (second) product-sum operation as an input value, converts the result of the arithmetic operation into digital data, and outputs the digital data to the circuit RD.

### REFERENCE NUMERALS

CDV: semiconductor device, DGP: arithmetic portion, ANP: arithmetic portion, MEM: storage portion, D10: switching circuit, D20: arithmetic circuit, D20_1: arithmetic circuit, D20_k: arithmetic circuit, D30: processing circuit, ME11: memory circuit portion, ME12: memory circuit portion, ME13: memory circuit portion, WWD: circuit, WSD: circuit, RWD: circuit, RBD: circuit, WCS: circuit, WBD: circuit, XCS: circuit, ITS: circuit, CA: cell array, MEA: cell array, XCSa_1: circuit, XCSa_i: circuit, XCSa_m: circuit, WCSa_1: circuit, WCSa_j: circuit, WCSa_n: circuit, ITSa_1: circuit, ITSa_j: circuit, ITSa_n: circuit, SWCA: circuit, SWCB: circuit, RL_j: converter circuit, ADC: analog-digital converter circuit, CS: current source, CS1: current source, CS2: current source, CS3: current source, ILA: wiring, ILA_1: wiring, ILA_k: wiring, ILB: wiring, ILB_1: wiring, ILB_k: wiring, MLA: wiring, MLA_1: wiring, MLA_k: wiring, MLB: wiring, CNL: wiring, CNL_1: wiring, CNL_k: wiring, POL: wiring, IXL: wiring, IXL_1: wiring, IXL_i: wiring, IXL_m: wiring, IWL_1: wiring, IWL_j: wiring, IWL_n: wiring, WCL_1: wiring, WCL_j: wiring, WCL_n: wiring, XCL_1: wiring, XCL_i: wiring, XCL_m: wiring, WSL_1: wiring, WSL_m: wiring, OL_1: wiring, OL_n: wiring, RSTL: wiring, CLKL: wiring, DIL: wiring, DOL: wiring, WBL: wiring, WBL_1: wiring, WBL_v: wiring, WWL: wiring, WWL_1: wiring, WWL_u: wiring, RBL: wiring, RBL_1: wiring, RBL_v: wiring, RWL: wiring, RWL_1: wiring, RWL_u: wiring, CVLA: wiring, CVLB: wiring, BL: wiring, SL: wiring, WBLP: wiring, WBLN: wiring, RBLP: wiring, RBLN: wiring, SWLA: wiring, SWLB: wiring, VE0: wiring, VE1: wiring, VINIL1: wiring, VINIL2: wiring, DW: wiring, DW[1]: wiring, DW[2]: wiring, DW[M]: wiring, DX[1]: wiring, DX[2]: wiring, DX[L]: wiring, VDDL: wiring, VTHL: wiring, VWL: wiring, VTL: wiring, VRL: wiring, MP: multiplier circuit, AP: adder circuit, RG: register, MEX: memory circuit, MC: storage cell, MC[1,1]: storage cell, MC[u,1]: storage cell, MC[1,v]: storage cell, MC[u,v]: storage cell, IM[1,1]: arithmetic cell, IM[m,1]: arithmetic cell, IM[1,n]: arithmetic cell, IM[m,n]: arithmetic cell, IMD_1: driving cell, IMD_m: driving cell, MCP: storage cell, MCN: storage cell, TM1i: input terminal, TM2i: input terminal, TMo: output terminal, TN1i: input terminal, TN2i: input terminal, TNo: output terminal, U1: terminal, U2: terminal, RTi_j: terminal, RTo_j: terminal, M1: transistor, M2: transistor, M3: transistor, F1: transistor, F1d: transistor, F2: transistor, F2d: transistor, F5: transistor, F5d: transistor, Tr1: transistor, Tr1[1]: transistor, Tr1[2]: transistor, Tr1[M]: transistor, Tr2: transistor, Tr2[1]: transistor, Tr2[M]: transistor, Tr3: transistor, C1: capacitor, C5: capacitor, C5d: capacitor, C7: capacitor, SA_1: switch, SA_j: switch, SA_n: switch, SB_1: switch, SB_j: switch, SB_n: switch, SWW: switch, SWX: switch, LE: load, OP: operational amplifier, N[1,1]: node, N[m,1]: node, N[1,n]: node, N[m,n]: node, INLY: input layer, CNV1: convolution layer, CNV2: convolution layer, CNV3: convolution layer, CNV4: convolution layer, CNV5: convolution layer, PL1: pooling layer, PL2: pooling layer, PL5: pooling layer, FC6: fully connected layer, FC7: fully connected layer, FC8: fully connected layer, PURL: circuit layer, OMEL: storage layer, OMEL1: storage layer, OMEL2: storage layer, OMAL: arithmetic layer, OMAL1: arithmetic layer, OMAL2: arithmetic layer, T01: time, T02: time, T03: time, T04: time, BS1: substrate, BS2: substrate, WD: circuit, XD: circuit, GD: circuit, RD: circuit, NLNR: circuit, MCA: circuit, MCA1: circuit, MCA2: circuit, 311: substrate, 313: semiconductor region, 314a: low-resistance region, 314b: low-resistance region, 315: insulator, 316: conductor, 317: insulator, 320: insulator, 324: insulator, 326: insulator, 328: conductor, 330: conductor, 350: insulator, 352: insulator, 354: insulator, 356: conductor, 357: insulator, 400: transistor, 700: electronic component, 702: printed circuit board, 704: circuit board, 710: semiconductor device, 711: mold, 712: land, 713: electrode pad, 714: wire, 715: driver circuit layer, 716: storage layer, 730: electronic component, 731: interposer, 732: package substrate, 733: electrode, 735: semiconductor device, 5600: large computer, 5610: rack, 5620: computer, 5621: PC card, 5622: board, 5623: connection terminal, 5624: connection terminal, 5625: connection terminal, 5626: semiconductor device, 5627: semiconductor device, 5628: semiconductor device, 5629: connection terminal, 5630: motherboard, 5631: slot, 6500: electronic device, 6501: housing, 6502: display portion, 6503: power button, 6504: button, 6505: speaker, 6506: microphone, 6507: camera, 6508: light source, 6509: control device, 6600: electronic device, 6611: housing, 6612: keyboard, 6613: pointing device, 6614: external connection port, 6615: display portion, 6616: control device, 6800: artificial satellite, 6801: body, 6802: solar panel, 6803: antenna, 6804: planet, 6805: secondary battery, 6807: control device, 7000: storage system, 7001: host, 7001sb: server, 7002: storage control circuit, 7003: storage, 7003md: storage device, 7004: storage area network

1. A semiconductor device comprising:
a first arithmetic portion comprising a first wiring and an arithmetic circuit;
a second arithmetic portion comprising a second wiring, a first circuit, a second circuit, a third circuit and a plurality of arithmetic-cell circuits; and
a storage portion comprising a first memory circuit, a second memory circuit and a third memory circuit,
wherein a first input terminal of the arithmetic circuit is electrically connected to the first wiring,
wherein a second input terminal of the arithmetic circuit is electrically connected to the second memory circuit,
wherein the second wiring is electrically connected to the first circuit, the third circuit and the plurality of arithmetic-cell circuits,
wherein the first wiring is a wiring configured to sequentially transmit a plurality of pieces of first digital data,
wherein the second memory circuit is configured to read a plurality of pieces of second digital data and to sequentially transmit the plurality of pieces of second digital data to the second input terminal of the arithmetic circuit,
wherein the arithmetic circuit is configured to perform a first arithmetic operation of the plurality of pieces of first digital data and the plurality of pieces of second digital data to obtain third digital data and to transmit the third digital data to the first memory circuit,
wherein the first memory circuit is configured to retain a plurality of pieces of the third digital data,
wherein the third memory circuit is configured to read a plurality of pieces of fourth digital data and to sequentially transmit the plurality of pieces of the fourth digital data to the first circuit,
wherein the first circuit is configured to sequentially generate first currents corresponding to the plurality of pieces of the fourth digital data and to make the first currents flow to the plurality of arithmetic-cell circuits,
wherein the each of the plurality of arithmetic-cell circuits is configured to retain a first potential corresponding to an amperage of the first current,
wherein the first memory circuit is configured to read the plurality of pieces of third digital data and to transmit the plurality of pieces of third digital data to the second circuit,
wherein the second circuit is configured to generate a plurality of second currents corresponding to the plurality of pieces of third digital data and to make the second currents flow to the plurality of arithmetic-cell circuits,
wherein each of the plurality of arithmetic-cell circuits is configured to change the first potential in accordance with an amperage of the second current, to generate a third current in an amperage corresponding to a product of the fourth digital data and the third digital data, and to make the third current flow to the second wiring,
wherein the third circuit is configured to obtain, from the second wiring, a sum of amperages of a plurality of the third currents generated in the plurality of arithmetic-cell circuits and to perform a second arithmetic operation to obtain first data,
wherein the first arithmetic operation is a product-sum operation, and
wherein the second arithmetic operation is an operation using a function inputting the sum of the amperages of the plurality of third currents.

2. The semiconductor device according to claim 1, further comprising:
a plurality of first wirings including the first wiring; and
a plurality of arithmetic circuits including the arithmetic circuit,
wherein first input terminals of the plurality of arithmetic circuits are electrically connected to the plurality of first wirings in a one-to-one correspondence,
wherein second input terminals of the plurality of arithmetic circuits are electrically connected to each other, and
wherein output terminals of the plurality of arithmetic circuits are electrically connected to the first memory circuit.

3. The semiconductor device according to claim 2,
wherein the first arithmetic portion comprises a processing circuit,
wherein the first memory circuit is configured to transmit the third digital data to the processing circuit, and
wherein the processing circuit is configured to perform pooling processing on the third digital data to obtain pooling-processed third digital data and to transmit the pooling-processed third digital data to the first memory circuit.

4. The semiconductor device according to claim 3,
wherein the first arithmetic portion comprises a switching circuit,
wherein the switching circuit comprises a plurality of first input terminals, a plurality of second input terminals and a plurality of output terminals,
wherein the plurality of second input terminals of the switching circuit are electrically connected to the first memory circuit,
wherein the plurality of output terminals of the switching circuit are electrically connected to the plurality of first wirings in a one-to-one correspondence,
wherein the switching circuit is configured to:
switch a path from one of the plurality of first input terminals of the switching circuit and the plurality of second input terminals of the switching circuit to the plurality of output terminals of the switching circuit to be in a conductive state; and
to switch a path from the other of the plurality of first input terminals and the plurality of second input terminals of the switching circuit to the plurality of output terminals of the switching circuit to be in a non-conductive state,
wherein the first memory circuit is configured to read the plurality of pieces of third digital data and to transmit the plurality of pieces of third digital data to the first input terminal of the arithmetic circuit through the switching circuit,
wherein the arithmetic circuit is configured to perform a third arithmetic operation of the plurality of pieces of third digital data retained in the first memory circuit and the plurality of pieces of second digital data retained in the second memory circuit to obtain fifth digital data and to transmit the fifth digital data to the first memory circuit, and
wherein the third arithmetic operation is a product-sum operation.

5. The semiconductor device according to claim 4,
wherein the third circuit comprises an analog-digital converter circuit,
wherein the analog-digital converter circuit is configured to convert the first data into sixth digital data, and
wherein the third circuit is configured to transmit the sixth digital data to the first memory circuit.

6. The semiconductor device according to claim 1, further comprising a first layer, a second layer over the first layer, and a third layer over the second layer,
wherein the first layer comprises the arithmetic circuit, the first circuit, the second circuit and the third circuit,
wherein the second layer comprises the first memory circuit, the second memory circuit and the third memory circuit, and
wherein the third layer comprises the plurality of arithmetic-cell circuits.

7. The semiconductor device according to claim 6,
wherein the first layer comprises a transistor in which a channel formation region comprises silicon,
wherein each of the second layer and the third layer comprises a transistor in which a channel formation region comprises an oxide semiconductor,
wherein the oxide semiconductor comprises one or more selected from indium, zinc and an element M, and
wherein the element M is one or more selected from gallium, aluminum, silicon, boron, yttrium, tin, copper, vanadium, beryllium, titanium, iron, nickel, germanium, zirconium, molybdenum, lanthanum, cerium, neodymium, hafnium, tantalum, tungsten, cobalt, magnesium and antimony.

8. An electronic device comprising:
the semiconductor device according to claim 7; and
a housing.
